(19) United States
(12) Patent Application Publication
(10) Pub. No.: US 2026/0346830 A1
(43) Pub. Date: Nov. 5, 2026

(54) Hull-Borne Maneuvering of Craft with Distributed Propulsion Systems

(71) Applicant: Regent Craft, Inc., North Kingstown, RI (US)

(72) Inventors: Andrew Gregg, Burlington, MA (US); Amira Malik, Burlington, MA (US); Michael Klinker, Burlington, MA (US); Daniel Cottrell, Burlington, MA (US)

(21) Appl. No.: 19/488,667

(22) PCT Filed: Jun. 5, 2024
(86) PCT No.: PCT/US2024/032670

§ 371 Date: Nov. 28, 2025

Related U.S. Application Data
(60) Provisional application No. 63/506,590, filed on Jun. 6, 2023.
(60) Provisional application No. 63/610,245, filed on Dec. 14, 2023.

(51) Int. Cl. B60V 1/11

(52) U.S. Cl. CPC B60V 1/11

(57) ABSTRACT

While hull-home and operating in a heading adjustment mode, the control system of the disclosed craft receives indications of a target craft heading and an observed craft heading. Embodiments include determining that the difference in heading is above a threshold, determining an adjusted wing-affixed control setting for affecting a change in the observed heading of the craft based on at least (a) sensed environmental conditions, (b) the initial wing-affixed control setting, (c) the target craft heading, and (d) the observed craft heading; and operating wing-affixed control element(s) according to the adjusted wing-affixed control setting to change the observed heading of the craft to the target craft heading. After determining that the heading difference is not above the threshold heading difference, the wing-affixed control setting is adjusted to forgo affecting further change in the observed heading of the craft.

### CROSS-REFERENCE TO RELATED APPLICATIONS

This application claims priority under 35 U.S.C. § 119 (e) to: (i) U.S. Provisional App. 63/506,590, titled “Hull-Borne Maneuvering of Airborne Craft,” filed on Jun. 6, 2023, and currently pending; and (ii) U.S. Provisional App. 63/610,245, titled “Hull-Borne Maneuvering of Craft with Distributed Propulsion Systems,” filed on Dec. 14, 2023, and currently pending. The entire contents of U.S. Provisional Apps. 63/506,590 and 63/610,245 are incorporated herein by reference.

This application also incorporates by reference the entire contents of: (i) U.S. Provisional App. 63/493,575, titled “Water Landing of Airborne Craft With Hydrofoil,” filed Mar. 31, 2023, and now expired; (ii) U.S. Provisional App. 63/459,197, titled “Controlling a Craft Using a Control Lever,” filed Apr. 13, 2023, and now expired; and (iii) U.S. Provisional App. 63/495,852, titled “On Water Inference of Airborne Craft with Hydrofoil,” filed Apr. 13, 2023, and now expired.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIGS. 1A-1D illustrate various views of a craft, in accordance with example embodiments.

FIG. 2 illustrates a main hydrofoil deployment system of a craft, in accordance with example embodiments.

FIG. 3 illustrates a rear hydrofoil deployment system of a craft, in accordance with example embodiments.

FIG. 4 illustrates a battery system of a craft, in accordance with example embodiments.

FIG. 5 illustrates a control system of a craft, in accordance with example embodiments.

FIG. 6A illustrates a craft in a hull-borne mode of operation, in accordance with example embodiments.

FIG. 6B illustrates a craft in a hydrofoil-borne maneuvering mode of operation, in accordance with example embodiments.

FIG. 7A illustrates a craft in a hydrofoil-borne takeoff mode of operation, in accordance with example embodiments.

FIG. 7B is a graph that illustrates various lift forces acting on a craft, in accordance with example embodiments.

FIG. 8 illustrates a craft in a wing-borne mode of operation, in accordance with example embodiments.

FIGS. 9A and 9B illustrate bottom and side views, respectively, of an outrigger propulsion system, in accordance with example embodiments.

FIGS. 9C and 9D illustrate actuatable covers of an outrigger propulsion system, in accordance with example embodiments.

FIGS. 10A-10C illustrate various views of an outrigger propulsion system, in accordance with example embodiments.

FIGS. 11A and 11B illustrate bottom and side views, respectively, of an outrigger propulsion system, in accordance with example embodiments.

FIG. 12 illustrates propulsion pods of a craft, in accordance with example embodiments.

FIG. 13 illustrates operations performed by a craft before the craft begins to perform the hull-borne maneuvering operations, in accordance with example embodiments.

FIG. 14 illustrates heading adjustment operations performed by a craft, while hull-borne and maneuvering, to adjust the heading of the craft to a particular/target heading, in accordance with example embodiments.

FIGS. 15A-15C illustrate a craft adjusting its heading according to the heading adjustment operations of FIG. 14, in accordance with example embodiments.

FIG. 16 is a schematic diagram of heading control logic implemented by a control system of a craft to facilitate the performance of heading adjustment operations, in accordance with example embodiments.

FIG. 17 illustrates location adjustment operations performed by a craft, while hull-borne and maneuvering, to adjust the location of the craft to a particular/target location, in accordance with example embodiments.

FIGS. 18A-18F illustrate a craft adjusting its location according to location adjustment operations, in accordance with example embodiments.

FIG. 19 is a schematic diagram of location control logic implemented by a control system of a craft to facilitate the performance of the location adjustment operations, in accordance with example embodiments.

FIG. 20 illustrates operations performed by a craft, while hull-borne and maneuvering, to minimize the distance between the craft and a particular/target craft location using hull-aligned movements, in accordance with example embodiments.

FIGS. 21A and 21B illustrate a craft adjusting its location hull-aligned movements, in accordance with example embodiments.

FIG. 22 illustrates anchoring operations performed by a craft, in accordance with example embodiments.

FIGS. 23A-23D illustrate six maneuvering stages through which a craft transitions in anchoring itself, in accordance with example embodiments.

FIG. 24 illustrates station-keeping operations performed by a craft, in accordance with example embodiments.

FIGS. 25A-25C illustrate a craft performing station-keeping, in accordance with example embodiments.

FIG. 26 illustrates docking operations performed by a craft, in accordance with example embodiments.

FIGS. 27A-27E illustrate a craft performing docking operations, in accordance with example embodiments.

FIG. 28 illustrates a table showing several configurations in which propeller assemblies of a craft can be operated to facilitate performing maneuvering operations, in accordance with example embodiments.

### DETAILED DESCRIPTION

Various examples of systems, devices, and/or methods are described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein. Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

### I. INTRODUCTION

Aspects described herein are generally related to craft, such as aircraft, including craft that are capable of taking off from, and landing on, water. Examples of such craft include crafts having extendible hydrofoils attached to the hull of the craft. For instance, a first (or “rear”) hydrofoil may be positioned towards the tail section of the craft, and a second (or “main”) hydrofoil may be positioned near the midsection of the craft, forward the first hydrofoil (e.g., proximate to the main wing of the craft). The hydrofoils may be controlled to extend and retract depending on the operating mode of the craft. For example, when airborne, the hydrofoils may be retracted towards the hull, and when hull-borne or foil-borne, the hydrofoils may be extended. The term hull is used throughout this description to refer to the main body of the craft. It is understood that this term is interchangeable with the term fuselage which is sometimes used to refer to the main body of aircraft.

In some examples, the craft may additionally or alternatively be a wing-in-ground (WIG) effect craft. Such craft fly close to the ground or water surface by using the ground effect principle, where flying close to the surface reduces aerodynamic drag and increases lift. For example, the drag on the craft is reduced when its distance from the ground is within about half the length of the aircraft's wingspan.

Maneuvering such craft when hull-borne (i.e., when the hull of the craft is on water) presents a number of challenges, especially when considering some applications, including some commercial applications, of such craft. For example, these craft may operate in congested waters at times to, for example, facilitate the onboarding/offboarding of passengers. This may involve maneuvering to a pier to receive passengers, which in turn may involve maneuvering around and/or away from other craft, navigational markers, geographic features, swimmers, and/or any other obstacles that may be present in the water. Other maneuvers or scenarios may involve negotiating such obstacles as well, such as station-keeping maneuvers whereby the craft maintains its heading while minimizing its translation, or virtual “anchoring” maneuvers whereby the craft maintains a given geographical position in the water (perhaps without throwing a physical anchor). While propellers affixed to the wings of the craft can be used to an extent to maneuver the craft while in the water, it may not be practical or desirable to operate those propellers when such obstacles are present.

Various examples of craft that perform particular hull-borne maneuvering operations to address the challenges encountered by craft when hull-borne are described below. Some examples of these craft include various control elements that may be operated individually or in concert with one another to facilitate performing the maneuvering operations. Some examples of these control elements are fixed/coupled to the main wing of the craft (i.e., wing-affixed), such as propellers that are distributed along the main wing of the craft and propulsion systems positioned within outriggers or pontoons that are provided at opposite ends of the main wing. Some examples of these control elements are fixed/coupled to the hull of the craft (i.e., hull-affixed), such as front and rear hydrofoils, propulsion pods, bow thrusters, and the rudder. These control elements, in conjunction with environmental factors (e.g., wind, current, waves, etc.), facilitate movement of the craft while it is hull-borne.

Some examples of the craft comprise a control system that controls the operation of the control elements to facilitate performing the hull-borne maneuvering operations. Some particular maneuvering operations performed by the craft include anchoring/mooring, docking, and station-keeping. In some examples, performing these maneuvering operations involves the control system operating the control elements to maintain the heading of the craft, cause the craft to move to a target location, and minimize lateral movement of the craft away from a target location.

For instance, the control system may receive an indication from the pilot to anchor the craft at its current location. In some examples, after receiving this indication, the control system may set the current location as a target location and operate the control elements to minimize lateral movement of the craft away from the target location. In another example, the control system may receive an indication to dock the craft at a particular location. After receiving this indication, the control system may set the target location as the location of the dock and then determine a path to traverse to reach the dock. For example, the control system may operate one or more control elements to cause the craft to travel along a first heading to a first waypoint and then to the target location (i.e., the dock location) along a second heading. In another example, the control system may receive an indication to perform a station-keeping operation to maintain the craft at a target location and pointing in a particular target heading. For example, if the craft heading is pointing into the wind and/or into the direction of the water current, the control system may operate the control elements (e.g., to generate thrust) to counteract the force of the wind and/or water current acting on the craft. In some examples, if crosswinds or currents are present, the control system may operate the control elements to cause the craft to perform a series of turning maneuvers so that the craft heading points into the wind and/or current and is at the target location. Once the craft heading points into the wind, the control system may operate the control elements to generate an equal amount of thrust that is sufficient to counteract the force of the wind acting on the craft.

In some examples, the control system receives one or more environmental indications of environmental forces acting on the craft (e.g., wind, water current direction, waves) and determines which control elements should be operated to maneuver the craft and how they should be operated based on the environmental indications. For instance, the control system may receive a target location and information indicative of a force acting on the craft due to wind blowing on the craft and may operate one or more control elements to maneuver the craft to the target location and in a manner that compensates for the force acting on the craft due to the wind blowing on the craft. In some examples, the control system continuously monitors the craft's heading and/or location relative to a target heading and/or target location and the wind direction and dynamically adjusts the control element to maintain the craft on course toward the target location.

In some examples, the control system performs the hull-borne maneuvering operations after first determining that, for example, the water speed of the craft is below a threshold speed (e.g., 7 knots), the propellers are not engaged, the pumps of the propulsion system are submerged in the water (e.g., using sensors and to prevent an “airlock” condition), etc.

As indicated above, in some examples, the propellers of the craft are operated in a manner that facilitates performing one or more of the maneuvering operations described above. For example, forward thrust generated by the propellers on, for example, the starboard side of the craft can be increased relative to forward thrust generated (if any) by the propellers on the port side of the craft to impart forward and yaw forces on the craft to move the craft leftward. In another example, propellers on the starboard side of the craft can be rotated in a direction that provides forward thrust, and the propellers on the port side of the craft can be rotated in a direction that provides an amount of reverse thrust to impart yaw on the craft that rotates the craft about its yaw axis. The port and starboard propellers may be set to provide the same amount of thrust and in the same forward/backward direction to cause the craft to move forward or backward without introducing a significant yaw moment.

Some examples of the maneuvering operations described herein may involve several sub-maneuvers to be performed. For example, a particular maneuvering operation to maneuver the craft to a dock or other anchoring location may involve rotating the craft to a first heading, then moving along the first heading to a first location, then rotating to a second heading, and then moving along the second heading to a second location. In this regard, a first sub-maneuver may involve operating some propellers in a first direction during a first period, and a second/subsequent sub-maneuver may involve operating some propellers in the opposite direction. In some maneuvering operations, the different operations may need to be performed in rapid succession (e.g., transitioning between sub-maneuvers in under 3 seconds).

However, quickly reversing the direction of the propellers to change the direction of thrust between sub-maneuvers can, in some instances, be impractical. For example, some examples of propellers used by some examples of craft described herein might typically take upwards of 10 seconds to transition between providing 50% thrust in a first direction to providing 50% thrust in the opposite direction.

Accordingly, in some examples, the propellers of the craft are operated such that during maneuvering operations, the propellers are operated in a single direction. For example, during particular maneuvering operations that require numerous sub-maneuvers to complete, a first subset of propellers is operated in the forward direction, and a different subset of the propellers is operated in the opposite direction.

Further, it was observed that in some implementations, when the propellers were completely shutdown (i.e., not rotating), it might typically take the propellers between about 1.5-2 seconds to spin up to their maximum rotation rate, but if the propellers were not completely shutdown (e.g., generating a minimum/negligible amount of thrust), this time could be reduced 50%. For instance, in an example implementation, idling a particular propeller at 800 RPM as opposed to starting the propeller from a zero-rotation rate state reduced the amount of time it took for the propeller to reach its maximum rotation rate of 3000 RPM from 2 seconds down to 0.25 seconds. Therefore, in some examples, the rotation rates of the propellers that are used during the maneuvering operations are modulated between a minimum/idle rotation rate at which the thrust generated has a negligible effect on the maneuvering of the craft and higher rates at which the thrust generated contributes meaningfully to the maneuvering of the craft.

In some examples, the propellers have a variable pitch. In these examples, the rotation rate of the propellers may be set to operate at a fixed rate and in a fixed direction during the maneuvering operations, and the propeller pitch may be adjusted to control the amount of thrust generated by specific propellers.

In some instances, such as when obstacles are present that may interfere with the operation of the propellers, it may be more advantageous to use the outrigger propulsion systems to perform the maneuvering operations. Some examples of the outrigger propulsion systems are integrated within the outriggers of the craft and cause water to be ejected from the underside of the outriggers and in a direction that has a horizontal component to provide horizontal thrust.

As indicated above, in some examples, propulsion systems positioned within outriggers or pontoons that are provided at opposite ends of the main wing are operated in a manner that facilitates performing one or more of the maneuvering operations described above. In this regard, in some examples, each outrigger comprises an outrigger body having a longitudinal axis that extends from the front end of the outrigger to the rear end of the outrigger and that is substantially parallel to a longitudinal axis of the craft. The outrigger body comprises a section that, in hull-borne operations, is generally below the water surface (e.g., a lower or bottom surface) and that comprises a first opening and a second opening. An inner channel extends between the first opening and the second opening. In these examples, a pump is provided in the outrigger body and is configured to cause water to be pulled into the first opening, moved through the inner channel, and ejected from the second opening. In some examples, the first opening is proximate to the front end of the outrigger, and the second opening is proximate to the rear end of the outrigger. Providing the openings on the bottom surface of the outrigger, as opposed to, for example, the leading and trailing edges of the outrigger, minimizes the amount of drag that would otherwise be generated by the respective openings when the craft is in use in other applications, including when the craft is airborne.

As indicated above, the first opening and the second opening are generally configured so that they are below the water surface when the craft is hull-borne. This reduces the chances of air becoming trapped in the inner channel and causing a condition where excess air is contained within the channel (perhaps an “airlock” condition), which may prevent the pump from effectively moving water. In some examples, the inner channel is positioned so that when the craft is hull-borne, the inner channel is also below the surface of the water. This further reduces the chances of air becoming trapped in the inner channel. In this regard, in some examples, one or more sensors may be provided within the inner channel to determine whether the inner channel is filled with water.

In some examples, whether the outrigger body is in the water (e.g., the first opening and second opening are below the water surface) and/or whether the inner channel is below the surface of the water can be inferred based on the geometry of the craft. Techniques for inferring the relative location/position of various features of a craft are disclosed in U.S. Provisional App. 63/495,852, titled “On Water Inference of Airborne Craft with Hydrofoil,” filed Apr. 13, 2023, which is incorporated herein by reference in its entirety.

Some examples of the inner channel comprise a first section proximate to the first opening and a second section proximate to the second opening. The second section extends towards the second opening such that during a first mode of operation in which water is ejected from the second opening, the direction in which the water is ejected has a horizontal component. This horizontal component of the ejected water generates thrust that moves the corresponding outrigger in a first direction. In some examples, the first section similarly extends toward the first opening such that when the pump is reversed in a second mode of operation, water is pulled into the second opening, moved through the inner channel, and ejected from the first opening generating thrust in a second/opposite direction. These operations facilitate moving the craft in the lateral/horizontal direction (e.g., forward, backward, side-to-side, circular, etc.).

In some examples, the first section extends towards the first opening at a different angle and/or the diameter/volume of the first opening and the first section are greater than the diameter/volume of second section and the second opening such that the amount of thrust that can be generated to move the craft in the forward direction is greater than the amount of thrust that can be generated to move the craft in the reverse direction.

In some examples, the bottom surface section of each outrigger comprises a third opening between the first opening and the second opening. The pump in these examples is configured to cause water to be pulled into the third opening, moved through the inner channel, and ejected from either the first opening to cause thrust to be generated in a first direction or from the second opening to cause thrust to be generated in a second direction that is opposite the first direction. Some examples of the pump used in this configuration correspond to centrifugal pumps.

Some examples of the propulsion systems comprise a first actuatable cover and a second actuatable cover that are configured to selectively cover the first opening and the second opening, respectively. (When a third opening is present, a third actuatable cover may be provided, and so forth). The first actuatable cover and the second actuatable cover are controlled to cover the first opening and the second opening, respectively, to facilitate airborne operations of the craft. Covering these openings can reduce drag on the craft that results from the air blowing over the openings. The first actuatable cover and the second actuatable cover are controlled to uncover the first opening and the second opening, respectively, to facilitate hull-borne maneuvering operations of the craft.

Some examples of WIG craft that are configured to take off from water are described herein. These craft include retractable hydrofoils that are extended during takeoff to generate additional upward lift as the craft approaches take-off speeds. The upward lift raises the hull of the craft above the water. This action i) reduces the wetted surface area of the craft and therefore drag on the craft and ii) allows the craft to cruise through rough waters during takeoff without colliding with waves. Once airborne, the hydrofoils may be retracted. Some examples of these craft include and implement features disclosed in U.S. patent application Ser. No. 17/570,090, filed Jan. 6, 2022 (hereinafter '090 application), and U.S. patent application Ser. No. 17/845,480, filed Jun. 21, 2022 (hereinafter '480 application). The '090 and '480 applications are incorporated herein by reference in their entirety. The '090 application describes, among other things, a seaglider that includes a pair of retractable hydrofoils (e.g., main and rear hydrofoils) that facilitate hydrofoil-borne operation of the craft. The '480 application describes, among other things, a seaglider that implements a bi-plane tail.

Other examples of craft to which the aspects described herein can be applied correspond to blown wing craft. In these craft, air is blown over the wings of the craft by propellers, and the blowing of the air over the wings contributes meaningfully to the overall lift acting on the craft. Examples of these craft can include 4, 5, 6, or even more propellers on each wing. Some examples of the WIG craft described herein are blown wing craft. Some of these craft include six propellers on each wing, making these craft better suited for commercial travel. These and other aspects are discussed in more detail in the passages that follow.

### II. EXAMPLE WING-IN-GROUND EFFECT VEHICLES

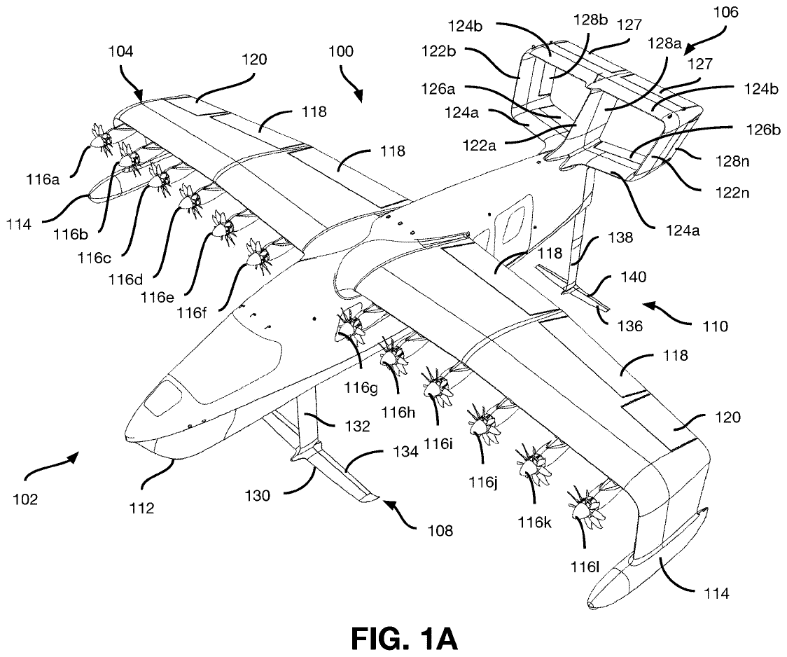

FIGS. 1A-1D illustrate different views of an example of a craft 100. As shown, some examples of the craft 100 include a hull 102, a main wing 104, a tail 106, a main hydrofoil assembly 108, and a rear hydrofoil assembly 110.

### A. Hull

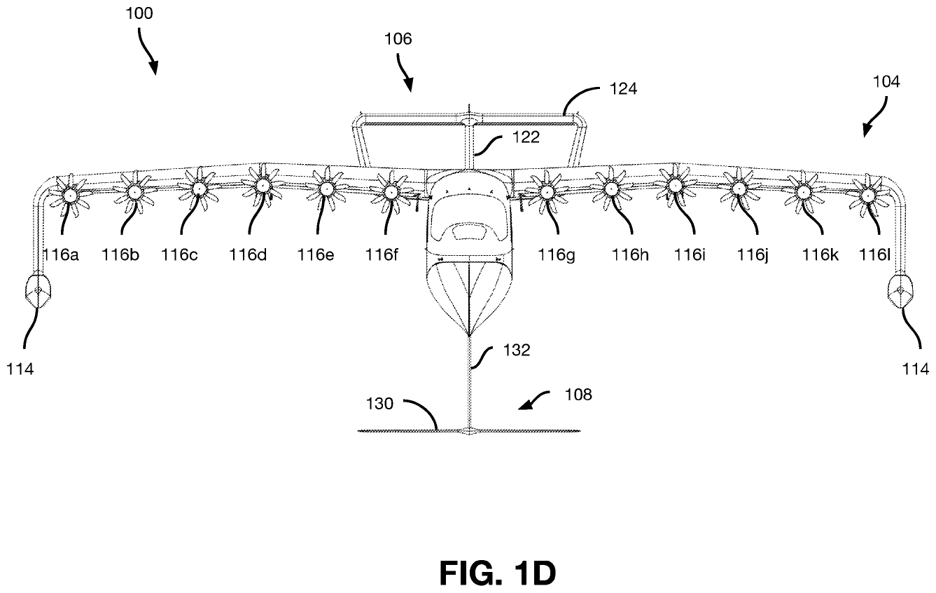

Some examples of the craft 100 operate in a first waterborne mode for an extended period of time, during which the hull 102 is at least partially submerged in water. As such, some examples of the hull 102 are configured to be watertight, particularly for surfaces of the hull that contact the water during this first waterborne operational mode. Further, some examples of the hull 102, as well as the entirety of the craft 100, are configured to be passively stable on all axes when floating in water. To help achieve this, some examples of the hull 102 include a keel (or centerline) 112, which provides improved stability and other benefits described below. Some examples of the craft 100 include various mechanisms for adjusting the center of mass of the craft 100 so that the center of mass aligns with the center of buoyancy of the craft 100. For instance, in some examples, a battery system (described in further detail below in connection with FIG. 4) of the craft 100 is electrically coupled to one or more moveable mounts. Some examples of the mounts are moved by one or more servo motors or the like. In some examples, a control system of the craft 100 is configured to detect a change in its center of buoyancy, for instance, by detecting a rotational change via an onboard gyroscope, and responsively operate the servo motors to move the battery system until the gyroscope indicates that the craft 100 has stabilized. Some examples of the craft 100 include a ballast system for pumping water or air to various tanks distributed throughout the hull 102 of the craft 100. The ballast system facilitates adjusting the center of mass of the craft 100 so that the center of mass aligns with the center of buoyancy of the craft 100. Other example systems may be used to control the center of mass of the craft 100 as well.

Additionally, or alternatively, some examples of the hull 102 are configured to reduce drag forces when both waterborne and wing-borne. For instance, some examples of the hull 102 have a high length-to-beam ratio (e.g., greater than or equal to 8), which facilitates reducing hydrodynamic drag forces when the craft 100 is under forward waterborne motion. Some examples of the keel 112 are curved or rockered to improve maneuverability when waterborne. Further, some examples of the hull 102 are configured to pierce the surface of waves (e.g., to increase passenger and crew comfort) by including a narrow, low-buoyancy bow portion of the hull 102.

### B. Wing and Distributed Propulsion System

As shown in FIGS. 1A-1D, some examples of the main wing 104 include an outrigger 114 at each end of the main wing 104. The outriggers 114 (which are sometimes referred to as “wing-tip pontoons”) are configured to provide a buoyant force to the main wing 104 when submerged or when otherwise in contact with the water, which improves the stability of the craft 100 during waterborne operation. Some examples of the outriggers 114 may also include integrated pumps (e.g., propeller pumps) that facilitate providing thrust in some scenarios, as described in more detail below.

As shown in FIG. 1D, some examples of the main wing 104 have a gull-wing shape such that the outriggers 114 at the ends of the main wing 104 are at the lowest point of the main wing 104 and are positioned approximately level with (or slightly above) a waterline of the hull 102 when the hull 102 is waterborne.

Some examples of the main wing 104 have a high aspect ratio, which is defined as the ratio of the span of the main wing 104 to the mean chord of the main wing 104. In some examples, the aspect ratio of the main wing 104 is greater than or equal to five, or greater than or equal to six, but other example aspect ratios are possible as well. Such wings tend to have reduced pitch stability and maneuverability due to lower roll angular acceleration. These issues are ameliorated by various mechanisms described below. On the other hand, such wings tend to have increased roll stability and increased efficiency resulting from higher lift-to-drag ratios. Further, high aspect ratio wings provide a longer leading edge for the mounting of a distributed propulsion system along the wing.

As shown in the figures, some examples of the main wing 104 include a number of electric motor propeller assemblies 116a, 116b, 116c, 116d, 116e, 116f, 116g, 116h, 116i, 116j, 116k, and 116l (sometimes referred to collectively herein as propeller assemblies 116) distributed across a leading edge of the main wing 104. This arrangement corresponds to a blown-wing propulsion system. Arranging the propeller assemblies 116 in this manner increases the speed of air moving over the main wing 104, which increases the lift generated by the main wing 104. This increase in lift allows the craft 100 to take off and become wing-borne at slower vehicle speeds. This facilitates, for example, taking off on water which can be difficult at higher speeds due to the various forces that would otherwise act on the craft 100.

The electric motor propeller assemblies 116 tend to be much lighter, less complex, and smaller than the liquid-fueled engines used on conventional craft. Some examples of the electric motor propeller assemblies 116 are controlled by an electronic speed controller and powered by an onboard battery system (e.g., a lithium-ion system, magnesium-ion system, lithium-sulfur system, etc.). Some examples of the electric motor propeller assemblies 116 are controlled by a fuel cell or a centralized liquid-fueled electricity generator. In some examples, the onboard electrical supply system includes multiple systems for supplying power during different operational modes, such as a first battery system configured to deliver large amounts of power during takeoff and a second system with a higher energy density but lower peak power capability for delivering sustained lower power during cruise operation (e.g., during hydrofoil waterborne operation or during wing-borne operation, each of which are described in further detail below).

In some examples, the positioning of the electric motor propeller assemblies 116 along the leading edge of the main wing 104 is determined based on a variety of factors including, but not limited to, (i) the total thrust for all modes of operation of the craft 100, (ii) the thrust generated by each individual propeller of the propeller assemblies 116, (iii) the radius of each propeller in the respective propeller assemblies 116, (iv) the tip clearance between each propeller and the surface of the water, and (v) the additional freestream speed over the main wing 104 required for operation.

As shown in the figures, in some examples, the number of propeller assemblies 116 is symmetrical across both sides of the hull 102. In some examples, the propeller assemblies 116 are identical. In some examples, the propeller assemblies 116 have different propeller radii or blade configurations along the span so long as the configuration is symmetrical across the hull 102. The different radii facilitate adequate propeller tip clearance from the water or vehicle structure. In some examples, the different propellers are optimized for different operational conditions, such as wing-borne cruise. The propeller placement and configuration may vary to increase the airflow over the main wing 104 or tail system 106 to improve controllability or stability. While eight total propeller assemblies 116 are illustrated, the actual number of propeller assemblies 116 can vary based on the requirements of the craft 100.

In some examples, the propeller assemblies 116 have different pitch settings or variable pitch capabilities based on their position on the main wing 104. For instance, in some examples, a subset of the propeller assemblies 116 have fixed-pitch propellers sized for cruise speeds, while the remainder of the propeller assemblies 116 have fixed-pitch propellers configured for takeoff or can allow for varying the propeller's pitch.

In some examples, different propeller assemblies 116 are turned off or have reduced rotational speeds during different modes of operation. For instance, during waterborne operation, one or more of the propeller assemblies 116 may be turned off or have reduced rotational speeds in a manner that generates asymmetrical thrust. This may create a yawing moment on the craft 100, allowing the craft 100 to turn without large bank angles and increasing the turning maneuverability of the craft 100. For instance, in order to yaw right, the craft 100 may increase the rotational speeds of the propellers of one or more of propeller assemblies 116g-1 while decreasing the rotational speeds of the propellers of one or more of propeller assemblies 116a-f. Similarly, to yaw left, the craft 100 may increase the rotational speeds of the propellers of one or more of propeller assemblies 116a-f while decreasing the rotational speeds of the propellers of one or more of propeller assemblies 116g-1.

Similarly varying rotational speeds or propeller pitches may be used to yaw or roll the aircraft in flight or while foiling due to varied forces and lift distributions imposed over the wing and its control surfaces or in general used to tailor the lift distribution across the wing for optimized efficiency.

In some examples, the propeller assemblies may tilt to vector thrust either to provide directly more vertical lift or to change how the wing is blown depending on the mode of operation so as to tailor the blown lift distribution.

Some examples of the main wing 104 include one or more aerodynamic control surfaces, such as flaps 118 and ailerons 120. In some embodiments, the aerodynamic control surfaces on the main wing 104 include one or more flaps 118, ailerons 120, flaperon (i.e., combining the functions of a flap and an aileron), spoiler, and/or or any other aerodynamic control surface now known or later developed, in any combination suitable for controlling a craft in the manner(s) disclosed and described herein. Some examples of these controls comprise movable hinged surfaces on the trailing or leading edges of the main wing 104 for changing the aerodynamic shape of the main wing 104. Some examples of the flaps 118 are configured to extend downward below the main wing 104 to reduce stall speed and create additional lift at low airspeeds, while some examples of the ailerons 120 are configured to extend upward above the main wing 104 to decrease lift on one side of the main wing 104 and induce a roll moment in the craft 100. In some examples, the ailerons 120 are additionally configured to extend downward below the main wing 104 in a flaperon configuration to help the flaps 118 generate additional lift on the main wing 104, which, in some examples, is used to either create a rolling moment or additional balanced lift depending on coordinated movement of both ailerons. Some examples of the flaps 118 and ailerons 120 include one or more actuators for raising and lowering the flaps 118 and ailerons 120. Within examples, the flaps 118 include one or more of plain flaps, split flaps, slotted flaps, Fowler flaps, slotted Fowler flaps, Gouge flaps, Junkers flaps, or Zap flaps. Further, in some examples, the flaps 118 (and the ailerons 120 when configured as flaperons) are positioned to be in the wake of one or more of the propeller assemblies 116. In some examples, the ailerons 120 are positioned so that they are in the wake of one or more of the propeller assemblies 116 to increase the effectiveness of the ailerons at low forward velocities. Some of the propeller assemblies 116 are positioned so that no ailerons 120 are in their wake to increase thrust on the outboard wing during a turn without inducing adverse yaw. For example, in a left turn, a normal airplane would have adverse yaw to the right as the right aileron is deflected down, increasing drag. In the present disclosure, however, the right propeller assembly outboard of the right aileron may have its thrust increased relative to the respective left propeller assembly, initiating a turn without adverse yaw.

### C. Tail System

As illustrated in FIGS. 1A-1D, some examples of the tail 106 include a vertical stabilizer 122, horizontal stabilizers 124a and 124b (sometimes referred to herein collectively as horizontal stabilizers 124), and one or more control surfaces, such as one or more elevators 126a and 126b (sometimes referred to herein collectively as elevators 126) and one or more tail flaps 127 (sometimes also referred to as elevators). In some embodiments, the tail 106 may include any one or more tail flaps, elevators, rudders, and/or any other aerodynamic control surface now known or later developed, in any combination suitable for controlling a craft in the manner(s) disclosed and described herein. Similar to the flaps 118 and ailerons 120, some examples of the elevators 126 comprise movable hinged surfaces on the trailing or leading edges of the horizontal stabilizer 124 for changing the aerodynamic shape of the horizontal stabilizer 124 to control a pitch of the craft 100. Some examples of the horizontal stabilizer 124 are combined with the elevator 126, creating a fully articulating horizontal stabilizer (e.g., a stabilator). Raising the elevator 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. Some examples of the elevators 126 include actuators, which are operated by a control system of the craft 100 to raise and lower the elevators 126.

As illustrated in FIGS. 1A-1D, some examples of tail 106 include a rudder 128. Some examples of the rudder 128 comprise a movable hinged surface on the trailing edge of the vertical stabilizer 122 for changing the aerodynamic shape of the vertical stabilizer 122 to control the yaw of the craft 100 when operating in an airborne mode. In some examples, the rudder 128 additionally changes a hydrodynamic shape of the hull 102 to control the yaw of the craft 100 when operating in a waterborne mode. To facilitate such hydrodynamic control, in some examples, the rudder 128 is positioned low enough on the tail 106 that the rudder 128 is partially or entirely submerged when the hull 102 is floating in water. For instance, the rudder 128 is positioned partially or entirely below the waterline of the hull 102. Some examples of the rudder 128 include one or more actuators, which are operated by a control system of the craft 100 to rotate the hinged surface of the rudder 128 to the left or right of the vertical stabilizer 122. Actuating the rudder 128 to the left (relative to the direction of travel) causes the craft 100 to yaw left. Actuating the rudder 128 to the right (relative to the direction of travel) causes the craft 100 to yaw right. As such, the rudder 128 may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

Some examples of the tail 106 include one or more vertical stabilizers 122a, 122b, 122n, one or more horizontal stabilizers 124a, 124b, one or more control surfaces, such as elevators 126, and one or more tail flaps 127 for enhanced pitch control configured to exert enhanced net downward force on the tail system. It should be understood that although the figures show only two horizontal stabilizers, it is contemplated that more than two of each can be used within the scope of the present teachings. In some applications, it has been found that the transition from waterborne operation to airborne or wing-borne operation can require a larger pitching moment to overcome the larger drag forces existing between the hull 102 and/or the hydrofoil assemblies 108, 110 and the water. This phenomenon can further occur in wheeled aircraft configured for short takeoff and landing (STOL) operations. In this way, at low airspeeds, aerodynamic forces in conventional designs fail to produce sufficient downward force to permit sufficient pitching moment. To provide sufficient pitching moment to pitch the craft 100 upward, a conventional solution would be to increase the span of the tail so that the elevator generates more force; however, a resultant consequence of increasing the span of the tail is that the entire tail must be stronger and heavier, which can result in undesired reduction of payload and efficiency. However, the present configuration provides improved performance by providing a tail 106 having a first horizontal stabilizer 124a and a second horizontal stabilizer 124b. It should be understood that one or more additional horizontal stabilizers can be used.

In some examples, a first horizontal stabilizer 124a is a lower horizontal stabilizer relative to a second horizontal stabilizer 124b. However, it should be appreciated that the horizontal stabilizers in some examples can be interchanged for performance purposes (e.g., the disclosed structure of the first horizontal stabilizer 124a can be incorporated in the upper horizontal stabilizer and the disclosed structure of the second horizontal stabilizer 124b can be incorporated in the lower horizontal stabilizer). In some non-limiting examples, the structure, shape, and/or performance of each horizontal stabilizer can be tailored as desired such that the lower horizontal stabilizer (in this example, the first horizontal stabilizer 124a) is more likely to experience aerodynamic effect from being in the wake of the blown-wing propulsion system disclosed herein or associated wake produced by alternative propulsion systems. In this way, greater aerodynamic control and/or downwards lift can be generated during desired phases of operation.

Some examples of the horizontal stabilizers 124a, 124b (sometimes collectively referred to herein as horizontal stabilizers 124) include one or more aerodynamic control surfaces, such as tail flaps 127 (sometimes also referred to as elevators) and elevators 126a, 126b (sometimes collectively referred to herein as elevators 126), which may comprise movable hinged surfaces on the trailing or leading edges of the horizontal stabilizer 124a, 124b for changing the aerodynamic shape of the respective horizontal stabilizer 124a, 124b. It should be recognized that at least one of the horizontal stabilizers 124a, 124b can be sized, shaped, and/or spaced relative to a second of the horizontal stabilizers 124a, 124b to enhance or minimize the aerodynamic effect on the adjacent stabilizers. In this way, the aerodynamic flow, pressures, and/or forces can be used to improve the efficiency or effectiveness of the adjacent stabilizer. In some examples, at least one of the horizontal stabilizers 124a, 124b can be actuated in an opposing direction. In some embodiments, at least one of the horizontal stabilizers 124a, 124b can define a ratio of a surface area of the first horizontal stabilizer to a surface area of the second horizontal stabilizer in the range of 0.9 to 1.6. In some non-limiting example configurations, the surface area of the first horizontal stabilizer is 5.7 m2, the surface area of the second horizontal stabilizer is 3.9 m2, both have a chord of about 1 m and a vertical separation of 1.8 m. In some embodiments, a vertical separation distance between the first horizontal stabilizer and the second horizontal stabilizer is in the range of 0.25 to 0.75 of the lower horizontal stabilizer span. In some examples, a vertical separation distance can be dependent on the required rudder authority and thus elevator size (driven by, e.g., yaw stability, or the need to counteract asymmetric thrust following powerplant failure). In some examples, a sweep offset moves the center of pressure further aft from the center of gravity, thus allowing the airfoil of the horizontal stabilizer to have less surface area overall, thus being smaller and lighter. In some examples, a dihedral in the bottom surface of the horizontal stabilizer adds stability. In some examples, the box tail design itself increases the efficiency due to the elimination of wingtip vortices of a typical tail. In some embodiments, a lower horizontal stabilizer may have approximately a 15% thickness-to-chord ratio to support the weight of the upper components, whereas the vertical and upper surfaces may be thinner, such as, for example, 10% thickness-to-chord ratio due to reduced structural load requirement, which enables the upper horizontal stabilizer to be more efficient (lower drag). It should be appreciated that the left and right elevator surfaces 126 can be controlled independently and/or differentially to create a rolling moment, thereby enabling the wing ailerons 120 to be made smaller. The smaller wing ailerons 120 further enable larger flaps 118. It should be appreciated that in some embodiments, using the vertical control surfaces 128a, 128b, 128n can change the pressure distribution across the elevator 126, for example, commanding a left 5 degree deflection in the left vertical control surface may move the mean pressure distribution left/right by a percentage of the elevator width.

Some examples of the tail flaps 127 are configured to selectively extend upward above the horizontal stabilizer 124 for changing a surface area, camber, aspect ratio, and/or shape of the horizontal stabilizer 124. The tail flaps 127 may include, for example, one or more of plain flaps, split flaps, slotted flaps, Fowler flaps, slotted or double-slotted Fowler flaps, Gouge flaps, Junkers flaps, or Zap flaps. That is, in some examples, tail flaps 127 serve to change an angle of attack of the horizontal stabilizer 124, change a chord line of the horizontal stabilizer 124, change a surface area of the horizontal stabilizer 124, and/or otherwise increase the net effective downwardly directed lift of the horizontal stabilizer 124. Such configurations effectively reduce the speed at the horizontal stabilizer 124 becomes aerodynamically effective by creating additional net downward force at low airspeeds to aid in exerting a nose-up pitching moment of the craft 100. The elevators 126 may be configured for changing the aerodynamic shape of the horizontal stabilizer 124 to further control or vary a pitch of the craft 100.

In some examples operations, the tail flaps 127 are deployed for takeoff (e.g., transition from hydrofoil-borne mode to airborne mode) and landing (e.g., transition from airborne mode to hull-borne mode) to generate additional downforce on the tail system when additional pitch-up moment is required. Tail flaps 127 can be stowed for other phases of operation, such as hull-borne mode, to reduce downforce on the tail system and reduce drag.

In some examples, the elevators 126 are additionally configured to extend upward above the horizontal stabilizer 124 in a flaperon-like configuration (yet with elevators, rather than ailerons) to help the tail flaps 127 generate additional downward force on the horizontal stabilizer 124, which may be used to either create a pitching moment or additional balanced downward force. The tail flaps 127 and elevators 126 may each include one or more actuators 125 for raising and lowering the tail flaps 127 and elevators 126, singly or in combination. The actuators 125 can comprise any system configured to selectively actuate the associated system, such as but not limited to a flap track system (integrated into vertical stabilizers 122a, 122b, 122n, which can reduce complex hinge systems or external arms, thereby reducing wetted area and excrescences drag), an electric servo motor mounting within the vertical stabilizers 122a, 122b, 122n and/or horizontal stabilizers 124a, 124b, and/or a central vertical strut system generally mounted in the hull 102 or the fuselage of the craft 100 (to provide the potential for reduced cross-sectional area and associated drag).

Further, in some examples, the elevators 126 and/or the tail flaps 127 are positioned so that they are in the wake 129 of one or more of the propeller assemblies 116 of main wing 104. The elevators 126 and/or the tail flaps 127 may be positioned so that they are in the wake 129 of one or more of the propeller assemblies 116 to increase the effectiveness of the elevators at low forward velocities. In some examples, the propeller assemblies 116 are positioned so that no elevators 126 and/or tail flaps 127 are in the wake 129 to ensure consistent and/or predictable aerodynamic forces, independent of power application, are exerted during critical operational phases. In some examples, the propeller assemblies 116 are positioned so that the elevators 126 are in their wake 129 and the tail flaps 127 are not in the wake 129 (e.g., above the wake 129) and are exposed to clean air 131. It should be understood that positioning of the tail flaps 127 in the second horizontal stabilizer 124b, or at a distance above the center of gravity of the craft 100, will have the added unexpected benefit of creating additional nose-up pitching moment as a result of induced drag acting about the center of gravity causing the craft 100 to pitch upward.

Similar to the flaps 118 and the ailerons 120 of the main wing 104, some examples of the elevators 126 comprise movable hinged surfaces on the trailing or leading edges of the horizontal stabilizer 124 for changing the aerodynamic shape of the horizontal stabilizer 124 to control a pitch of the craft 100. The horizontal stabilizer 124 may be combined with the elevator 126, creating a fully articulating horizontal stabilizer (e.g., a stabilator). Raising the elevators 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. The elevators 126 may include actuators, which may be operated by a control system of the craft 100 in order to raise and lower the elevators 126.

In some examples, the tail 106 includes one or more rudders 128a, 128b, 128n. The rudders 128a, 128b, 128n may each comprise a movable hinged surface on the trailing edge of the corresponding vertical stabilizers 122a, 122b, 122n for changing the aerodynamic shape of the vertical stabilizer 122 to control the yaw of the craft 100 when operating in an airborne mode. It should be understood that rudders 128a, 128b, 128n can operate independently or in combination as desired. Moreover, in some examples, rudders 128a, 128b, 128n can be used as redundant systems, particularly useful in the event of one or more failures.

In some examples, the rudders 128a, 128b, 128n additionally change a hydrodynamic shape of the hull 102 to control the yaw of the craft 100 when operating in a waterborne mode. In order to facilitate such hydrodynamic control, the rudders 128a, 128b, 128n may be positioned low enough on the tail 106 that one or more of the rudders 128a, 128b, 128n is partially or entirely submerged when the hull 102 is floating in water. Namely, the rudders 128a, 128b, 128n may be positioned partially or entirely below a waterline of the hull 102. The rudders 128a, 128b, 128n may include one or more actuators, which may be operated by a control system of the craft 100 in order to rotate the hinged surface of the rudders 128a, 128b, 128n to the left or right of the vertical stabilizer 122. Actuating the rudders 128a, 128b, 128n to the left (relative to the direction of travel) causes the craft 100 to yaw left. Actuating the rudders 128a, 128b, 128n to the right (relative to the direction of travel) causes the craft 100 to yaw right. As such, the rudders 128a, 128b, 128n may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

It should be understood that the fundamental shape of tail 106, having one or more vertical stabilizers 122a, 122b, 122n and one or more horizontal stabilizers 124a, 124b, can result in a box-like assembly, wherein the vertical stabilizers are generally coupled to the horizontal stabilizers to form a reinforced box-like construction. This box-like construction provides enhanced structural integrity that enables tail 106 of some examples to be lighter and/or smaller than otherwise constructed.

Some examples of the craft 100 include a distributed propulsion system on the tail 106, which may be similar to the distributed propulsion system of propeller assemblies 116 on the main wing 104. Such a distributed propulsion system may provide similar benefits of increasing the freestream velocity over the control surfaces (e.g., the elevators 126 and/or the rudder 128) to allow for increased pitch and yaw control of the craft 100 at lower travel speeds. When determining the number and size of propeller assemblies to include on the tail 106, one may apply the same factors described above when determining the number and size of propeller assemblies to include on the main wing 104.

### D. Hydrofoil Systems

As noted above, some examples of the craft 100 include a main hydrofoil assembly 108 and a rear hydrofoil assembly 110. In some examples, the main hydrofoil assembly 108 is positioned proximate to the middle or bow of the craft 100, and the rear hydrofoil assembly 110 is positioned proximate to the stern. For instance, some examples of the main hydrofoil assembly 108 is positioned between the bow and a midpoint (between the bow and stern) of the craft 100, and some examples of the rear hydrofoil assembly 110 is positioned below the tail 106 of the craft 100.

The main hydrofoil assembly 108 and the rear hydrofoil assembly 110 are configured to facilitate the breaking of contact between the hull of the craft and the water surface during takeoff, which, as noted above, can otherwise be challenging in some conventional craft designs. Some examples of the main hydrofoil assembly 108 and the rear hydrofoil assembly 110 are configured to be retractable, large enough to lift the entire craft out of the water and not impact the water surface, and to enable sustained operation in the hydrofoil-borne mode (where the entire weight of the craft is supported by the one or more hydrofoil assemblies).

Some examples of the main hydrofoil assembly 108 include a main hydrofoil 130, one or more main hydrofoil struts 132 that couple the main hydrofoil 130 to the hull 102, and one or more main hydrofoil control surfaces 134. Similarly, some examples of the rear hydrofoil assembly 110 include a rear hydrofoil 136, one or more rear hydrofoil struts 138 that couple the rear hydrofoil 136 to the hull 102, and one or more rear hydrofoil control surfaces 140.

Some examples of the main hydrofoil 130 and the rear hydrofoil 136 take the form of one or more hydrodynamic lifting surfaces (also referred to as “foils”) configured to be operated partially or entirely submerged underwater while the hull 102 of the craft 100 remains above and clear of the water's surface. In operation, as the craft 100 moves through water with the main hydrofoil 130 and the rear hydrofoil 136 submerged, the hydrofoils generate a lifting force that causes the hull 102 to rise above the surface of the water. In general, the lifting force generated by the hydrofoils must be at least equal to the weight of the craft 100 to cause the hull 102 to rise above the surface of the water. The lifting force of the hydrofoils depends on the speed and angle of attack at which the hydrofoils move through the water, as well as their various physical dimensions, including the aspect ratio, the surface area, the span, and the chord of the foils.

The height at which the hull 102 is elevated above the surface of the water during hydrofoil-borne operation is limited by the length of the one or more main hydrofoil struts 132 that couple the main hydrofoil 130 to the hull 102 and the length of the one or more rear hydrofoil struts 138 that couple the rear hydrofoil 136 to the hull 102. In some examples, the main hydrofoil strut 132 and the rear hydrofoil strut 138 are long enough to lift the hull 102 at least five feet above the surface of the water during hydrofoil-borne operation, which facilitates operation in substantially choppy waters. Struts of other lengths may be used as well. For instance, in some examples, longer struts that allow for better wave-isolation of the hull 102 (but at the expense of the stability of the craft 100 and increasing complexity of the retraction system) are utilized.

In practice, hydrofoils have a limited top speed before cavitation occurs, which results in vapor bubbles forming and imploding on the surface of the hydrofoil. Cavitation not only may cause damage to a hydrofoil but also significantly reduces the amount of lift generated by the hydrofoil and increases drag. Therefore, it is desirable to reduce the onset of cavitation by designing the main hydrofoil 130 and the rear hydrofoil 136 in a way that allows the hydrofoils to operate at higher speeds (e.g., ~20-45 mph) and across the entire required hydrofoil-borne speed envelope before cavitation occurs. For instance, in some examples, the onset of cavitation is controlled based on the geometric design of the main hydrofoil 130 and the rear hydrofoil 136. Additionally, in some examples, the structural design of the main hydrofoil 130 and the rear hydrofoil 136 is configured to allow the surfaces of the hydrofoils to flex and twist at higher speeds, which may reduce loading on the hydrofoils and delay the onset of cavitation.

Further, in some examples, the distributed blown-wing propulsion system described above further facilitates the delay of onset of cavitation on the main hydrofoil 130 and the rear hydrofoil 136. Cavitation is caused by both (i) the amount of lift generated by a hydrofoil and (ii) the profile of the hydrofoil (which is affected by both the hydrofoil's angle of attack and its vertical thickness) as it moves through water. Reducing the amount of lift generated by the hydrofoil delays the onset of cavitation. Because the blown-wing propulsion system creates additional lift on the main wing 104, the amount of lift exerted on the main hydrofoil 130 and the rear hydrofoil 136 to lift the hull 102 out of the water is reduced. Further, because the main hydrofoil 130 and the rear hydrofoil 136 do not need to generate as much lift to raise the hull 102 out of the water, their angles of attack may be reduced as well, which further delays the onset of cavitation. In some examples, combining the blown-wing propulsion system with the hydrofoil designs described herein facilitates operating the craft 100 in a hydrofoil-borne mode at speeds above 35 knots before cavitation occurs.

As noted above, some examples of the main hydrofoil assembly 108 and the rear hydrofoil assembly 110 include one or more main and rear hydrofoil control surfaces 134, 140, respectively. Some examples of the main hydrofoil control surfaces 134 include one or more hinged surfaces on a trailing or leading edge of the main hydrofoil 130 as well as one or more actuators which are operated by the control system of the craft 100 to rotate the hinged surfaces so that they extend above or below the main hydrofoil 130. Some examples of the main hydrofoil control surfaces 134 on the main hydrofoil 130 are operated in a similar manner as the flaps 118 and ailerons 120 on the main wing 104 of the craft 100. In some examples, lowering the control surfaces 134 to extend below the main hydrofoil 130 changes the hydrodynamic shape of the main hydrofoil 130 in a manner that generates additional lift on the main hydrofoil 130, similar to the aerodynamic effect of lowering the flaps 118. In some examples, asymmetrically raising one or more of the control surfaces 134 (e.g., raising a control surface 134 on only one side of the main hydrofoil 130) changes the hydrodynamic shape of the main hydrofoil 130 in a manner that generates a roll force on the main hydrofoil 130, similar to the aerodynamic effect of raising one of the ailerons 120.

Likewise, some examples of the rear hydrofoil control surfaces 140 include one or more hinged surfaces on a trailing or leading edge of the rear hydrofoil 136 as well as one or more actuators, which are operated by the control system of the craft 100 to rotate the hinged surfaces so that they extend above or below the rear hydrofoil 136. In some examples, the rear hydrofoil control surfaces 140 on the rear hydrofoil 136 are operated in a similar manner as the elevators 126 on the tail 106 of the craft 100. In some examples, lowering the control surfaces 140 to extend below the rear hydrofoil 136 changes the hydrodynamic shape of the rear hydrofoil 136 in a manner that causes the craft 100 to pitch downwards, similar to the aerodynamic effect of lowering the elevators 126. In some examples, raising the control surfaces 140 to extend above the rear hydrofoil 136 changes a hydrodynamic shape of the rear hydrofoil 136 in a manner that causes the craft 100 to pitch upwards, similar to the aerodynamic effect of raising the elevators 126.

In some examples, one or both of the main hydrofoil control surfaces 134 or the rear hydrofoil control surfaces 140 include rudder-like control surfaces similar to the rudder 128 on the tail 106 of the craft 100. For instance, some examples of the main hydrofoil control surfaces 134 include one or more hinged surfaces on a trailing edge of the main hydrofoil strut 132 as well as one or more actuators, which are operated by the control system of the craft 100 to rotate the hinged surfaces so that they extend to the left or right of the main hydrofoil strut 132. Similarly, some examples of the rear hydrofoil control surfaces 140 include one or more hinged surfaces on a trailing edge of the rear hydrofoil strut 138 as well as one or more actuators, which are operated by the control system of the craft 100 in order to rotate the hinged surfaces so that they extend to the left or right of the rear hydrofoil strut 138. In some examples, actuating the main hydrofoil control surfaces 134 or the rear hydrofoil control surfaces 140 in this manner changes the hydrodynamic shape of the main hydrofoil strut 132 or the rear hydrofoil strut 138, respectively, which facilitates controlling the yaw of the craft 100 when operating in a waterborne or hydrofoil-borne mode, similar to the effect of actuating the rudder 128 of the craft 100, as described above.

In some examples, instead of (or in addition to) actuating hinged control surfaces on the main hydrofoil 130 and/or the rear hydrofoil 136, a control system of the craft 100 actuates the entire main hydrofoil 130 and/or the entire rear hydrofoil 136 themselves. In some examples, the craft 100 includes one or more actuators for rotating the main hydrofoil 130 and/or the rear hydrofoil 136 around the yaw axis. In some examples, the craft 100 includes one or more actuators for controlling the angle of attack of the main hydrofoil 130 and/or the rear hydrofoil 136 (i.e., rotating the main hydrofoil 130 and/or the rear hydrofoil 136 around the pitch axis). Some examples of the craft 100 include one or more actuators for rotating the main hydrofoil 130 and/or the rear hydrofoil 136 around the roll axis. Some examples of the craft 100 include one or more actuators for changing a camber or shape of the main hydrofoil 130 and/or the rear hydrofoil 136. Some examples of the craft 100 include one or more actuators for flapping the main hydrofoil 130 and/or the rear hydrofoil 136 to help propel the craft 100 forward or backward. Other examples are possible as well.

Further, some examples of the craft 100 dynamically control an extent to which the main hydrofoil 130 and/or the rear hydrofoil 136 are deployed based on an operational mode (e.g., hull-borne, hydrofoil-borne, or wing-borne modes) of the craft 100. For instance, in some examples, during hull-borne mode, the rear hydrofoil assembly 110 is partially deployed or retracted to increase turning authority. The amount of partial deployment or retraction may be a function of the desired overall vehicle draft when operating in a shallow water environment. In some examples, during hydrofoil-borne mode, the main hydrofoil assembly 108 is partially retracted to reduce the distance between the hull of the vehicle and the water's surface. This increases the amount of lift generated by the main wing 104 by operating the wing closer to the surface of the water, increasing the effects of the aerodynamic ground effect.

As noted above, some examples of the main hydrofoil assembly 108 and rear hydrofoil assembly 110 interface with a deployment system that facilitates retracting the respective hydrofoil assemblies 108, 110 into or toward the hull 102 for hull-borne or wing-borne operation and for extending the respective hydrofoil assemblies 108, 110 below the hull 102 for hydrofoil-borne operation. As described further below, in some embodiments, the deployment system is used in connection with extending, retracting, and/or otherwise controlling the positioning of the hydrofoil assemblies 108, 110 during takeoff when the craft is transitioning from hydrofoil-borne operation to wing-borne operation.

### E. Hydrofoil Deployment Systems

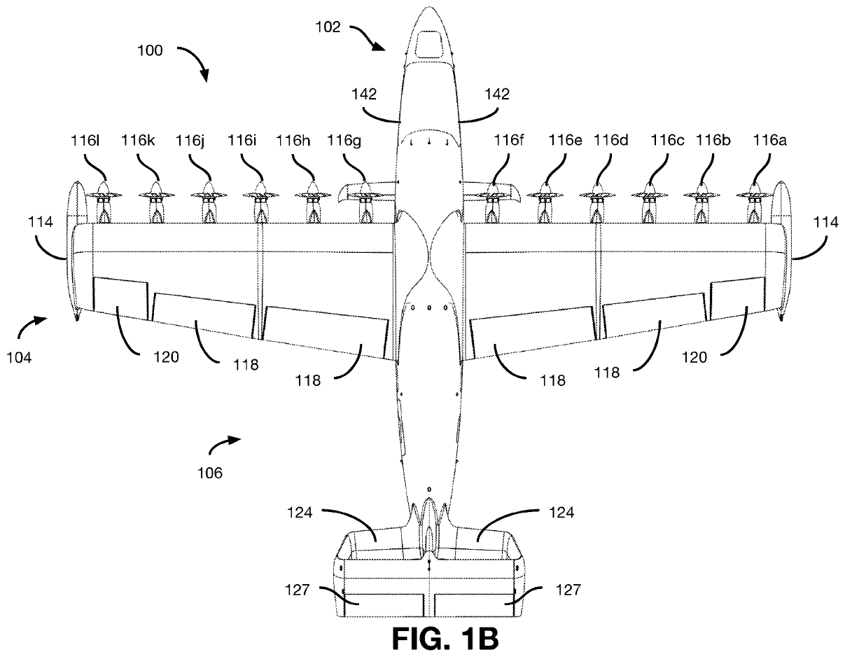

FIG. 2 illustrates an example of a main hydrofoil deployment system 200 that facilitates retracting and extending of the main hydrofoil assembly 108. As shown, some examples of the main hydrofoil deployment system 200 take the form of a linear actuator that includes one or more brackets 202 that couple the main hydrofoil assembly 108 (by way of the main hydrofoil strut 132) to one or more vertical tracks 204. Some examples of the brackets 202 are configured to move vertically along the tracks 204, such that when the brackets 202 move vertically along the tracks 204, the main hydrofoil assembly 108 likewise moves vertically. Some examples of the brackets 202 are coupled to a leadscrew 206 that, when rotated, causes vertical movement of the brackets 202. Some examples of the leadscrew 206 are rotatable by any of various sources of torque, such as an electric motor coupled to the leadscrew 206 by a gear assembly.

Some examples of the main hydrofoil deployment system 200 further include one or more sensors (not shown) configured to detect a vertical position of the main hydrofoil assembly 108. For example, a first sensor senses when the main hydrofoil assembly 108 has reached a fully retracted position and a second sensor senses when the main hydrofoil assembly 108 has reached a fully extended position. However, the main hydrofoil deployment system 200 may include additional sensors for detecting additional discrete positions or continuous positions of the main hydrofoil assembly 108. Some examples of the sensors are included as part of, or otherwise configured to communicate with, the control system of the craft 100 to provide the control system with data that indicates the position of the main hydrofoil assembly 108. Some examples of the control system use this data to determine whether to operate the electric motor to retract or extend the main hydrofoil assembly 108.

In some examples, such as examples where the linear actuator is not a self-locking linear actuator, the main hydrofoil deployment system 200 includes a locking or braking mechanism for holding the main hydrofoil strut 132 in a fixed position (e.g., in a fully retracted or fully extended position). An example of the locking mechanism corresponded to a dual-action mechanical brake that is coupled to the electric motor, the leadscrew 206, or the gear assembly.

While the above description provides various details of an example main hydrofoil deployment system 200, it should be understood that the main hydrofoil deployment system 200 illustrated in FIG. 2 is for illustrative purposes and is not meant to be limiting. For instance, the main hydrofoil deployment system 200 may include any of various linear actuators now known or later developed that are capable of retracting and extending the main hydrofoil assembly 108.

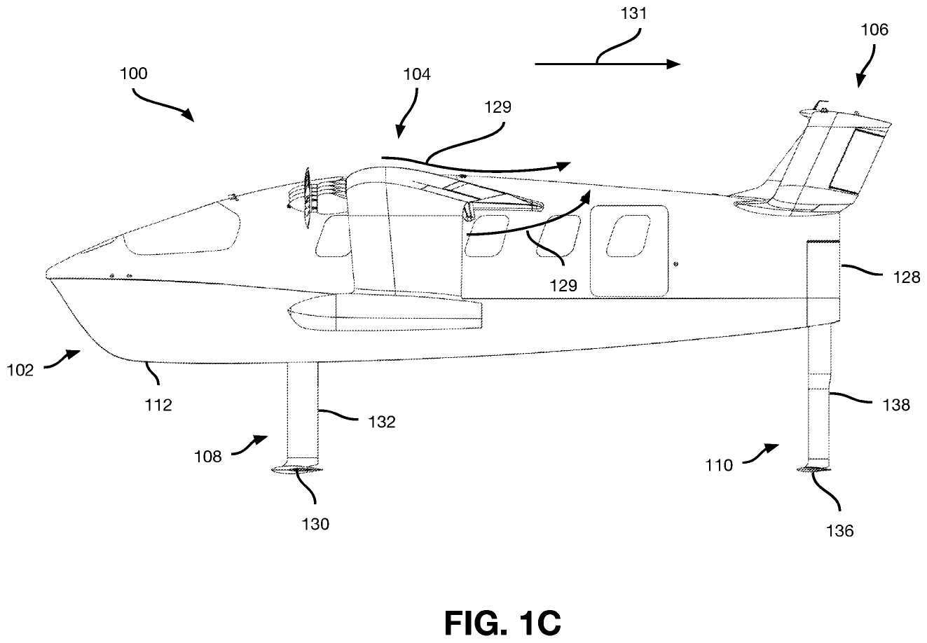

FIG. 3 illustrates an example of a rear hydrofoil deployment system 300 that facilitates retracting and extending the rear hydrofoil assembly 110. As shown, some examples of the rear hydrofoil deployment system 300 include an actuator 305 to the rear hydrofoil strut 138. When actuated, the actuator 305 causes the rear hydrofoil strut 138 to raise or lower by causing the rear hydrofoil strut 138 to slide vertically along a shaft 307. While not illustrated in FIG. 3, in some examples, the rudder 128 is mounted to the shaft 307 such that, when the actuator 305 raises the rear hydrofoil strut 138, the rear hydrofoil strut 138 retracts at least partially into the rudder 128. Additionally, some examples of the rear hydrofoil deployment system 300 include one or more servo motors configured to rotate the rear hydrofoil strut 138 around the shaft. In this respect, in some examples, the rear hydrofoil strut 138 is rotated around the shaft to act as a hydro-rudder when submerged in water or to act as an aero-rudder when out of the water. Further, because the rudder 128 is mounted to the same shaft 307 as the rear hydrofoil strut 138 and the rear hydrofoil strut 138 can be retracted into the rudder 128, the same servo motor can also be used to control the rotation of the rudder 128.

The actuator 305 of the rear hydrofoil deployment system 300 may take various forms and may, for instance, include any of various linear actuators now known or later developed that are capable of retracting and extending the rear hydrofoil assembly 110. Further, in some examples, the actuator 305 has a non-unitary actuation ratio such that a given movement of the actuator 305 causes a larger corresponding induced movement of the rear hydrofoil assembly 110. This can help allow for faster retractions of the rear hydrofoil assembly 110, which may be beneficial during takeoff, as described in further detail below.

Some examples of the main hydrofoil assembly 108 and/or the rear hydrofoil assembly 110 are configured such that, when fully retracted, the hydrofoil assembly is flush, conformal, or tangent to the hull 102. For instance, some examples of the hull 102 include one or more recesses configured to receive the main hydrofoil assembly 108 and/or the rear hydrofoil assembly 110. In this regard, some examples of the main hydrofoil assembly 108 and/or the rear hydrofoil assembly 110 have a shape such that when the main hydrofoil assembly 108 and/or the rear hydrofoil assembly 110 are fully retracted into the recesses of the hull 102, the outer contour of the hull 102 forms a substantially smooth transition at the intersection of the hull 102 and the main hydrofoil assembly 108 and/or the rear hydrofoil assembly 110.

Other examples of the main hydrofoil assembly 108 and/or the rear hydrofoil protrude slightly below the hull 102 when retracted. These examples of the main hydrofoil assembly 108 and/or the rear hydrofoil assembly 110 are configured to have a non-negligible effect on the aerodynamics of the craft 100. Some examples of the craft 100 are configured to leverage these effects to provide additional control of the craft 100. For instance, in some examples, when the main hydrofoil assembly 108 and/or the rear hydrofoil assembly 110 are retracted but still exposed, the exposed hydrofoil is manipulated in flight to impart forces and moments on the craft 100 similar to an aero-control surface.

Some examples of the hydrofoil assemblies 108, 110 disclosed herein are mounted on a pivot that is locked underwater but is unlocked to allow the hydrofoil to move around the pivot in the air. At that point, the control surfaces act like trim tabs and are able to effect movement of the entire unlocked, pivoting hydrofoil, which would otherwise require impractically large and heavy servo motors. This configuration facilitates unlocking and moving of the hydrofoil using a slow servo and/or a combination of control surface movement combined with forward movement through water, and then re-locked such that the hydrofoil is at a selected angle of incidence.

As noted above, some examples of the main hydrofoil assembly 108 are configured to be retractable. Some examples of the hull 102 include openings through which the strut 132 of the main hydrofoil assembly 108 are retracted and extended. Some examples of the hull 102 are configured to isolate water that enters through these openings (e.g., when the hull 102 contacts the water surface) and to allow for the water to drain from the hull 102 after the hull 102 is lifted out of the water. For instance, some examples of the hull 102 include pockets 142 on each side of the hull 102 aligned above the strut 132. Some examples of the pockets 142 are isolated from the remainder of the interior of the hull 102 so that water that accumulates in the pockets 142 does not reach any undesired areas (e.g., the cockpit, passenger seating area, areas that house the battery system 400, components of the control system of the craft 100, etc.). Further, some examples of the pockets 142 include venting holes or other openings located at or near the bottom of the pockets 142. The venting openings are configured to allow water that enters the pockets 142 to vent out of the pockets 142 when the hull 102 is lifted out of the water.

Some examples of the main hydrofoil assembly 108 and/or the rear hydrofoil assembly 110 include one or more propellers for additional propulsion when submerged underwater. For instance, in some examples, one or more propellers are mounted to the main hydrofoil 130 and/or the rear hydrofoil 136. In some examples, the propellers are configured to provide additional propulsion force to the craft 100 during hydrofoil-borne or hull-borne operation.

In some examples, propellers are mounted to the hull 102. The propellers are submerged during hull-borne operation. In some examples, the propellers are configured to provide additional propulsion force to the craft 100 during hull-borne operation.

Some examples of the main and/or rear hydrofoil assemblies 108, 110 include various failsafe mechanisms in case of malfunction. For instance, in some examples, when one or both of the main and rear hydrofoil deployment systems 200, 300 cannot be retracted due to a malfunction, the craft 100 is configured to jettison the malfunctioning assembly. In this regard, some examples of the main and/or rear hydrofoil assemblies 108, 110 are coupled to the hull 102 by a releasable latch. Some examples of the control system of the craft 100 are configured to identify a retraction malfunction (e.g., based on data received from the positional sensors) and responsively open the latch to release the connection between the hull 102 and the malfunctioning hydrofoil assembly. In some examples, the weight of the malfunctioning hydrofoil assembly is sufficient to jettison the malfunctioning hydrofoil assembly out of the hull 102 when the latch is opened. Some examples of the craft 100 include an actuator or some other mechanism to jettison the malfunctioning hydrofoil assembly out of the hull 102. In some examples, the main and/or rear hydrofoil assemblies 108, 110 are configured to break in a controlled manner upon impact with water. For instance, in some examples, a joint between the main hydrofoil strut 132 and the hull 102 and/or a joint between the rear hydrofoil strut 138 and the hull 102 is configured to disconnect when subjected to a torque significantly larger than standard operational torques at the joints. Other designs for providing controlled breaks are possible as well.

### F. Battery System

FIG. 4 illustrates an example of an onboard battery system. In some examples, the battery system 400 is arranged in a protected area 402 of the hull 102 below a passenger seating area 404. Some examples of the battery system 400 are separated from the passenger seating area 404 by a firewall 406 to protect the passengers from harm if a thermal runaway occurs. In this regard, some examples of the craft 100 include a battery management system comprising voltage, current, and/or thermal sensors for detecting thermal runaway or some other fire detection system for detecting a fire in the protected area 402.

Some examples of the craft 100 include one or more mechanisms for flooding the battery system 400 (e.g., with an inert gas fire, with water, etc.) upon detecting a thermal runaway or a fire in the protected area 402. For instance, some examples of the hull 102 comprise one or more valves or other controllable openings. The control system of the craft 100 is configured to open the valves and/or controllable openings upon detecting a fire in the protected area 402 or thermal runaway in the battery system 400 to allow water to enter the protected area 402 and to extinguish or prevent a fire in the protected area 402.

In some examples, the battery system 400 is configured to be jettisoned through one or more of the controllable openings in the hull 102 described above. In this regard, in some examples, the weight of the battery system 400 is sufficient to jettison the battery system 400 out of the hull 102 when the hull 102 is opened. In some examples, the craft 100 comprises an actuator or the like configured to jettison the battery system 400 out of the hull 102.

In other examples, the craft 100 may take measures to become waterborne in response to detecting a fire in the protected area 402 or thermal runaway in the battery system 400. Some examples of the control system of the craft 100 determine a fire suppression operation to perform based on the operational state of the craft 100 (e.g., operating in hull-borne, hydrofoil-borne, or wing-borne mode). For instance, when operating in hull-borne mode and upon detecting a thermal runaway or a fire in the protected area 402, some examples of the control system are configured to flood the battery system 400 as described above. When operating in hydrofoil-borne or a wing-borne mode, the control system is configured to cause the craft 100 to transition to hull-borne mode upon detecting a thermal runaway or a fire in the protected area 402 and then flood the battery system 400.

### G. Control System

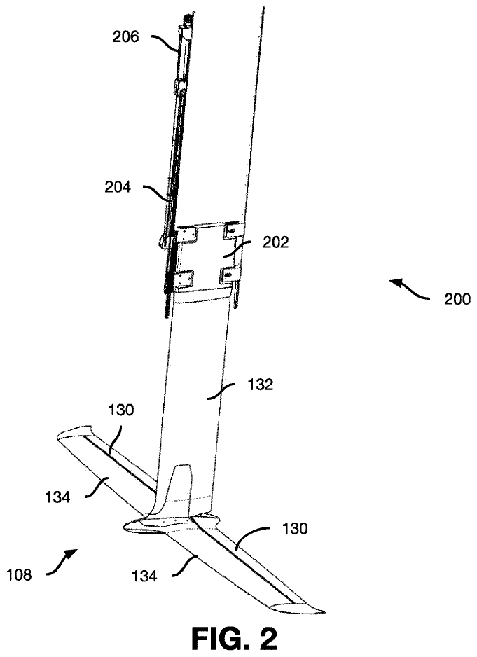

FIG. 5 illustrates an example of a control system 500 of the craft 100. As shown, some examples of control system 500 include one or more processors 502, data storage 504, a communication interface 506, a propulsion system 508, actuators 510, a Global Navigation Satellite System (GNSS) 512, an inertial navigation system (INS) 514, a radar system 516, a lidar system 518, an imaging system 520, various sensors 522, a flight instrument system 524, and flight controls 526. In some examples, some or all of these components communicate with one another via one or more communication links 528 (e.g., a system bus, a public, private, or hybrid cloud communication network, etc.)

Some examples of processors 502 correspond to or comprise general-purpose processors (e.g., a single- or multi-core microprocessor), special-purpose processors (e.g., an application-specific integrated circuit or digital-signal processor), programmable logic devices (e.g., a field-programmable gate array), controllers (e.g., microcontrollers), and/or any other processor components now known or later developed. Further, while the one or more processors 502 are illustrated as a separate stand-alone component of the control system 500, it should also be understood that the one or more processors 502 could comprise processing components that are distributed across one or more of the other components of the control system 500.

Some examples of the data storage 504 comprise one or more non-transitory computer-readable storage mediums that are collectively configured to store (i) program instructions executable by the one or more processors 502 such that the control system 500 is configured to perform some or all of the functions disclosed herein, and (ii) data that may be received, derived, or otherwise stored, for example, in one or more databases, file systems, or the like, by the control system 500 in connection with the functions disclosed herein. In this respect, the one or more non-transitory computer-readable storage mediums of data storage 504 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. Further, while the data storage 504 is illustrated as a separate stand-alone component of the control system 500, it should also be understood that the data storage 504 may comprise computer-readable storage mediums that are distributed across one or more of the other components of the control system 500.

Some examples of the communication interface 506 include one or more wireless interfaces and/or one or more wireline interfaces, which allow the control system 500 to communicate via one or more networks. Some example wireless interfaces provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Some example wireline interfaces include an Ethernet interface, a Universal Serial Bus (USB) interface, CAN Bus, RS-485, or similar interface to communicate via a wire, a twisted pair of wires, a coaxial cable, an optical link, a fiber-optic link, or other physical connection to a wireline network.

Some examples of the propulsion system 508 include one or more electronic speed controllers (ESCs) for controlling the electric motor propeller assemblies 116 distributed across the main wing 104 and, in some examples, across the horizontal stabilizer 124. Some examples of the propulsion system 508 include a separate ESC for each respective propeller assembly 116, such that the control system 500 individually controls the rotational speeds of the electric motor propeller assemblies 116.

Some examples of the actuators 510 include any of the actuators described herein, including (i) actuators for raising and lowering the flaps 118, ailerons 120, elevators 126, main hydrofoil control surfaces 134, and rear hydrofoil control surfaces 140, (ii) actuators for turning the rudder 128, the main hydrofoil control surfaces 134 positioned on the main hydrofoil strut 132, and the rear hydrofoil control surfaces 140 positioned on the rear hydrofoil strut 138, (iii) actuators for retracting and extending the main hydrofoil assembly 108 and the rear hydrofoil assembly 110, and/or (iv) actuators for performing the various other disclosed actuations of the main hydrofoil assembly 108 and the rear hydrofoil assembly 110. Each of the actuators described herein may include any actuators now known or later developed capable of performing the disclosed actuation. Some examples of the actuators correspond to linear actuators, rotary actuators, hydraulic actuators, pneumatic actuators, electric actuators, electro-hydraulic actuators, and mechanical actuators. Some examples of the actuators correspond to electric motors, stepper motors, and hydraulic cylinders. Other examples are contemplated herein as well.

Some examples of the GNSS system 512 are configured to provide a measurement of the location, speed, altitude, and heading of the craft 100. The GNSS system 512 includes one or more radio antennas paired with signal processing equipment. Data from the GNSS system 512 may allow the control system 500 to estimate the position and speed of the craft 100 in a global reference frame, which can be used for route planning, operational envelope protection, and vehicle traffic deconfliction by both understanding where the craft 100 is located and comparing the location with known traffic.

Some examples of the INS 514 include motion sensors, such as angular and/or linear accelerometers, and rotational sensors, such as gyroscopes, to calculate the position, orientation, and speed of the craft 100 using dead reckoning techniques. In some examples, one or more of these components are used by the control system to calculate actuator outputs to stabilize or otherwise control the vehicle during all modes of operation.

Some examples of the radar system 516 include a transmitter and a receiver. The transmitter may transmit radio waves via a transmitting antenna. The radio waves reflect off an object and return to the receiver. The receiver receives the reflected radio waves via a receiving antenna, which may be the same antenna as the transmitting antenna, and the radar system 516 processes the received radio waves to determine information about the object's location and speed relative to the craft 100. This radar system 516 may be utilized to detect, for example, the water surface, maritime or wing-borne vehicle traffic, wildlife, or weather.

Some examples of the lidar system 518 comprise a light source and an optical receiver. The light source emits a laser that reflects off an object and returns to the optical receiver. The lidar system 518 measures the time for the reflected light to return to the receiver to determine the distance between the craft 100 and the object. This lidar system 518 may be utilized by the flight control system to measure the distance from the craft 100 to the surface of the water in various spatial measurements.

Some examples of the imaging system 520 include one or more still and/or video cameras configured to capture image data from the environment of the craft 100. Some examples of the cameras correspond to or comprise charge-coupled device (CCD) cameras, complementary metal-oxide-semiconductor (CMOS) cameras, short-wave infrared (SWIR) cameras, mid-wave infrared (MWIR) cameras, or long-wave infrared (LWIR) cameras. Some examples of the imaging system 520 are configured to perform obstacle avoidance, localization techniques, water surface tracking for more accurate navigation (e.g., by applying optical flow techniques to images), video feedback, and/or image recognition and processing among other possibilities.

As noted above, some examples of the control system 500 include various other sensors 522 for use in controlling the craft 100. Examples of such sensors 522 correspond to or comprise thermal sensors or other fire detection sensors for detecting a fire in the hull 102 or for detecting thermal runaway in the battery system 400. As further described above, the sensors 522 may include position sensors for sensing the position of the main hydrofoil assembly 108 and/or the rear hydrofoil assembly 110 (e.g., sensing whether the assemblies are in a retracted or extended position). Examples of position sensors may include photodiode sensors, capacitive displacement sensors, eddy-current sensors, Hall effect sensors, inductive sensors, or any other position sensors now known or later developed.

Some examples of the sensors 522 facilitate determining the altitude of the craft 100. For instance, some examples of the sensor 522 include an ultrasonic altimeter configured to emit and receive ultrasonic waves. The emitted ultrasonic waves reflect off the water surface below the craft 100 and return to the altimeter. The ultrasonic altimeter measures the time for the reflected ultrasonic wave to return to the altimeter to determine the distance between the craft 100 and the water surface. Some examples of the sensor 522 include a barometer for use as a pressure altimeter. The barometer measures the atmospheric pressure in the environment of the craft 100 and determines the altitude of the craft 100 based on the measured pressure. Some examples of the sensor 522 include a radar altimeter to emit and receive radio waves. The radar altimeter measures the time for the radio wave to reflect off of the surface of the water below the craft 100 to determine a distance between the craft 100 and the water surface. In some examples, these sensors are placed in different locations on the craft 100 to reduce the impact of sensor constraints, such as sensor deadband or sensitivity to splashing water.

Some examples of the control system 500 are configured to use one or more of the sensors 522 or other components of the control system 500 to help navigate the craft 100 through maritime traffic or to avoid any other type of obstacle. For example, some examples of the control system 500 determine the position, orientation, and speed of the craft 100 based on data from the INS 514 and/or the GNSS 512, and the control system 500 may determine the location of an obstacle, such as a maritime vessel, a dock, or various other obstacles, based on data from the radar system 516, the lidar system 518, and/or the imaging system 520. Some examples of the control system 500 determine the location of an obstacle using the Automatic Identification System (AIS). Some examples of the control system 500 are configured to maneuver the craft 100 to avoid collision with an obstacle based on the determined position, orientation, and speed of the craft 100 and the determined location of the obstacle by actuating various control surfaces of the craft 100 in any of the manners described herein.

Some examples of the flight instrument system 524 include instruments for providing data about the altitude, speed, heading, orientation (e.g., yaw, pitch, and roll), battery levels, or any other information provided by the various other components of the control system 500.

Some examples of the flight controls 526 include one or more joysticks, thrust control levers, buttons, switches, dials, levers, or touch screen displays, etc. In operation, a pilot may use the flight controls 526 to operate one or more control surfaces (e.g., flaps, ailerons, elevators, rudder, propulsion propellers, etc.) of the craft 100 to thereby maneuver the craft 100 (e.g., control the direction, speed, altitude, etc., of the craft 100)

In some examples, the combinations of control surfaces on the craft 100 used by the control system 500 to control operations of the craft 100 depends on the mode of operation of the craft 100 and is determined based at least in part on aspects such as vehicle position, speed, attitude, acceleration, rotational rates, and/or altitude above water. Table 1 summarizes an example of the relationship between the control surfaces and the operation mode.

TABLE 1

| Control Surface | Hull-borne | Foil-borne | Wing-borne |
|---|---|---|---|
| Propulsion | Y | Y | Y |
| Aerodynamic | N | Y | Y |
| Elevator | | | |
| Aerodynamic | N | Y | Y |
| Ailerons | | | |
| Aerodynamic | Y | Y | Y |
| Rudder | | | |
| Aerodynamic Flaps | N | Y | Y |
| Hydrodynamic | Y | Y | N |
| Elevator | | | |
| Hydrodynamic Flaps | Y | Y | N |
| Hydrodynamic | Y | Y | N |
| Rudder | | | |

In some examples, the propulsion control surfaces in the table include the propeller assembly 116, as well as any propellers mounted to the hull 102, main hydrofoil assembly 108, or rear hydrofoil assembly 110. In some examples, the aerodynamic elevator control surfaces include elevator 126, the aerodynamic ailerons include ailerons 120, the aerodynamic rudder includes rudder 128 (when not submerged), the aerodynamic flaps include flaps 118, the hydrodynamic elevator includes rear hydrofoil control surfaces 140, the hydrodynamic flaps include main hydrofoil control surfaces 134, and the hydrodynamic rudder includes rudder 128 (when submerged).

In some examples, when actuating the control surfaces in the various examples, operational modes identified in Table 1 above, the control system 500 executes different levels of stabilization along the various vehicle axes during different modes of operation. Table 2 below identifies examples of stabilization controls that the control system 500 applies during the various modes of operation for each axis of the craft 100. Closed-loop control may comprise feedback and/or feed-forward control.

TABLE 2

| Vehicle | | | |
|---|---|---|---|
| Axis | Hull-borne | Foil-borne | Wing-borne |
| Pitch | None | Closed-loop | Closed-loop |
| Axis | | control | control |
| | | on vehicle | on vehicle |
| | | ride height | altitude |
| Roll | None | Closed-loop | Stabilization |
| Axis | | control | and |
| | | around | closed-loop |
| | | vehicle bank | control on |
| | | angle = 0 | heading |
| Yaw | Rate | Closed-loop | Closed-loop |
| Axis | stabilization | control | control |
| | | on vehicle | on vehicle |
| | | heading | heading |
| Speed | Closed-loop | Closed-loop | Closed-loop |
| Control | control | control | control |
| | on vehicle | on vehicle | on vehicle |
| | GPS Speed | GPS | airspeed |
| | | Speed | |

Further, in some examples, the control system 500 is configured to actuate different control surfaces to control the movement of the craft 100 about its different axes. Table 3 below identifies example axial motions that are affected by the various control surfaces of the craft 100.

TABLE 3

| Control Surface | Axis Control Function |
|---|---|
| Propulsion | (a) accelerate and decelerate the vehicle |
| | (b) turn the vehicle about yaw axis |
| | (c) create a rolling moment |
| Aerodynamic | (a) create a pitch up or pitch down |
| Elevator | moment |
| Aerodynamic | (a) create a rolling moment |
| Ailerons | (b) increase lift on aerodynamic wing |
| | (c) create a pitch-down moment |
| Aerodynamic | (a) create a yawing moment |
| Rudder | |
| Aerodynamic | (a) increase lift on aerodynamic wing |
| Flaps | (b) create a pitch-down moment |
| Hydrodynamic | (a) create a pitch moment |
| Elevator | (b) generate heave force on rear hydrofoil |
| Hydrodynamic | (a) generate heave force on main |
| Flaps | hydrofoil |
| Hydrodynamic | (a) create a yaw moment |
| Rudder | |

### III. EXAMPLE MODES OF OPERATION

### A. Hull-Borne Operation

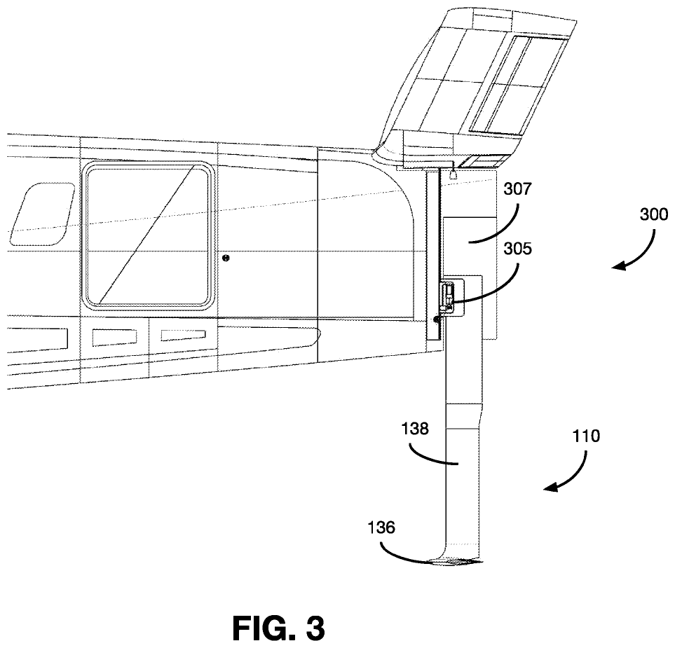

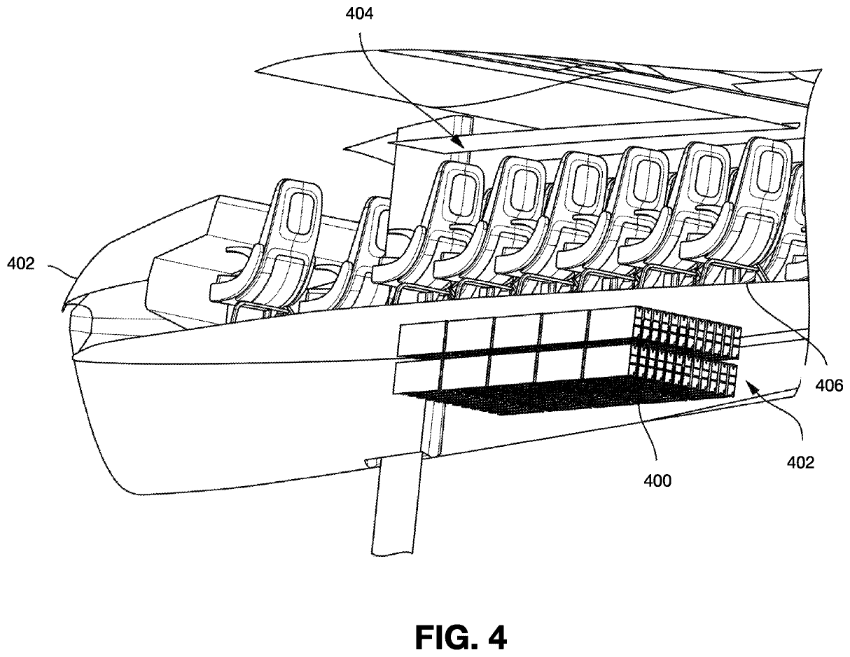

FIG. 6A illustrates an example of the craft 100 when the craft 100 is operating in a hull-borne mode. During this mode, the craft 100 is docked and floating on the hull 102, with the buoyancy of the outriggers 114 providing for roll stabilization of the craft 100. While docked, the battery system 400 of the craft 100 may be charged. In some examples, rapid charging is aided by an open or closed-loop water-based cooling system. In some examples, the surrounding body of water is used in the loop or as a heat sink. In some examples, the craft 100 includes a heat sink integrated into the hull 102 for exchanging heat from the battery system 400 to the surrounding body of water. In other examples, the heat sink is located offboard in order to reduce the mass of the craft 100.

Additionally, in some examples, the propeller assemblies 116 are folded in a direction away from the dock while the craft 100 is docked to help avoid collision with nearby structures or people. This folding may be actuated in various ways, such as by metal spring force, hydraulic pressure, electromechanical actuation, or centrifugal force due to propeller rotation. Other examples are possible as well. Further, in some examples, the main hydrofoil assembly 108 and the rear hydrofoil assembly 110 are retracted (or partially retracted) to avoid collisions with nearby underwater structures.

In some examples, when the craft 100 is ready to depart, the craft 100 uses its propulsion systems, including the propeller assemblies 116 and/or the underwater propulsion system (e.g., one or more outrigger propulsion systems 900, one or more propeller pods mounted to the hull 102, the main hydrofoil assembly 108, and/or the rear hydrofoil assembly 110), to maneuver away from the dock while remaining hull-borne. In some examples, the main hydrofoil assembly 108 and the rear hydrofoil assembly 110 remain retracted (or partially retracted) during this maneuvering to reduce the risk of hitting underwater obstacles near docks or in shallow waterways. However, when there is a limited risk of hitting underwater obstacles, the craft 100 may partially or fully extend the main hydrofoil assembly 108 and/or the rear hydrofoil assembly 110. With the main hydrofoil assembly 108 and/or the rear hydrofoil assembly 110 extended, the craft 100 actuates the main hydrofoil control surfaces 134 and/or the rear hydrofoil control surfaces 140 to improve maneuverability as described above.

In some examples, at low speeds during hull-borne operation, the control system 500 controls the position and/or rotation of the craft 100 by causing all of the propeller assemblies 116 to spin at the same idle speed, but with a first subset spinning in a forward direction and a second subset spinning in a reverse direction. For instance, in some examples, the control system 500 causes propeller assemblies 116a, 116c, 116e, 116h, 116j, and 116l to idle in reverse and propeller assemblies 116b, 116d, 116f, 116g, 116i, and 116k to idle forward. In this arrangement, the control system 500 causes the craft 100 to make various maneuvers without having to change the direction of rotation of any of the propeller assemblies 116. For instance, to induce a yaw on the craft 100, in some examples, the control system 500 increases the speed of the reverse propeller assemblies on one side of the main wing 104 while increasing the speed of the forward propeller assemblies on the other side of the main wing 104 and without causing any of the propeller assemblies to transition from forward to reverse or from reverse to forward. For example, idling the propellers at a nominal RPM may allow for a faster response in generating a yaw moment on the craft 100 because the propellers required for generating the yaw moment do not have to increase from zero RPM to the desired RPM value. They can spin from the idle RPM to the desired RPM value.

### B. Foil-Borne Maneuvering Operation

FIG. 6B illustrates an example of the craft 100 when the craft 100 is operating in hydrofoil-borne maneuvering mode. During this mode, the craft 100 is configured to, for example, move through harbors and crowded waterways at speeds generally between 20-45 mph. In this regard, the craft 100 may extend the main hydrofoil assembly 108 and the rear hydrofoil assembly 110 (if not already extended) and accelerate using the previously described propulsion system towards a desired takeoff speed. During acceleration, the craft 100 reaches a speed at which the main hydrofoil assembly 108 and the rear hydrofoil assembly 110 alone support the weight of the craft 100, and the hull 102 is lifted above the surface of the water (e.g., by 3-5 ft) so that the hull is clear of any surface waves. After the hull 102 leaves the surface of the water, the drag forces exerted on the craft 100 drop significantly, and the amount of thrust required to maintain acceleration can be reduced. Therefore, in some examples, after the hull 102 has left the water, the control system 500 reduces the speed of the propeller assemblies 116 to lower the thrust of the craft 100.

Some examples of the control system 500 sustain this operational mode by actively controlling the pitch and speed of the craft 100 so that the main hydrofoil assembly 108 and the rear hydrofoil assembly 110 continue to entirely support the weight of the craft 100. In this regard, some examples of the control system 500 actuate the main hydrofoil control surfaces 134 and/or the rear hydrofoil control surfaces 140 and/or the propulsion system to stabilize the attitude of the craft 100 to maintain the desired height above the surface of the water, vehicle heading, and vehicle forward speed. In this regard, some examples of the control system 500 are configured to detect various changes in the yaw, pitch, or roll of the craft 100 based on data provided by the INS 514 and to make calculated actuations of the main hydrofoil control surfaces 134 and/or the rear hydrofoil control surfaces 140 to counteract the detected changes.

### C. Foil-Borne Takeoff Operation

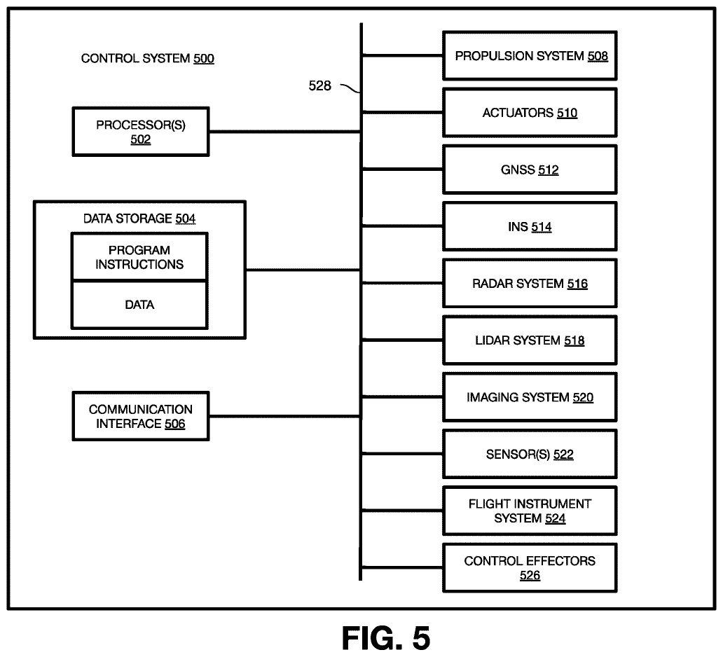

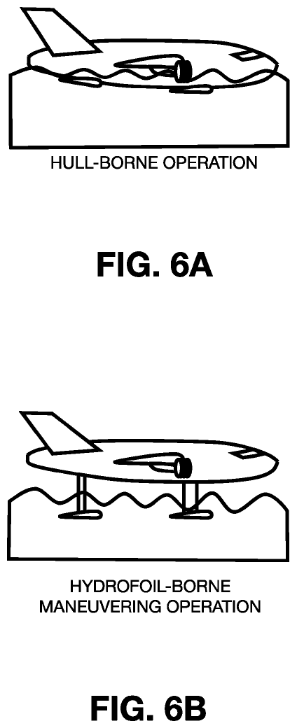

FIG. 7A illustrates an example of the craft 100 when the craft 100 is operating in hydrofoil-borne takeoff mode. During this mode, the craft 100 is configured to, for example, move through open waters and obtain speeds generally between 40-50 mph to facilitate generating the lift required to become wing-borne.

Referring to FIG. 7A, aero lift, LW, generally represents the lift generated by the main wing 104 of the craft 100 but can also include the lift generated by other surfaces such as the tail wing, hull, or propulsive devices such as propellers, rotors, jets, etc. LF generally corresponds to the lift generated by one or more hydrofoils 130, 136 of the craft 100, where LFF corresponds to the lift generated by the front foil and the LFR corresponds to the lift generated by the rear foil. WCRAFT corresponds to the force of gravity exerted on the craft 100 and is also referred to as the weight of the craft. During steady state operation, WCRAFT generally corresponds to LW+LFR+LFF which also corresponds to LNET. Throughout the description, the term LF is generally understood to correspond to LFR+LFF.

As previously noted, some experimental craft developed by Applicant that include aero foils were unable to achieve the lift required to sustain flight. In these experimental craft, in an attempt to become airborne, the craft 100 would ramp up to a speed at which point the hydrofoil would breach the surface of the water, as WCRAFT<Lw+LF, and LF>0, resulting in Lw<WCRAFT. However, in order to takeoff from the water's surface, the aero lift must be greater than or equal to the weight of the craft, however prior to takeoff, the hydrofoils are still under the water's surface, and up until takeoff, have been generating lift (LF>0) as the aerodynamic lift has been insufficient for takeoff up until this point. If the hydro lift and the aero lift sum to greater than the weight of the craft, the vehicle will accelerate upwards and potentially create a premature takeoff condition (prior to condition C0 in FIG. 7B) as the aero lift, LW, generated by the wings, etc., of the craft 100 would be insufficient to sustain flight, and, as a result, the craft 100 would come back down and breach the water, ultimately preventing takeoff. The techniques disclosed below ameliorate these problems by controlling the hydrofoil lift vector, LF, specifically by generating downward forces of one or more hydrofoils 130, 136 of the craft 100 to keep the hydrofoils 130, 136 submerged until after the upwards aero lift, LW, is sufficient to allow the craft 100 to sustain flight.

In some examples, the lift LF is in the downward direction, and is introduced via the hydrofoil(s) as LW increases beyond WCRAFT while the craft 100 is increasing in speed in anticipation of takeoff. This allows the craft 100 to generate a greater overall aero lift, LW, prior to actual takeoff than would otherwise be possible. Then, at the appropriate time (e.g., when LW reaches some predetermined threshold such as the weight of the craft 100 or some margin thereof), the negative lift, LF, can be “released” from the craft 100, and the craft 100 can, as a result, proceed to become wing-borne.

FIG. 7B is an example of a graph 700 that relates these aspects. The relationships shown in the graph 700 and the ways in which various lift forces, thresholds, etc., are depicted are merely examples and are provided to aid understanding of the various operations and procedures described herein. As shown, the net lift, LNET, on the craft 100 initially corresponds to the combination of the aero lift, LW, generated by the wing (e.g., main wing, tail wing, etc.) and the lift, LF, generated by the hydrofoils 130, 136 (e.g., LNET=LW+LF). On the left side of the graph 700, the speed of the craft 100 is such that LNET is sufficient to allow the craft 100 to operate in hydrofoil-borne maneuvering mode but is insufficient to allow the craft 100 to become wing-borne. Moving to the right of the graph 700 as speed increases, LW increases with increased craft 100 water speed. To maintain ride height and prevent the hydrofoils 130, 136 from breaching the water surface, LF is reduced in proportion to an increase in LW. For example, LF is adjusted with the speed of the craft 100 to maintain LNET at a margin equal to the weight, WCRAFT, of the craft 100, or small deviations about equal to control ride height. The overall lift provided by the hydrofoils 130, 136 may decrease at the same rate at which lift from the wing is increased towards zero or even become negative with increased speed. For example, just before the speed of the craft 100 reaches the speed associated with condition C0, LF may be reduced to zero. The conditions at C0 (e.g., speed of the craft 100, angle of attack of craft 100, deflection angles of control surfaces, angle of incidence of hydrofoils, etc.) may be such that LF may be zero or close to zero. At C0, the aero lift, LW, generated by the main wing 104 may be expected to be able to transition the craft 100 to a wing-borne mode of operation if the downwards hydrofoil lift, LF, were to be removed as LW=WCRAFT. Accordingly, at some time and/or increased speed after this point (e.g., speed associated with condition C1) where LW>WCRAFT, LF may be gradually or abruptly removed/released. This, in turn, allows LNET to approximately equal to or greater than WCRAFT which allows the craft 100 to take off and become wing-borne.

While not shown in the graph, in some examples, LF is not removed/released as described. Rather, as the craft 100 continues to accelerate, the downwards hydrofoil lift, LF, increases to a maximum downwards amount (e.g., a predetermined maximum amount and/or a maximum amount achievable due to the limitations of the control capabilities of the hydrofoil). As the aero lift, LW, generated by the main wing 104 continues to increase past this maximum amount of downwards hydrofoil lift, LF, LNET increases in the upwards direction beyond WCRAFT and the craft 100 is pulled from the water. This, in turn transitions the craft 100 to a wing-borne mode of operation.

### D. Wing-Borne Operation

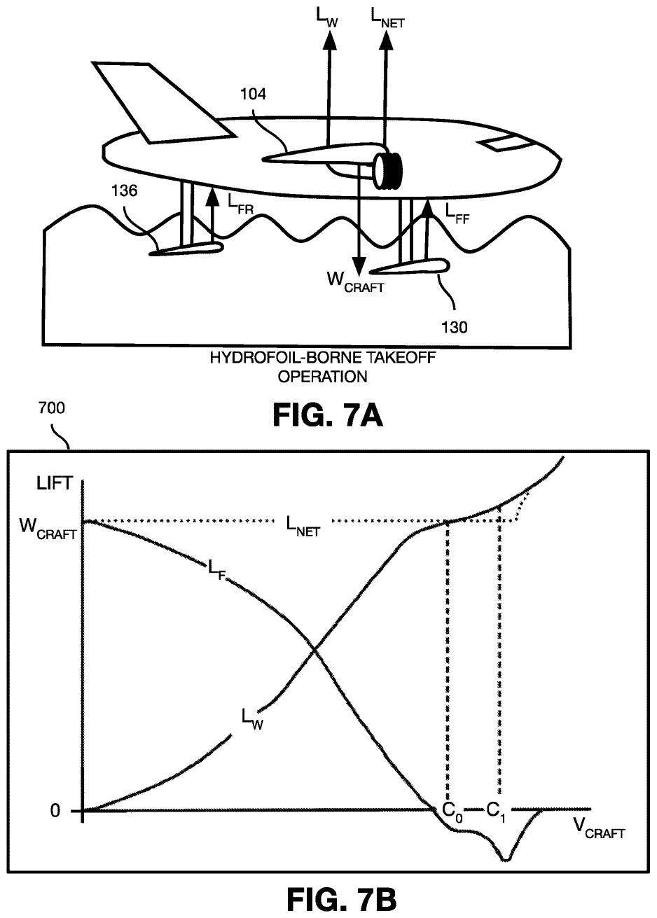

FIG. 8 illustrates an example of the craft 100 after becoming wing borne. In some examples, once the transition from hydrofoil-borne operation to wing-borne operation is complete, the control system 500 causes the main hydrofoil deployment system 200 and the rear hydrofoil deployment system 300 to respectively retract the main hydrofoil assembly 108 and the rear hydrofoil assembly 110. In some examples, the control system 500 initiates this retraction as soon as the hydrofoil assemblies 108, 110 are clear of the water to reduce the chance of the hydrofoil assemblies 108, 110 reentering the water. The control system 500 may determine that the hydrofoil assemblies 108, 110 are clear of the water in various ways. For instance, in an example, the control system 500 makes such a determination based on a measured altitude of the craft 100 (e.g., based on data provided by the radar system 516, the lidar system 518, and/or the other sensors 522 described above for measuring an altitude of the craft 100). In another example, the sensors 522 may further include one or more conductivity sensors, temperature sensors, pressure sensors, strain gauge sensors, or load cell sensors arranged on the hydrofoil assemblies 108, 110, and the control system 500 may determine that the hydrofoil assemblies 108, 110 are clear of the water-based on data from these sensors.

Once the craft 100 is clear of the water, the control system 500 continues to accelerate the craft 100 to the desired cruise speed by controlling the speed of the propeller assemblies 116. In some examples, the control system 500 retracts the flap systems when the craft 100 has achieved sufficient airspeed to generate enough lift to sustain altitude without them and actuates various control surfaces of the craft 100 and/or applies differential thrust to the propeller assemblies 116 to perform any desired maneuvers, such as turning, climbing, or descending, and to provide efficient lift distribution. While in wing-borne mode, the craft 100 can fly both low over the water's surface in ground-effect or above ground-effect depending on operational conditions and considerations.

### E. Return to Hull-Borne Operation

To facilitate transitioning from wing-borne to hull-borne mode of operation (See FIG. 6A), the control system 500 determines that the hydrofoil assemblies 108, 110 are fully or partially retracted so that the craft 100 may safely land on its hull 102. In some examples, the control system 500 additionally determines and suggests the desired landing direction and/or location-based on observed, estimated, or expected water surface conditions (e.g., based on data from the radar system 516, the lidar system 518, the imaging system 520, or other sensors 522).

The control system 500 initiates deceleration of the craft 100, for instance, by reducing the speeds of the propeller assemblies 116 until the craft 100 reaches a desired landing airspeed. During the deceleration, the control system 500 may deploy the flaps 118 to increase lift at low airspeeds and/or to reduce the stall speed. Once the craft 100 reaches the desired landing airspeed (e.g., approximately 50 knots), the control system 500 reduces the descent rate (e.g., to be less than approximately 200 ft/min). As the craft 100 approaches the surface of the water (e.g., once the control system 500 determines that the craft 100 is within 5 feet of the water surface), the control system 500 further slows the descent rate to cushion the landing (e.g., to be less than approximately 50 ft/min). As the hull 102 of the craft 100 impacts the surface of the water, the control system 500 reduces thrust, and the craft 100 rapidly decelerates due to the presence of hydrodynamic drag, the reduction in forward thrust, and the reduction or elimination of blowing air over the wing which significantly reduces lift causing the vehicle to settle into the water. The hull 102 settles into the water as the speed is further reduced until the craft 100 is stationary.

In some examples, after the craft 100 is settled in the water, the craft 100 is transitioned back to hydrofoil-borne maneuvering mode (See FIG. 6B) by extending the hydrofoil assemblies 108, 110 to transition from hull-borne operation to hydrofoil-borne operation in the same manner as described above. In some examples, the control system 500 then sustains the hydrofoil-borne mode at the fifth stage and maneuvers the craft 100 into port while keeping the hull 102 insulated from surface waves. The control system 500 then reduces the thrust generated by the propeller assemblies 116 to lower the speed of the craft 100 until the hull 102 settles into the water, thereby transitioning that craft back to hull-borne operation at the sixth stage. The control system 500 then retracts the hydrofoil assemblies 108, 110 and performs the hull-borne operations described above to maneuver the craft 100 into a dock for disembarking passengers or goods and recharging the battery system 400.

### IV. ON-WATER MANEUVERING EXAMPLES

As previously noted, some examples of craft 100 described above are wing-in-ground effect (WIG) craft 100 that take off from and land on the water. These craft 100 may operate in congested waters at times to, for example, facilitate the onboarding/offboarding of passengers. This may involve maneuvering to a pier to receive passengers, which in turn may involve maneuvering around and/or away from other craft 100, navigational markers, geographic features, swimmers, and/or any other obstacles that may be present in the water. Other maneuvers or scenarios may involve negotiating such obstacles as well, such as station-keeping maneuvers whereby the craft 100 maintains its heading while minimizing its translation, or virtual “anchoring” maneuvers whereby the craft 100 maintains a given geographical position in the water (perhaps without throwing a physical anchor).

Various examples of hull-borne maneuvering operations performed by the craft 100 to address the challenges encountered by craft 100 when hull-borne are described in more detail below. In this regard, some examples of the craft 100 include various control elements that may be operated individually or in concert with one another to facilitate performing the maneuvering operations. These control elements in conjunction with environmental factors (e.g., wind, current, waves, etc.) facilitate movement of the craft 100 while it is hull-borne.

In some examples of the craft 100, the control system 500 controls the operation of the control elements to facilitate performing the hull-borne maneuvering operations. Some particular maneuvering operations performed by the craft 100 include anchoring/mooring, docking, and station-keeping. In some examples, performing these maneuvering operations involves the control system 500 operating the control elements to maintain the heading of the craft, cause the craft 100 to move to a target location, and minimize lateral movement of the craft 100 away from a target location.

For instance, the control system 500 may receive an indication from the pilot to (e.g., virtually) anchor the craft 100 at its current location. In some examples, after receiving this indication, the control system 500 may set the current location as a target location and operate the control elements to minimize lateral movement of the craft 100 away from the target location without requiring a physical anchor being deployed in the water. In another example, the control system 500 may receive an indication to dock the craft 100 at a particular location. After receiving this indication, the control system 500 may set the target location as the location of the dock and then determine a path to traverse to reach the dock. For example, the control system 500 may operate one or more control elements to cause the craft 100 to travel along a first heading to a first way point and then to the target location (i.e., the dock location) along a second heading. In another example, the control system 500 may receive an indication to perform a station-keeping operation to maintain the craft 100 at a target location and pointing in a particular target heading. For example, if the craft heading is pointing into the wind and/or into the direction of the water current, the control system 500 may operate the control elements (e.g., to generate thrust) to counteract the force of the wind and/or water current acting on the craft. In some examples, if crosswinds or currents are present, the control system 500 may operate the control elements to cause the craft 100 to perform a series of turning maneuvers so that the craft heading points into the wind and/or water current and is at the target location. Once the craft 100 heading points into the wind and/or water current, the control system 500 may operate the control elements to generate an equal amount of thrust that is sufficient to counteract the force of the wind and/or water current acting on the craft 100.

Some examples of control elements used to maneuver the craft 100 while hull-borne correspond to outrigger propulsion systems that are integrated within the outriggers 114 of the craft 100 that are affixed to the respective ends of the main wing 104. Some examples of these outrigger propulsion systems cause water to be ejected from the underside of the outriggers and in a direction that has a horizontal component to provide horizontal thrust. The relatively large moment arm between the outrigger propulsion systems and the center of the craft 100 facilitates more efficient control of, for example, the yaw of the craft 100. That is, less power is required to control the yaw of the craft 100 because the propulsion systems are arranged at the ends of the wings.

Some examples of control elements used to maneuver the craft 100 while hull-borne correspond to propulsion pods 1200 and/or bow thrusters integrated within the hull of the craft 100. Some examples of the propulsion pods 1200 and/or bow thrusters facilitate rotating the craft 100 about its axis, moving the craft 100 in a lateral direction, etc.

In some examples, the propeller assemblies 116 of the craft 100 correspond to control elements that can be used to maneuver the craft 100 while hull-borne. For instance, as described in more detail below, the amount and direction of thrust generated by different propeller assemblies 116 can be controlled to cause the craft 100 to rotate about its axis, move forward or backward, etc.

In some examples, the control surfaces 128a, 128b, 128n on rudder 128 of the craft 100 corresponds to a control element that can be used to maneuver the craft 100 while hull-borne. For example, when the craft 100 is hull-borne and air is blowing over the tail rudder, the angle of the control surfaces 128a, 128b, 128n of the rudder 128 can be adjusted to alter the heading of the craft 100. In this regard, in some instances, these adjustments to the control surfaces 128a, 128b, 128n of the rudder 128 can be used to maneuver the craft 100 even when the propulsion systems of the craft are not actively engaged/generating thrust. In some examples, other control surfaces can be actuated/adjusted (e.g., deflection angles adjusted) such as ailerons, flaps, elevators, etc., to maneuver the craft 100 to an extent while hull-borne, and perhaps when the propulsion systems of the craft 100 are not actively engaged/generating thrust.

In some examples, the main hydrofoil assembly 108 and the rear hydrofoil assembly 110 correspond to control elements that can be used to maneuver the craft 100. For example, the main hydrofoil assembly 108 and rear hydrofoil assembly 110 can be extended to varying amounts to affect the pivot point or yaw axis of the craft 100 when, for example, one or more propulsion systems of the craft 100 (e.g., outrigger propulsion systems 1000, propulsion pods 1200, bow thrusters, propeller assemblies 116, etc.) are generating thrust alone or in combination with one another in such a manner as to cause the craft 100 to rotate. For instance, extending the main hydrofoil assembly 108 and retracting the rear hydrofoil assembly 110 may move the pivot point towards the middle section of the craft 100. Extending the rear hydrofoil assembly 110 and retracting the main hydrofoil assembly 108 may move the pivot point towards the tail section of the craft 100.

### A. Outrigger Propulsion Systems

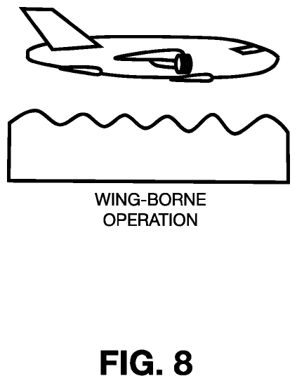

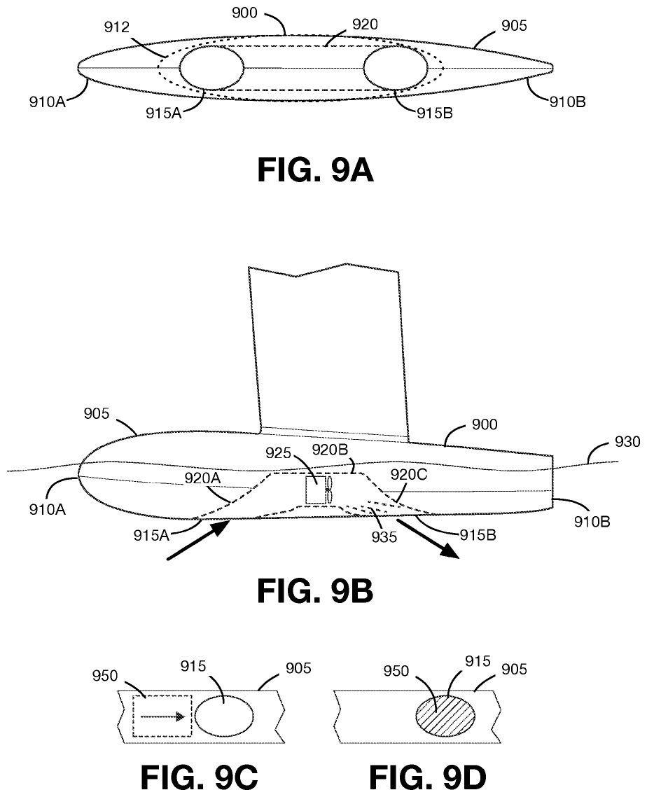

FIGS. 9A and 9B illustrate bottom and side views, respectively, of an example outrigger propulsion system 900. Some examples of the outrigger propulsion system 900 include an outrigger body 905 and a propeller pump 925 positioned within the outrigger body 905. The outrigger body 905 extends longitudinally such that the longitudinal axis of the outrigger body 905 extends from a front end 910A of the outrigger body 905 (e.g., the end nearest the front of the craft 100) to a rear end 910B of the outrigger body 905 (e.g., the end nearest the rear of the craft 100). In some examples, the longitudinal axis of the outrigger body 905 is substantially parallel to the longitudinal axis of the craft 100.

In some examples, a section of the outrigger body 905 in hull-borne operations is generally below the water surface (e.g., a lower or bottom surface section 912) of the outrigger body 905 comprises/defines a first opening 915A and a second opening 915B. In some examples, the first opening 915A is proximate to the front end 910A of the outrigger body 905 and the second opening 915B is proximate to the rear end 910B of the outrigger body 905. The first opening 915A and the second opening 915B can be arranged differently (e.g., side-by-side). In this regard, the shape of the outrigger body 905 is configured/designed to minimize drag on the craft 100 when the craft 100 is airborne. The bottom surface section 912 may correspond to a section of the outrigger body 905 that contributes the least amount to the drag when the craft 100 is airborne (e.g., a section that is substantially parallel to the direction of airflow over the craft 100). Thus, providing the first opening 915A and the second opening 915B on this section of the bottom surface of the outrigger body 905 as opposed to other known locations for providing openings that can be used to more efficiently provide thrust such as the leading and trailing edges of the outrigger body 905, minimizes the amount of drag that would otherwise be generated by the respective openings when the craft 100 is airborne.

As shown in FIGS. 9C and 9D, in some examples, to further reduce drag and/or to facilitate providing openings at different locations on the outrigger body 905, actuatable covers 950 are provided and configured to selectively cover the opening 915 (e.g., the first opening 915A and the second opening 915B, respectively). In operation, the first and the second actuatable covers 950 are controlled to cover the first opening 915A and the second opening 915B, respectively, to facilitate airborne operations of the craft 100, and are controlled to uncover the first opening 915A and the second opening 915B, respectively, to facilitate hull-borne maneuvering operations of the craft 100. As shown in FIG. 9C, in some examples, when the respective actuatable covers 950 do not cover the openings 915, they are retracted within respective sections of the outrigger body 905 that are adjacent to the openings 915 (e.g., first opening 915A and the second opening 915B). As shown in FIG. 9D, the actuatable covers 950 may be slid laterally out of the respective sections and over the respective openings 915 to cover the openings 915.

Some examples of the outrigger body 905 include an inner channel 920 that extends between the first opening 915A and the second opening 915B. The inner channel 920 comprises a first section 920A that extends towards the first opening 915A, a second section 920C that extends towards the second opening 915B, and a third middle/raised section 920B. In some examples, the second section 920C extends towards the second opening 915B such that the direction at which water is ejected from the second opening 915B has a horizontal component, as indicated by the directed line. For example, the water may be ejected at about 45 degrees down from the longitudinal axis of the outrigger body 905. Configuring the water to be ejected in this direction provides a degree of horizontal thrust that facilitates moving the craft 100 in the forward direction. In some examples, the first section 920A may be similarly extended towards the first opening 915A such that the direction at which water is pulled into the first opening 915A has a horizontal component (as indicated by the directed line) that further facilitates moving the craft 100 in the forward direction. In some examples, the first section 920A extends towards the first opening 915A at an angle different than that at which the second section 920B extends towards the second opening 915B and/or the diameter/volume of the first opening 915A and the first section 920A are greater than the diameter/volume of the second section 920B and second opening 915B such that the amount of thrust that can be generated to move the craft 100 in the forward direction is greater than the amount of thrust that can be generated to move the craft 100 in the reverse direction.

Some examples of the inner channel 920 comprise one or more vanes 935 along the inner sidewalls of the inner channel 920 to further affect the direction in which water is ejected from the inner channel 920 and or pulled into the inner channel 920. For example, as shown in the figures, a group of vanes 935 may be provided in the second section 920C of the inner channel 920 to increase the horizontal component of the water ejected from the second opening 915B. This, in turn, increases the amount of horizontal thrust generated by the outrigger propulsion system 900. In some examples, the slope of the walls of the inner channel 920 may be different (i.e., not parallel) to further increase the horizontal component of the water ejected from the second opening 915B.

As indicated above, in some examples, the first opening 915A and the second opening 915B are generally positioned so that when the craft 100 is hull-borne and maneuvering in the water, the first opening 915A and the second opening 915B are below the nominal surface of the water 930. In this regard, as previously noted, some examples of the outriggers 114 are sized relative to the size and weight of the craft 100 so that during hull-borne operations, the outriggers are at least partially submerged in the water to provide a buoyant force to the main the wing 104 of the craft 100. This improves the stability of the craft 100 during hull-borne maneuvers. In some examples, the outriggers 114 and/or the inner channel 920 are sized so that at least the inner channel 920 is submerged within the water during these maneuvers. In this regard, to ensure that the outriggers 114 still provide sufficient buoyancy to the craft 100, in some examples, the inner channel 920 and the propeller pump 925 are configured and/or selected to occupy less than a quarter diameter of the outrigger 114.

Ensuring that the first opening 915A and second opening 915B are below the surface of the water 930 helps ensure that air does not get drawn into the inner channel 920 when the outrigger propulsion system 900 is engaged. This also minimizes the chances of air becoming trapped in the inner channel 920 and causing an “airlock” condition which may prevent the pump from effectively moving water. In some examples, the inner channel 920 of the outrigger body 905 (and more particularly the middle section 920B of the inner channel 920) is positioned so that when the craft 100 is hull-borne and maneuvering in the water, the inner channel 920 is below the nominal surface of the water 930. This further reduces the chances of air becoming trapped in the inner channel. In this regard, in some examples, one or more sensors may be provided within the inner channel 920 to determine whether the inner channel 920 is filled with water. Some examples of the sensors include float sensors that float in the presence of water and conductivity sensors that measure relative difference in the conductivity of the mediums within the inner channel 920 (e.g., air vs water). Other sensors may be utilized. In some examples, the outrigger propulsion systems 900 are disengaged unless or until water is detected within the respective inner channels 920. In some examples, water has to be detected within the inner channels 920 of both outrigger propulsion systems 900 before the outrigger propulsion systems 900 can be engaged. And in some examples, when the outrigger propulsion systems 900 are engaged, both may be disengaged if air enters the inner channel 920 of either one of the outrigger propulsion systems 900.

In some examples, whether the first opening 915A and second opening 915B are below the water surface and/or whether the inner channel 920 is below the surface of the water can be inferred based on the geometry of the craft 100. Techniques for inferring the relative location/position of various features of a craft 100 are disclosed in U.S. Provisional App. 63/495,852, titled “On Water Inference of Airborne Craft with Hydrofoil,” filed Apr. 13, 2023, which is incorporated herein by reference in its entirety.

Some examples of the propeller pump 925 are positioned within the inner channel 920 and are configured to cause water to be pulled into the first opening 915A, moved through the inner channel 920, and ejected from the second opening 915B. The ejection of the water mass from the second opening 915B causes the outrigger propulsion system 900 to generate forward thrust (e.g., to move the craft 100 in the forward direction). In some examples, the direction of the propeller pump 925 is reversible so that the water mass is ejected from the first opening 915A and the outrigger propulsion system generates a reverse thrust. Providing the propeller pump 925 within the inner channel 920 minimizes the chance of damage occurring to the propeller pump 925 that might otherwise occur if the propeller pump 925 were to be exposed.

Some examples of the propeller pump 925 use electric motors that are powered by the battery of the craft 100. In some examples, the propeller pump 925 is capable of delivering a force that is sufficient to overcome/control the craft 100 in the presence of nominal crosswinds (e.g., crosswinds of 25 knots or higher). For example, a propeller pump that generates 100 lbs. of force in combination with a 125 mm diameter inner channel 920 may be sufficient to control the craft 100 in the presence of such crosswinds. The choice of propeller pump 925 and/or inner channel diameter depends to an extent on a variety of factors such as the size of the outriggers, the weight and length of the craft 100, etc. For example, the amount of force required to be generated by the outrigger propulsion system may be larger for larger craft 100. As such, a more powerful and perhaps larger propeller pump may be required, the inner channel diameter may need to be larger, etc. And the larger propeller pump and/or inner channel diameter may necessitate using a larger outrigger body 905.

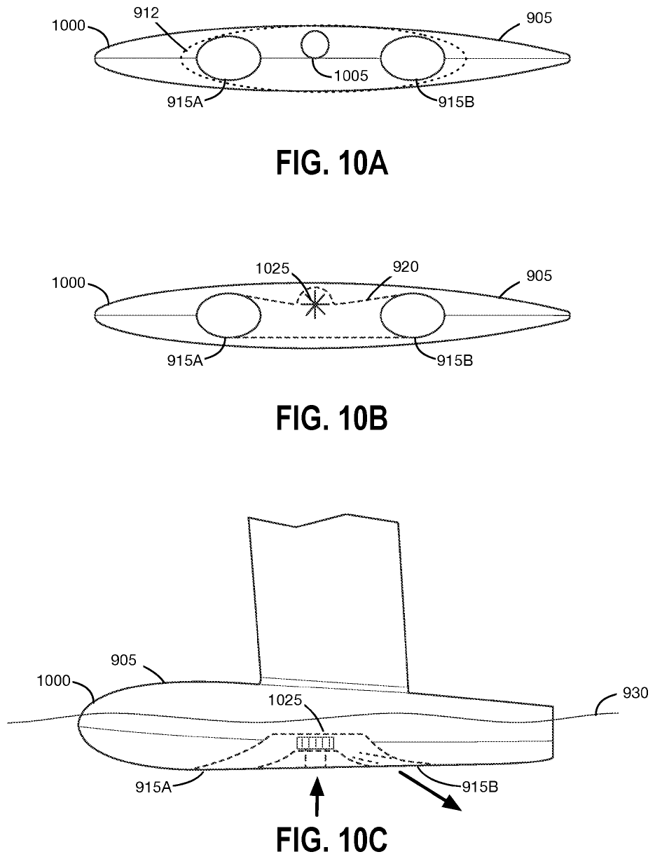

FIGS. 10A-10C illustrate various views of another example outrigger propulsion system 1000. FIGS. 10A and 10B are bottom views of the propulsion system 1000. FIG. 10A more clearly shows the bottom surface section 912 of the outrigger body 905, whereas FIG. 10B more clearly shows the inner channel 920 of the outrigger body 905. FIG. 10C is a side view of the outrigger propulsion system 1000.

The outrigger propulsion system 1000 of FIGS. 10A-10C is similar in some respects to the outrigger propulsion system 900 of FIGS. 9A and 9B. The primary difference is the use of a centrifugal pump 1025 rather than a propeller pump as the means for pumping water. In this regard, the bottom surface section 912 of the outrigger body 905 comprises a third opening 1005 in between the first opening 915A and the second opening 915B. The centrifugal pump 1025 is positioned in the inner channel such that water is pulled into the centrifugal pump 1025 via the third opening 1005, through the inner channel, and ejected from the second opening (as shown by the directed arrows) to generate forward thrust. In some examples, the direction of the centrifugal pump 1025 can be reversed such that the water is pulled in via the third opening 1005, moved through the inner channel, and ejected from the first opening 915A to generate reverse thrust.

Centrifugal pumps can generally be less complex than the propeller pumps used in the outrigger propulsion system 900 of FIGS. 9A and 9B. For example, centrifugal pumps tend to have fewer moving parts. This, in turn, makes them relatively easy to produce, and potentially more reliable to operate. A wider variety of materials can also be used to produce centrifugal pumps. And they can operate at relatively high speeds for extended periods and require relatively less maintenance.

Centrifugal pumps are also capable of generating more thrust than comparably sized propeller pumps, and the thrust generated tends to be relatively consistent. As such, for a particular required amount of power, a smaller/lower profile centrifugal pump can be used. This, in turn, facilitates decreasing the height of the middle section 920B of the inner channel 920 and moving the middle section 920B closer to the bottom of the outrigger body 905, providing more margin with respect to the surface of the water 930. The decrease in height may also result in an overall decrease in the volume of the inner channel 920 as compared to the volume of the inner channel 920 required to accommodate a propeller pump. This, in turn, may facilitate the use of a smaller outrigger body 905 because less volume is “carved out” of the outrigger body 905.

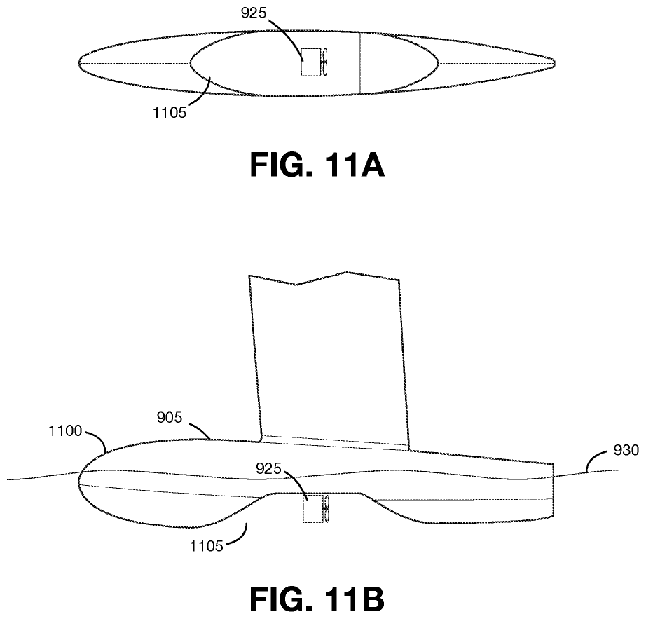

FIGS. 11A and 11B illustrate bottom and side views, respectively, of another example outrigger propulsion system 1100. The outrigger propulsion system 1100 of FIGS. 11A and 11B differs from the outrigger propulsion systems 900 described above in that the bottom surface of the outrigger body 905 defines a cavity 1105 or space within which a pump 925 is positioned. An example of the pump 925 corresponds to the propeller pump described above. In some examples, the depth of the cavity 1105 within the outrigger body 905 is sized to accommodate the pump 925 so that the pump 925 does not protrude below the lower extents of the outrigger body 905.

Placing the pump 925 lower in the outrigger body 905 can result in a relative increase in the amount of thrust usable for maneuvering the craft 100 because the horizontal component of that thrust can be larger than that of the configurations described above. This, in turn, improves the relative efficiency of the outrigger propulsion system 1100 as compared to the other outrigger propulsion systems 1100. It should be noted that the pump 925 can be configured to protrude beyond the lower extents of the outrigger body 905 to an extent to provide a greater horizontal component of thrust and, therefore, further improve efficiency. In this regard, in some examples, the pump 925 is configured to be dynamically lowered into the cavity 1105 and/or below the lower extents of the outrigger body 905 when propulsion is required, and to be retracted back into the cavity 1105 when propulsion is no longer required.

### B. Propulsion Pods

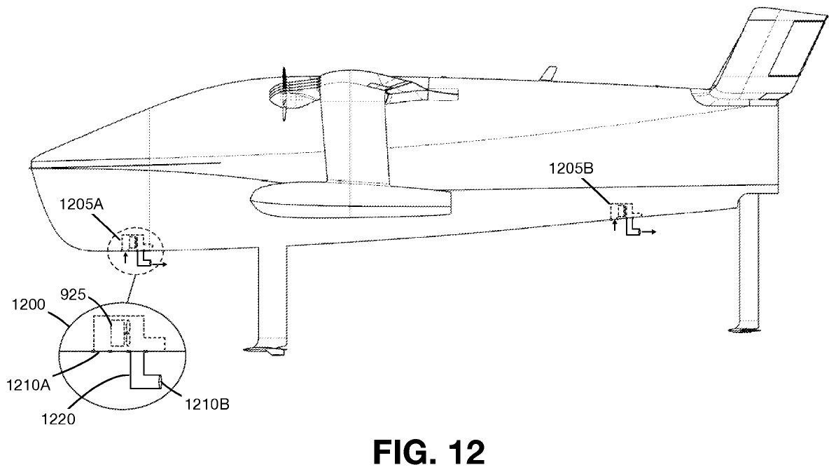

FIG. 12 illustrates examples of propulsion pods 1200 that can be used to maneuver the craft 100 when hull-borne. In some examples, the propulsion pods 1200 are used in lieu of the outrigger propulsion systems 900 described above. In some other examples, both propulsion pods 1200 and outrigger propulsion systems 900 are provided on the craft 100 and cooperate to move the craft 100 during hull-borne maneuvering mode operations. As shown, the craft 100 may include a forward propulsion pod 1205A and a rearward propulsion pod 1205B positioned respectively at the forward and rearward sections of the hull. Some examples of propulsion pod 1200 comprise a pump 925. The pump 925 may correspond to a propeller pump, centrifugal pump, etc. In operation, the pump 925 pulls water into a first opening 1210A and ejects the water from a second opening 1210B. Water may be ejected from the second opening 1210B in a generally horizontal direction to facilitate moving the craft 100 laterally. In this regard, some examples of propulsion pod 1200 comprise a nozzle 1220 configured to direct the flow of water in the horizontal direction. In some examples, the nozzle 1220 is rotatable to facilitate moving the craft 100 laterally in a variety of directions. In some examples, both the front propulsion pod 1205A and the rearward propulsion pod 1205B comprise a rotatable nozzle 1220, and the nozzles 1220 may be rotated independently of one another. For example, the nozzle 1220 of the forward propulsion pod 1205A may be rotated to cause water to be ejected in the portside direction, and the nozzle 1220 of the rearward propulsion pod 1205B may be rotated to cause water to be ejected in the starboard side direction. This may facilitate rotating the craft 100 about its vertical axis. The respective nozzles 1220 may be configured to direct water in the portside direction or the starboard direction to move the craft 100 laterally in the starboard direction or the star starboard side direction.

In some examples, the nozzle 1220 is configured to be retracted into the hull of the craft 100. For instance, the nozzle 1220 may be retracted when the craft 100 is airborne to reduce drag on the craft 100 and may be extended when the craft 100 is hull-borne to facilitate maneuvering the craft 100 in the water. In some examples, actuatable covers such as those described above are provided and configured to cover the forward opening 1210A and rearward opening 1210B when the nozzles are retracted. In some examples, rather than using a nozzle, the pump 925 itself (e.g., a propeller pump) can be lowered from the hull of the craft 100, rotated, etc., to cause the craft 100 to move laterally.

In addition to the examples above, some examples of the craft 100 may include one or more bow thrusters integrated within the hull that may be used in combination with, for example, the outrigger propulsion systems 900 and/or the propulsion pods 1200 described above to move the craft 100 when the craft 100 is in the hull-borne maneuvering mode of operation (e.g., when the propeller assemblies 116 on the wings are not engaged).

### C. Differential Propeller Control

As noted previously, the propeller assemblies 116 of the craft 100 correspond to wing-affixed control elements that can be operated in such a manner as to facilitate various on-water maneuvering operations, such as causing the craft 100 to maneuver along a particular heading and/or to a particular location. For instance, in some examples, the amount of forward thrust generated by the propeller assemblies 116 on, for example, the starboard side of the craft 100 is increased relative to the forward thrust generated (if any) by the propeller assemblies 116 on the port side of the craft 100 to impart forward and yaw forces on the craft 100 to move the craft 100 leftward. In some examples, the rudder 128 is simultaneously set to impart additional yaw force that urges the craft 100 to turn in the corresponding direction.

In some examples, the propeller assemblies 116 are set to provide the same amount of thrust and in the same direction to cause the craft 100 to move forward or backward.

In some examples, the propeller assemblies 116 on, for example, the starboard side of the craft 100 are rotated in a direction that provides forward thrust, and the propeller assemblies 116 on the port side of the craft 100 are rotated in a direction that provides an amount of reverse thrust to impart yaw on the craft 100 that rotates the craft 100 about its yaw axis (i.e., the crafts pivot point).

In this regard, in some examples, the pivot point is adjusted to an extent along the longitudinal axis of the hull by modulating the extension amounts of the main/front hydrofoil assembly 108 and rear hydrofoil assembly 110. For instance, in some examples, the main hydrofoil assembly 108 is extended to increase drag in the center of the craft 100, and the rear hydrofoil assembly 110 is retracted to reduce drag at the rear of the craft 100. This, in turn, moves the pivot point closer to the center of the craft 100. In some examples, the rear hydrofoil assembly 110 is extended to increase drag at the rear of the craft 100, and the main hydrofoil assembly 108 is retracted to decrease drag in the center of the craft 100 to move the pivot point closer to the tail of the craft 100.

Various maneuvering operations described herein may involve several sub-maneuvers to be performed. For example, a particular maneuvering operation to maneuver the craft 100 to a dock or other anchoring location may involve rotating the craft 100 to a first heading and moving the craft 100 along the first heading to a first location, then rotating the craft 100 to a second heading and moving the craft 100 along the second heading to a second location. The rotating and moving of the craft 100 during each sub-maneuver may occur simultaneously or sequentially. In some examples, changing of the heading may involve some propeller assemblies 116 operating in a first direction during a first period and operating in the opposite direction during a second period. In some maneuvering operations, the different operations may be performed in rapid succession (e.g., transitioning between sub-maneuvers in under 3 seconds). Quickly reversing the direction of the propeller assemblies 116 to change the direction of thrust between sub-maneuvers can, in some instances, be impractical. For example, some examples of propeller assemblies 116 used by some examples of craft 100 described herein can take more than 3 seconds to transition between providing 50% thrust in the forward direction to providing 50% thrust in the reverse direction.

Accordingly, in some examples, the propeller assemblies 116 of the craft 100 are operated such that during maneuvering operations, the propeller assemblies 116 are operated in a single direction. For example, during particular maneuvering operations that involve numerous sub-maneuvers to complete, a first subset of propeller assemblies 116 is operated in the forward direction, and a different subset of the propeller assemblies 116 is operated in the opposite direction.

Further, it was observed that in some implementations, it could take the propeller assemblies 116 between about 1.5-2 seconds to increase from the zero-rotation state to their maximum rotation rate and that the amount of time required to increase the rotation rate of the propeller assemblies 116 can be reduced by more than 50% by instead increasing the rotation rate of the propeller assemblies 116 from some a minimum/negligible rotation amount that provides little to no effect on the maneuvering of the craft 100. For instance, in an example implementation, idling a particular propeller at 800 RPM as opposed to starting the propeller from a zero-rotation rate state reduced the amount of time it took for the propeller to reach its maximum rotation rate of 3000 RPM from 2 seconds down to 0.25 seconds. Therefore, in some examples, the rotation rates of the propeller assemblies 116 that are used during the maneuvering operations are modulated between a minimum/idle rotation rate at which the thrust generated is insufficient to effect the maneuvering of the craft 100 and higher rates at which the thrust generated does contribute meaningfully to the maneuvering of the craft 100.

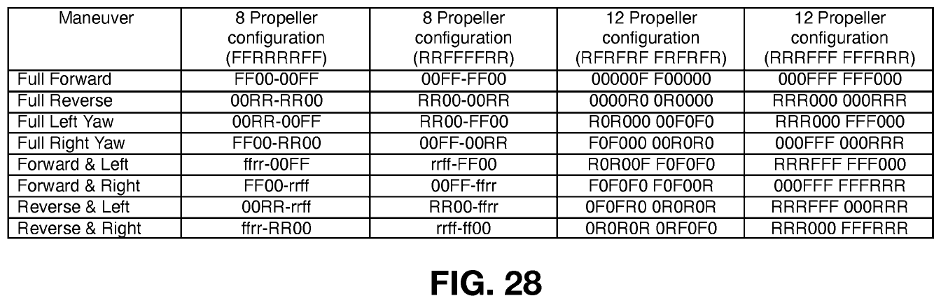

Table 4 below, also reproduced in FIG. 28, illustrates several example configurations in which the propeller assemblies 116 of the craft 100 can be operated to facilitate performing the maneuvering operations described herein. In the example configurations, a first subset of propeller assemblies 116 is configured to rotate in a first direction (e.g., clockwise or “CW”) and from an idle rotation rate to a maximum rotation rate to generate a varying amount of forward thrust. Similarly, a second subset of propeller assemblies 116 is configured to rotate in the opposite direction (e.g., counterclockwise or “CCW”) and from an idle rotation rate to a maximum rotation rate to generate a varying amount of reverse thrust. Selectively controlling the direction and amount of thrust generated by different propeller assemblies 116 facilitates performing a variety of maneuvering operations. Some examples of these maneuvering operations are listed in the table below.

In the table, the symbols “F” and “R” (and their lowercase versions) indicate that a corresponding propeller is rotating in such a direction as to provide forward and reverse thrust, respectively. The uppercase symbols indicate that a corresponding propeller is generating a maximum amount of thrust (e.g., rotating at 3000 RPM), whereas the lowercase symbols indicate that a corresponding propeller is generating, for example, 50% thrust (e.g., rotating at 1500 RPM). However, other amounts of thrust may be generated by the propeller assemblies 116. The value zero indicates that the propeller is rotating at an idle rotation rate at which a relatively small or negligible amount of thrust is generated (e.g., 800 RPM). Each column is associated with a configuration mask. For example, the mask “FFRRRRFF” in the first column for the eight propeller configuration indicates that the outer two propeller assemblies 116 are restricted to generating a varying amount of forward thrust and the inner most propeller assemblies 116 are restricted to generating a varying amount of reverse thrust. The last two columns correspond to examples of different propeller configurations that may be applied to craft 100, such as the example craft 100 disclosed herein that include twelve propeller assemblies 116.

TABLE 4

| | | | 12 Propeller | 12 Propeller |
|---|---|---|---|---|
| | 8 Propeller | 8 Propeller | configuration | configuration |
| | configuration | configuration | RFRFRF | (RRRFFF |
| Maneuver | (FFRRRRFF) | (RRFFFFRR) | FRFRFR) | FFFRRR) |
| Full | FF00-00FF | 00FF-FF00 | 00000F | 000FFF |
| Forward | | | F00000 | FFF000 |
| Full | 00RR-RR00 | RR00-00RR | 0000R0 | RRR000 |
| Reverse | | | 0R0000 | 000RRR |
| Full Left | 00RR-00FF | RR00-FF00 | R0R000 | RRR000 |
| Yaw | | | 00F0F0 | FFF000 |
| Full Right | FF00-RR00 | 00FF-00RR | F0F000 | 000FFF |
| Yaw | | | 00R0R0 | 000RRR |
| Forward & | ffrr-00FF | rrff-FF00 | R0R00F | RRRFFF |
| Left | | | F0F0F0 | FFF000 |
| Forward & | FF00-rrff | 00FF-ffrr | F0F0F0 | 000FFF |
| Right | | | F0F00R | FFFRRR |
| Reverse & | 00RR-rrff | RR00-ffrr | 0F0FR0 | RRRFFF |
| Left | | | 0R0R0R | 000RRR |
| Reverse & | ffrr-RR00 | rrff-ff00 | 0R0R0R | RRR000 |
| Right | | | 0RF0F0 | FFFRRR |

### V. EXAMPLE ON-WATER MANEUVERING OPERATIONS

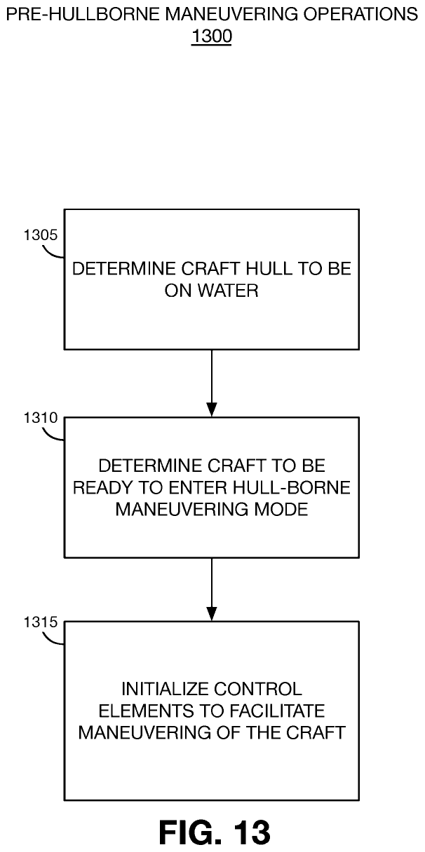

FIGS. 13-27 illustrate various examples of operations performed by some examples of the craft 100 that involve the use of one or more control elements of the craft 100 to maneuver the craft 100. Some examples of these control elements include propeller assemblies 116, outrigger propulsion systems 900, propulsion pods 1200, bow thrusters, rudder control surfaces 128a, 128b, 128n, hydrofoil assemblies 108, 110, etc. In some examples, the operations illustrated in these figures are implemented via instruction code that is executed by one or more processors of the control system 500 of the craft 100 that causes the control system 500 to control, alone or in cooperation with other subsystems of the craft 100, components of the craft 100 to perform these operations. Additionally, or alternatively, one or more of the operations can be implemented or controlled by dedicated hardware, such as via one or more application-specific integrated circuits (ASICs). Some aspects of the operations may be executed as a result of or in combination with inputs received from an operator of the craft 100 or other subsystems of the craft 100. Other aspects of the operations may alternatively and/or additionally be executed automatically.

### A. Pre-Hull-Borne Maneuvering Operations

FIG. 13 illustrates examples of operations 1300 performed by some examples of the craft 100 before the craft 100 begins to perform the hull-borne maneuvering operations described below. The operations at block 1305 involve the control system 500 determining that the hull of the craft 100 is on the water. Various techniques for determining whether the hull of the craft 100 is on the water are disclosed in U.S. Prov. App. 63/493,575, filed Mar. 31, 2023, which is incorporated herein by reference in its entirety. For instance, the craft 100 may have been controlled to land. As the craft 100 descends, the hydrofoils 130, 136 of the craft 100 may contact the water and the craft 100 may be controlled to enter a hydrofoil-borne mode of operation. During this mode of operation, the propeller assemblies 116 may still be operating to facilitate hydrofoil-borne movement through the water. In some examples, the craft 100 may remain in this mode of operation until the craft 100 reaches a predetermined target landing area or a threshold distance from the target landing area. For example, the pilot may have specified the GPS coordinate of the target landing area, and the control system 500 of the craft 100 may control the craft 100 via one or more control surfaces of the craft 100 to move towards that area. After reaching the target landing area, the craft 100 may transition to a hull-borne mode of operation. This may involve reducing power to the propeller assemblies 116 to allow the craft 100 to descend into the water. In some examples, after entering the hull-borne mode of operation, the hydrofoils 130, 136 may be retracted into or adjacent to the hull of the craft 100. At this stage, the craft 100 may continue to be moved under the power of the propeller assemblies 116 that are arranged on the wings until, for example, the craft 100 reaches a target area (e.g., an area within a threshold distance of a dock).

The operations at block 1310 involve preparing the craft 100 to enter a hull-borne maneuvering mode of operation. In some examples, the control system 500 determines the craft 100 to be ready to enter this mode of operation after the craft 100 reaches the target area. This may involve cutting power to the propeller assemblies 116 to slow or stop the craft 100.

The operations at block 1315 involve initializing one or more of the control elements to facilitate maneuvering the craft 100 (e.g., to control or set the heading and/or position of the craft 100). For instance, initializing the propeller assemblies 116 to facilitate maneuvering operations may involve configuring one or more propeller assemblies 116 to rotate at an idle rotation speed and in a particular direction to facilitate using the techniques described, for example, in Table 4 to maneuver the craft 100. Initializing the hydrofoil assemblies 108, 110 to facilitate maneuvering operations may involve extending or retracting the hydrofoil assemblies 108, 110 as necessary to adjust the pivot point of the craft 100. Initialization of the rudder control surfaces 128a, 128b, 128n may involve setting the respective deflection angles of the rudder control surfaces 128a, 128b, 128n to zero.

Initializing propulsion systems such as outrigger propulsion systems 900, propulsion pods 1200, and/or bow thrusters may involve controlling the propulsion systems to be extended from the outriggers 114 and/or the hull and/or controlling actuatable covers to uncover the respective openings of the propulsion systems. In some examples, initializing one or more of these propulsion systems involves the control system 500 holding off on engaging the hull-borne maneuvering until after determining that the pumps of the outrigger propulsion systems 900 are submerged in the water (e.g., using sensors to detect and facilitate prevention of an “airlock” condition).

In some examples, the pre-hull-borne maneuvering operations 1300 are performed after first determining that the water speed of the craft 100 is below a threshold speed. For example, the control system 500 may hold off on initializing the control elements until after the water speed is below 7 knots. In some examples, these initialization operations do not occur until after the propeller assemblies 116 are shut down.

In some examples, the pre-hull-borne maneuvering operations 1300 are performed after the pilot indicates to the control system 500 that the craft 100 should perform a maneuvering operation such as docking, anchoring, station-keeping, etc. Other techniques for triggering the craft 100 to perform hull-borne maneuvering operations are disclosed in U.S. Prov. App. 63/459,197, filed Apr. 13, 2023, which is incorporated herein by reference in its entirety.

### B. Operations to Align Craft to Target Heading

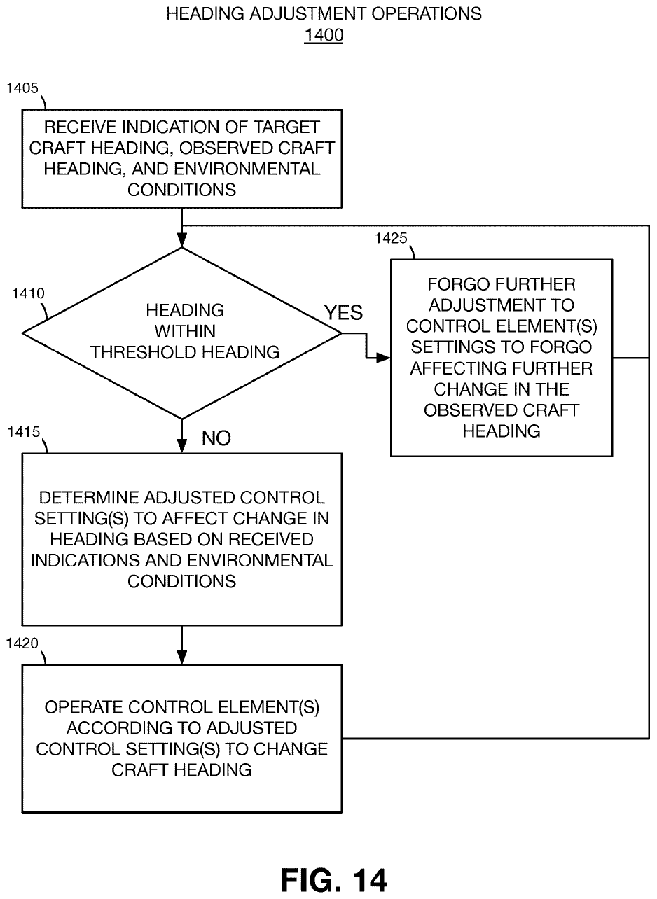

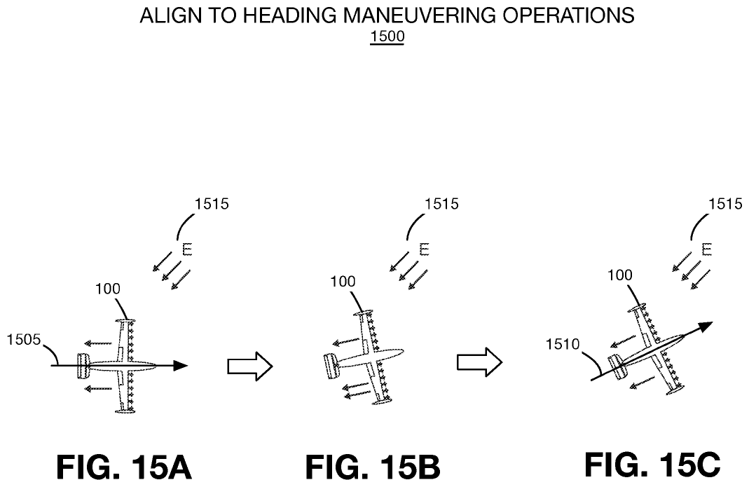

FIG. 14 illustrates example heading adjustment operations 1400 performed by some examples of the craft 100, while hull-borne and maneuvering, to adjust the heading of the craft 100 to a particular/target heading. The operations of FIG. 14 may be further described with reference to FIGS. 15A-15C, which illustrate an example craft 100 adjusting its heading according to the example heading adjustment operations 1400.

The operations at block 1405 involve the control system 500 receiving an indication of a target craft heading 1510, an observed craft heading 1505, and environmental conditions 1515, as shown in the examples illustrated in FIGS. 15A and 15C. In some examples, the target craft heading 1510 is specified by the pilot of the craft 100, by an automated onboard system of the craft 100, and/or from a remote system. For example, the pilot or one of these systems may specify that the craft 100 should have a heading of 120°. In some examples, the pilot or one of these systems may specify that the craft 100 should move to a particular/predetermined location (e.g., anchoring location, a dock, a GNSS location, etc.), and the control system 500 determines the target craft heading 1510 as the direction to the location.

Some examples of the craft 100 comprise one or more sensors and/or are in communication with one or more systems that facilitate determining the observed craft heading 1505. For instance, some examples of the craft 100 include magnetic compasses, gyroscopes, etc., that facilitate determining the heading of the craft 100. Some examples of the craft 100 include a GNSS system that facilitates determining the observed craft heading 1505. Some examples of the craft 100 comprise one or more sensors that facilitate determining the environmental conditions 1515 associated with the craft 100, such as, for example, the wind velocity and direction, the water current velocity and direction, wave height, swell, direction, and period.

The operations at block 1410 involve the control system 500 determining whether the difference between the target craft heading 1510 and the observed craft heading 1505 is above a predetermined threshold heading difference (e.g., beyond a 0° difference, 5° difference, etc.). When the heading difference is determined to be above the predetermined threshold heading difference, the operations at block 1415 are performed. Otherwise, the operations at block 1425 are performed.

The operations at block 1415 involve the control system 500 determining one or more adjustments to be made to settings associated with one or more control elements of the craft 100 to affect a change in the heading of the craft 100 that should cause the craft 100 to move in the target craft heading 1510. The operations at block 1420 involve operating the control elements according to the adjusted settings determined above (as shown in FIGS. 15B and 15C) and returning to block 1410.

Some examples of the control elements that can be adjusted to alter the heading of the craft 100 correspond to outrigger propulsion systems 900, propulsion pods 1200, bow thrusters, propeller assemblies 116, and rudder control surfaces 128a, 128b, 128n. In some examples, the respective heights of the main hydrofoil assembly 108 and rear hydrofoil assembly 110 correspond to control elements/aspects that can be adjusted to affect a change in the pivot point of the craft 100 and, therefore, affect a change in the heading of the craft 100. Additionally, in some examples, one or more control surfaces on the tail 106 of the craft 100 can be used to affect a change in the heading of the craft 100, especially in an environment with strong winds.

In some examples, the control system 500 determines the most appropriate control element or combination of control elements to use to adjust the heading of the craft 100. In some examples, this determination is made in part based on the environmental conditions 1515. For example, if the craft 100 is hull-borne and moving on the water and sufficient air is flowing over the craft 100 and, in particular, the rudder of the craft 100, the control system 500 may determine that that the rudder control surfaces 128a, 128b, 128n are the most appropriate control elements to use to adjust the heading of the craft 100 because little to no additional thrust, and therefore power, may be required to adjust the heading. In this case, the control system 500 may determine an angle to which the rudder control surfaces 128a, 128b, 128n should be changed to cause the craft 100 to change its heading.

In another example, such as perhaps when there is insufficient air flowing over the rudder control surfaces 128a, 128b, 128n, the control system 500 may determine that one of the propulsion systems (e.g., propeller assemblies 116, outrigger propulsion systems 900, propulsion pods 1200, bow thrusters) should be used to adjust the heading of the craft 100. For example, when the craft 100 is operating in an area free of obstacles that might otherwise interfere with propeller operation, the control system 500 may determine that the propeller assemblies 116 should be used to adjust the heading because, in general, the propeller assemblies 116 can deliver more maneuvering thrust than other propulsion systems of the craft 100. When there are obstacles nearby, the control system 500 may determine, for example, that the outrigger propulsion systems 900, propulsion pods 1200, and/or bow thrusters should be used to adjust the heading instead. In some examples, the control system 500 is in communication with various sensors on the craft that facilitate determining whether there are obstacles near the craft 100.

In examples where one or more of the propulsion systems are used to adjust the heading, the control system 500 may determine the amount and direction of thrust that should be generated by the propulsion systems to adjust the heading. For example, when using twelve propeller assemblies 116 in a “RFRFRF FRFRFR” configuration as shown in Table 4, the control system 500 may determine that the propeller assemblies 116 should be in the “R0R00F F0F0F0” configuration to cause the craft 100 to move forward and to the left and in the “F0F0F0 F0F00R” configuration to cause the craft 100 to move forward and to the right. When using the outrigger propulsion systems 900, the control system 500 may determine that the port outrigger propulsion system 900 should generate more forward thrust than the starboard outrigger propulsions system 900 to cause the craft 100 to turn or move leftward and that the starboard outrigger propulsion system should generate more forward thrust than the port outrigger propulsions system to cause the craft 100 to turn or move rightward. In some examples, the amount of thrust generated by the propulsion systems and the direction of that thrust is determined based in part on the environmental conditions 1515, such as, for example, the wind velocity and direction, the water current velocity and direction, wave height, swell, direction, and period to counteract these environmental conditions 1515.

In some examples, such as perhaps when the craft 100 is not moving but needs its heading to be adjusted, the control system 500 may determine that the pivot point about which the craft 100 rotates should be adjusted. For example, when the control system 500 determines that the pivot point should be closer to the longitudinal center of the craft 100, the control system 500 may determine that the main hydrofoil assembly 108 should be extended and that the rear hydrofoil assembly 110 should be retracted. When the control system 500 determines that the pivot point should be closer to the tail end of the craft 100, the control system 500 may determine that the rear hydrofoil assembly 110 should be extended and the main hydrofoil assembly 108 should be retracted. When the pivot point should be somewhere in between these two locations, the control system 500 may determine that both the main hydrofoil assembly 108 and the rear hydrofoil assembly 110 need to be extended to some extent to adjust the pivot point of the craft 100. In some examples, before adjusting the main hydrofoil assembly 108 and the rear hydrofoil assembly 110, the control system 500 determines (e.g., via underwater sensors) whether there are any obstructions (e.g., rocks, coral, kelp, etc.) below the surface of the water that could impede or interfere with movement and/or extension of the main hydrofoil assembly 108 and the rear hydrofoil assembly 110. If such obstructions exist, the craft 100 may forgo extending the main hydrofoil assembly 108 and the rear hydrofoil assembly 110 or may extend the main hydrofoil assembly 108 and the rear hydrofoil assembly 110 to a lesser extent to avoid hitting the obstructions.

In some examples, the control system 500 determines the control elements to use according to a predetermined control element usage map. For example, the control element usage map may indicate to the control system 500 where different control elements 500 are permitted to be used in a geographic region. For example, an example control element usage map may indicate that the propeller assemblies 116 are permitted to be used to maneuver the craft 100 in a particular region relatively far from the shoreline, that the outrigger propulsion systems 900 should be used in a different region that is closer to the shoreline, and that the bow thrusters should be used in regions adjacent to a dock.

After the operations at block 1420 for adjusting the control settings are performed, the operations at block 1410 for determining whether the difference between the target craft heading 1510 and the observed craft heading 1505 is above the predetermined threshold heading difference are performed. As such, in some examples, the control element settings may be continually adjusted or refined as the observed craft heading 1505 of the craft 100 moves towards the target craft heading 1510 and/or the environmental conditions 1515 change.

At block 1410, when the heading difference is determined to be within the predetermined threshold heading difference, the operations at block 1425 are performed. For instance, in some examples, the control system 500 forgoes making any further adjustments to the control element settings to forgo affecting any further change to the observed craft heading 1505 (i.e., to maintain the heading). In some examples, such as when there are no environmental forces (e.g., wind, water current) acting on the craft, this involves returning the settings of the control elements to the state they were in prior to entering the heading adjustment operating mode. After the operations at block 1425 are performed, the operations may repeat from block 1410. For example, if the threshold heading difference were to exceed the predetermined threshold heading difference, the control elements may be adjusted again to bring the heading difference within the predetermined threshold heading difference.

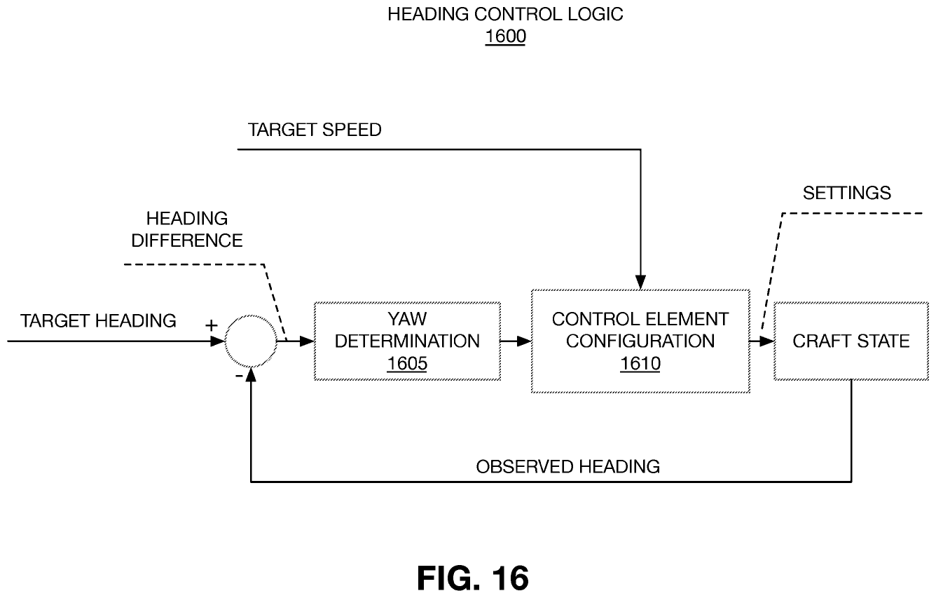

FIG. 16 is a schematic diagram of example heading control logic 1600 implemented by some examples of the control system 500 to facilitate the performance of the heading adjustment operations 1400 shown in FIG. 14. As shown, a signal that represents the difference between the target heading and the observed/sensed heading is input to yaw determination logic 1605, which converts this difference to a desired yaw. An example of the yaw determination logic 1605 includes proportional/integral/derivative (PID) logic for determining a first yaw signal, rate limiting logic for limiting the first yaw signal to within an acceptable range, and conversion logic. The conversion logic converts the yaw signal into one or more signals that can be input to control element configuration logic 1610. The control element configuration logic 1610 outputs one or more settings to the control elements of the craft 100 that cause the control elements to affect a change in the yaw of the craft 100. This, in turn, affects a change in the heading of the craft 100. For instance, examples of the settings output from the control element configuration logic 1610 correspond to wing-affixed control settings such as those that control the thrust and direction for each of the propeller assemblies 116 of the craft 100 and/or the outrigger propulsion systems 900. During operations, these settings may be continually adjusted by the heading control logic 1600 to minimize the difference between the target heading and the observed heading. In some examples, the control element configuration logic 1610 also receives a target speed indication, which causes the control elements to be operated such that the craft 100 moves along the desired heading and at a desired speed.

### C. Operations to Maneuver Craft to Target Location

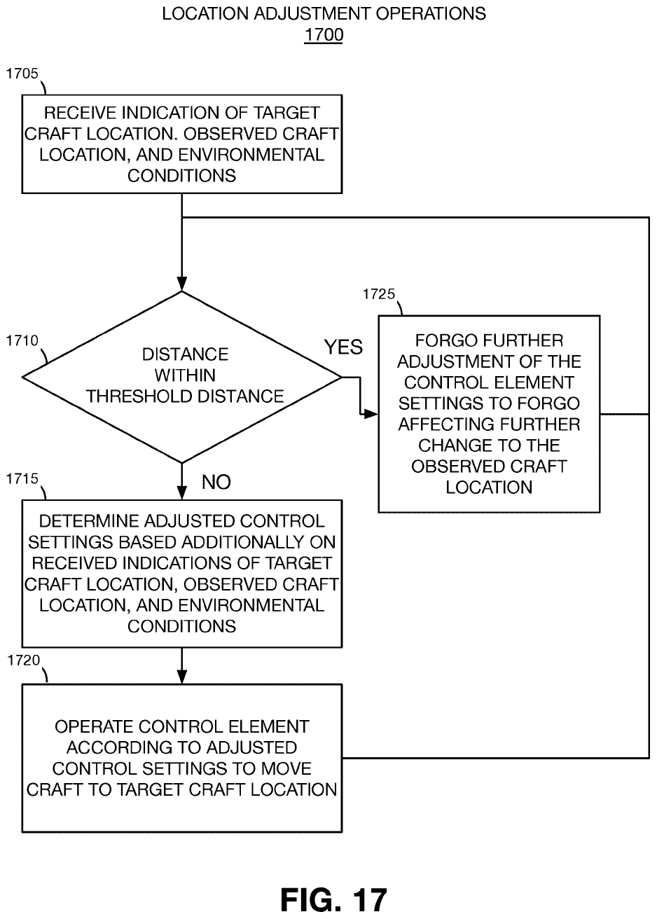

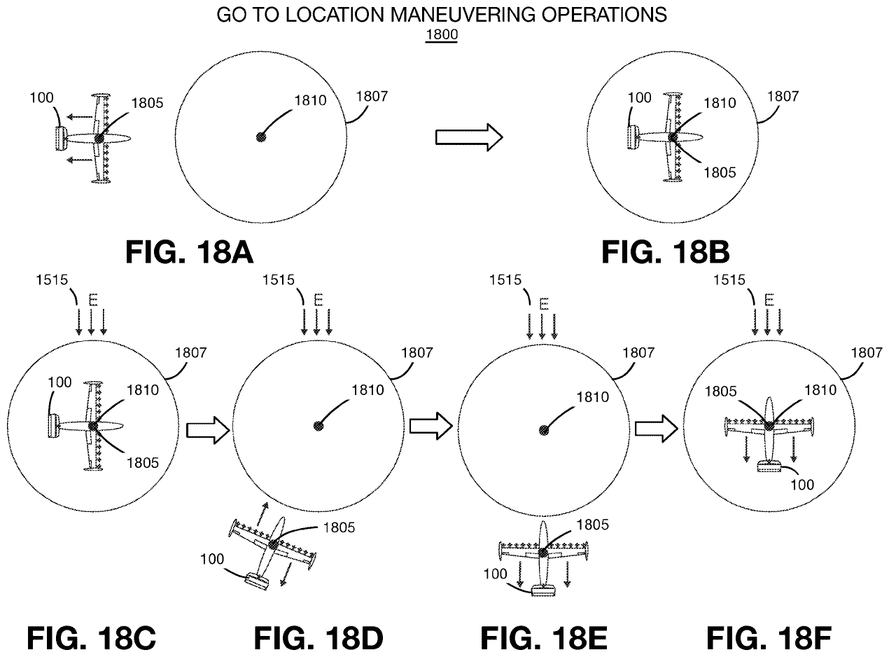

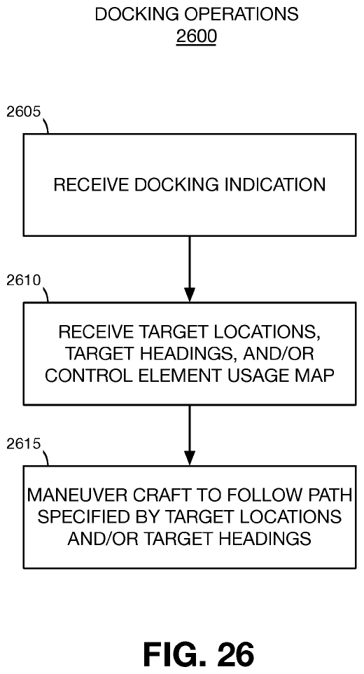

FIG. 17 illustrates example location adjustment operations 1700 performed by some examples of the craft 100, while hull-borne and maneuvering, to adjust the location of the craft 100 to a particular/target location. The operations of FIG. 17 may be further described with reference to FIGS. 18A-18F, which illustrate an example craft 100 adjusting its location according to the example location adjustment operations 1700. In this regard, FIGS. 18A and 18B illustrate an example of a craft 100 maneuvering to a target craft location 1810 and FIGS. 18C-18F illustrate an example of a craft 100 maneuvering to a target craft location 1810 when certain environmental conditions 1515 are present (e.g., wind, water current, waves, etc.). In some examples, these operations are performed in conjunction with the heading adjustment operations 1400 described in FIG. 14 for adjusting the heading of the craft 100 to the particular/target heading. For example, the craft 100 may be controlled to maneuver along a particular/target heading toward a particular/target location. As described in more detail in regard to FIG. 26, in some examples, multiple target craft headings and target craft locations corresponding to multiple waypoints may be used to cause the craft 100 to maneuver along a particular route and toward a particular target location, such as a dock. For instance, the craft 100 may be controlled to move along a first target heading towards a first target location. After reaching the first target location, the craft 100 may be controlled to move along a second target heading towards a second target location. These operations may be repeated until the craft 100 reaches a final target location.

The operations at block 1705 involve the control system 500 of the craft 100 receiving an indication of a target craft location 1810, an observed craft location 1805, a threshold location difference 1807 shown as a circle perimeter around the target craft location 1810, and environmental conditions 1815, as shown in FIGS. 18A and 18C. In some examples, the target craft location 1810 is specified by the pilot of the craft 100, by an automated onboard system of the craft 100, and/or from a remote system. An example of the target craft location 1810 corresponds to particular spatial geographic coordinates of a known location, such as a dock, a mooring location, an anchoring or virtual anchoring location, etc. In some examples, the spatial coordinates of the location may be known ahead of time. In this regard, the control system 500 may search a database for the spatial coordinates (e.g., GNSS location) of a particular location associated with a particular landing area (e.g., the location of a dock that is near the target landing area). The database may be onboard (e.g., stored in the memory of the control system 500) or hosted by a remote computer in wireless communication with the control system 500.

Some examples of the craft 100 comprise one or more systems that facilitate determining the observed craft location 1805, such as a GNSS system. In some examples, the observed craft location 1805 corresponds to the spatial coordinates of the craft 100 as determined via the GNNS system. In some examples, the observed craft location 1805 is determined via trilateration (e.g., by measuring the distance of the craft 100 to several (e.g., three) known reference points). In this regard, some examples of the target area in which the craft 100 lands include a group of signal transmitting beacons (e.g., proximate a docking location) and some examples of the craft 100 measure the time it takes for the respective signals to reach the craft 100 to determine the distance between the craft 100 and each beacon and, therefore, the location of the craft 100 relative to the location of the beacons. Some examples of the craft 100 comprise one or more sensors that facilitate determining the environmental conditions 1515 associated with the craft 100, such as the wind velocity and direction, the water current velocity and direction, wave height, swell direction and period, etc.

The operations at block 1710 involve the control system 500 determining whether the difference between the target craft location 1810 and the observed craft location 1805 are different and/or the difference between the two is above a predetermined threshold location difference 1807. When the location difference is determined to be above the predetermined threshold location difference, the operations at block 1715 are performed.

The operations at block 1715 involve the control system 500 determining one or more adjustments to be made to the settings associated with one or more control elements of the craft 100 to affect a change in the location of the craft 100 that should cause the craft 100 to move to the target craft location 1810. The operations at block 1720 involve operating the control elements according to the determined/adjusted settings.

Some examples of the control elements that can be adjusted to alter the position of the craft 100 correspond to outrigger propulsion systems 900, propulsion pods 1200, bow thrusters, propeller assemblies 116, and rudder control surfaces 128a, 128b, 128n. In some examples, the respective heights of the main hydrofoil assembly 108 and rear hydrofoil assembly 110 correspond to control elements/aspects that can be adjusted to affect a change in the pivot point of the craft 100 and, therefore, affect a change in the heading of the craft 100. Additionally, in some examples, one or more control surfaces on the tail 106 of the craft 100 can be used to affect a change in the heading of the craft 100, especially in an environment with strong winds.

In some examples, the control system 500 determines the most appropriate control element or combination of control elements to use to adjust the location of the craft 100. In some examples, this determination is made in part based on the environmental conditions 1515. For example, if the control system 500 determines that the heading of the craft 100 needs to be changed to cause the craft 100 to move towards the target craft location 1810, and if sufficient air is flowing over the rudder control surfaces 128a, 128b, 128n, the control system 500 may determine that the rudder control surfaces 128a, 128b, 128n are the most appropriate control elements to use to adjust the heading of the craft 100 because little to no additional thrust, and therefore power, may be required to adjust the heading. In this case, the control system 500 may determine an angle to which the rudder control surfaces 128a, 128b, 128n should be changed to cause the craft 100 to change its heading.

In another example, such as perhaps when there is insufficient air flowing over the rudder control surfaces 128a, 128b, 128n, the control system 500 may determine that one of the propulsion systems (e.g., propeller assemblies 116, outrigger propulsion systems 900, propulsion pods 1200, bow thrusters) should be used to adjust the location of the craft 100. For example, when the craft 100 is operating in an area free of obstacles that might otherwise interfere with propeller operation, the control system 500 may determine that the propeller assemblies 116 should be used to adjust the location because, in general, the propeller assemblies 116 can deliver more maneuvering thrust than other propulsion systems of the craft 100. When there are obstacles nearby, the control system 500 may determine that the outrigger propulsion systems 900, propulsion pods 1200, and/or bow thrusters should be used instead to adjust the heading. In some examples, the control system 500 is in communication with various sensors on the craft that facilitate determining whether there are obstacles near the craft 100.

In examples where one or more of the propulsion systems are used to adjust the location, the control system 500 may determine the amount and direction of thrust that should be generated by the propulsion systems to adjust the location. For example, when using twelve propeller assemblies 116 in a “RFRFRF FRFRFR” configuration as shown in Table 4, the control system 500 may determine that the propeller assemblies 116 should be in the “R0R00F F0F0F0” configuration to cause the craft 100 to move forward and to the left or in the “F0F0F0 F0F00R” configuration to cause the craft 100 to move forward and to the right. When using the outrigger propulsion systems 900, the control system 500 may determine that the port outrigger propulsion system should generate more forward thrust than the starboard outrigger propulsions system to cause the craft 100 to turn or move leftward and that the starboard outrigger propulsion system should generate more forward thrust than the port outrigger propulsions system to cause the craft 100 to turn or move rightward. In some examples, the amount of thrust generated by the propulsion systems and the direction of that thrust is determined based in part on the environmental conditions 1515, such as the wind velocity and direction, the water current velocity and direction, wave height, swell, direction, and period to counteract these environmental conditions 1515.

In some examples, such as perhaps when the craft 100 is not moving but needs its location to be adjusted, the control system 500 may determine that the pivot point about which the craft 100 rotates should be adjusted. For example, when the control system 500 determines that the pivot point should be closer to the longitudinal center of the craft 100, the control system 500 may determine that the main hydrofoil assembly 108 should be extended and that the rear hydrofoil assembly 110 should be retracted. When the control system 500 determines that the pivot point should be closer to the tail end of the craft 100, the control system 500 may determine that the rear hydrofoil assembly 110 should be extended and the main hydrofoil assembly 108 should be retracted. When the pivot point should be somewhere in between these two locations, the control system 500 may determine that both the main hydrofoil assembly 108 and the rear hydrofoil assembly 110 need to be extended to some extent to adjust the pivot point of the craft 100. In some examples, before adjusting the main hydrofoil assembly 108 and the rear hydrofoil assembly 110, the control system 500 determines (e.g., via underwater sensors) whether there are any obstructions (e.g., rocks, coral, kelp, etc.) below the surface of the water that could impede or interfere with movement and/or extension of the main hydrofoil assembly 108 and the rear hydrofoil assembly 110. If such obstructions exist, the craft 100 may forgo extending the main hydrofoil assembly 108 and the rear hydrofoil assembly 110 or may extend the main hydrofoil assembly 108 and the rear hydrofoil assembly 110 to a lesser extent to avoid hitting the obstructions.

In some examples, the control system 500 determines the control elements to use according to a predetermined control element usage map. For example, the control element usage map may indicate to the control system 500 where different control elements 500 are permitted to be used in a geographic region. For example, an example control element usage map may indicate that the propeller assemblies 116 are permitted to be used to maneuver the craft 100 in a particular region relatively far from the shoreline, that the outrigger propulsion systems 900 should be used in a different region that is closer to the shoreline, and that the bow thrusters should be used in regions adjacent to a dock.

After the operations at block 1720 for adjusting the control settings are performed, the operations at block 1710 for determining whether the difference between the target craft location 1810 and the observed craft location 1805 is above a predetermined threshold location difference is performed. As such, in some examples, the settings are continually adjusted or refined as the craft 100 moves towards the target craft location 1810.

Returning to block 1710, when the location difference is determined to be within the predetermined threshold location difference, the operations at block 1725 are performed. For instance, in some examples, the control system 500 forgoes making any further adjustments to the control elements settings associated with the control elements to forgo affecting a change in the observed location of the craft 100 (i.e., to maintain the location). In some examples, this involves returning the settings of the control elements to the state they were in prior to entering the location adjustment operating mode. After the operations at block 1725 are performed, the operations may repeat from block 1710. For example, if the location difference were to exceed the predetermined threshold location difference, the control elements may be adjusted again to bring the location difference within the predetermined threshold location difference.

FIGS. 18A-18F illustrate various conditions under which an example of a craft 100 adjusts its location according to location adjustment operations 1700 of FIG. 17. In FIG. 18A, there are no meaningful environmental conditions (e.g., wind, water current, etc.) affecting the craft 100, and the heading of the craft 100 is aligned with the target craft location 1810. Under these circumstances, the control system 500 may engage one or more propulsion systems of the craft 100 to move the craft 100 to the target craft location 1810. After the craft 100 reaches the target craft location 1810, the control system 500 disengages the propulsion systems. For example, when using twelve propeller assemblies 116 in a “RFRFRF FRFRFR” configuration as shown in Table 4, the control system 500 may determine that the propeller assemblies 116 should be in the “00000F F00000” configuration to cause the craft 100 to move forward to the target craft location. When using the outrigger propulsion systems 900, the control system 500 may determine that the port and starboard outrigger propulsion systems 900 should generate the same amount to cause the craft 100 to move forward to the target craft location 1810.

In FIG. 18C, the craft 100 is initially at the target craft location 1810 and the environmental conditions 1515 (e.g., wind, water current, etc.) cause the craft 100 to move away from the target craft location 1810. After the craft 100 is a threshold position distance 1807 away from the target craft location 1810, the control system 500 causes the craft 100 to perform various maneuvers to return the craft 100 to (or within) a threshold position difference 1807 of the target craft location 1810. For example, after the craft 100 passes the threshold position difference 1807, the control system 500 causes the craft 100 to rotate towards the target craft location 1810. For example, when using twelve propeller assemblies 116 in a “RFRFRF FRFRFR” configuration as shown in Table 4, the control system 500 may determine that the propeller assemblies 116 should be in the “R0R000 00F0F0” full left yaw configuration to cause the craft 100 to rotate counterclockwise. When using the outrigger propulsion systems 900, the control system 500 may cause the port outrigger propulsion system to generate reverse thrust and the starboard propulsion system to generate forward thrust. In some examples, the control system 500 may cause the main hydrofoil assembly 108 to extend and the rear hydrofoil assembly 110 to retract (or remain retracted) to adjust the pivot point of the craft 100 to the center of the craft 100. In some examples, the control system 500 continues to apply these maneuvers until the observed craft heading 1505 indicates that the craft 100 is pointing toward the target craft location 1810. As shown in FIG. 18E, afterward the craft is heading towards the target craft location 1810, the control system 500 may determine that the propeller assemblies 116 should be in the “00000F F00000” full forward configuration and/or that the outrigger propulsion system should generate forward thrust to cause the craft 100 to move forward towards the target craft location 1810. In some examples, the control system 500 may simultaneously cause the main hydrofoil assembly 108 to retract (if extended) to reduce drag on the craft 100. As shown in FIG. 18F, after the craft 100 reaches or is within the threshold position distance 1807 of the target craft location 1810, the control system 500 may adjust the thrust generated by the propulsion systems to counteract the environmental conditions 1815 so that the craft 100 remains at the target craft location 1810.

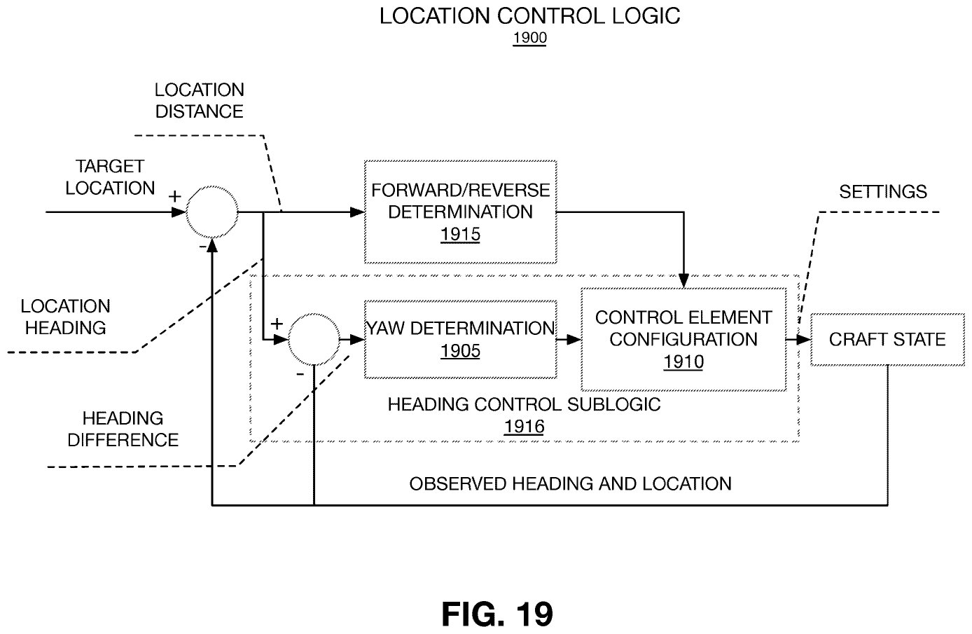

FIG. 19 is a schematic diagram of example location control logic 1900 implemented by some examples of the control system 500 to facilitate the performance of the location adjustment operations 1700 shown in FIG. 17. As shown, a location distance signal that represents the difference between the target location and the observed/sensed location is input to forward/reverse determination logic 1915. The location difference signal is simultaneously input to the heading control sub-logic 1916 of the location control logic 1900, which operates in a manner similar to the heading control logic 1600 shown in FIG. 16.

An example of the forward/reverse determination logic 1915 includes proportional/integral/derivative (PID) logic for determining a first forward/reverse signal, rate limiting logic for limiting the first forward/reverse signal to within an acceptable range, and conversion logic. The conversion logic converts the forward/reverse signal into one or more signals that can be input to control element configuration logic 1910.

The control element configuration logic 1910 outputs one or more settings to the control elements of the craft 100 that cause the control elements to affect a change in the forward or reverse thrust and to affect a change in the yaw of the craft 100. This, in turn, affects a change in the location of the craft 100 and the heading of the craft 100. For instance, examples of the settings output from the control element configuration logic 1910 correspond to wing-affixed control settings such as those that control the thrust and direction for each of the propeller assemblies 116 of the craft 100 and/or the outrigger propulsion systems 900. During operations, these settings may be continually adjusted by the location control logic 1900 to minimize the difference between the target location and the observed location.

### D. Hull-Aligned Maneuvering Operations to Maneuver Craft to Target Location

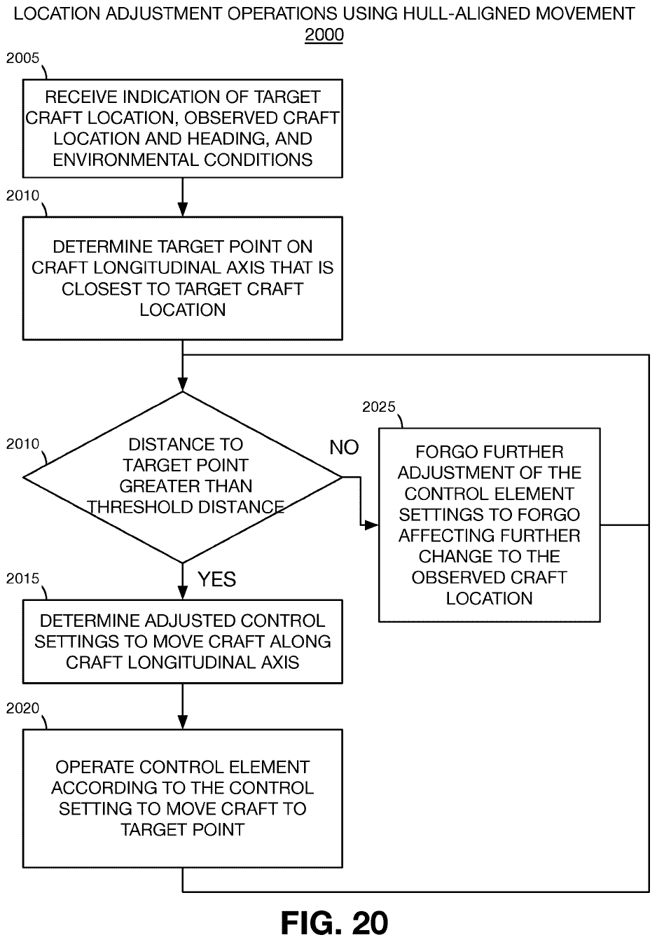

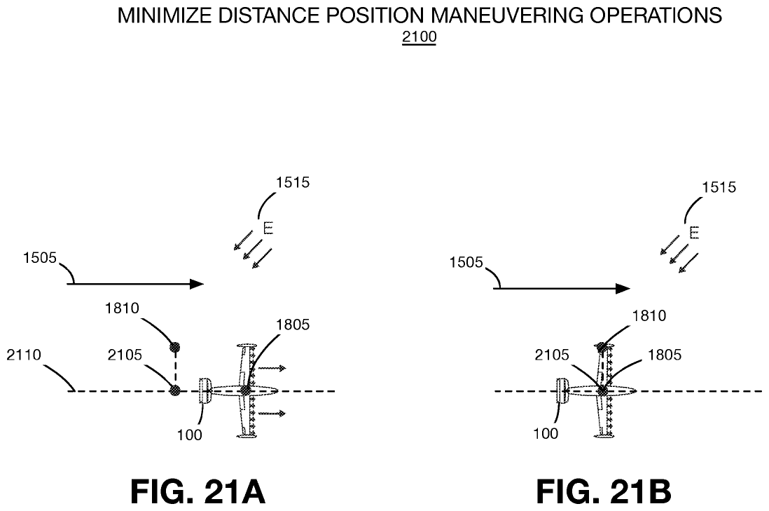

FIG. 20 illustrates example operations 2000 performed by some examples of the craft 100, while hull-borne and maneuvering, to minimize the distance between the craft 100 and a particular/target craft location using hull-aligned movements. The operations of FIG. 20 may be further described with reference to FIGS. 21A and 21B, which illustrate an example craft 100 adjusting its location according to the example operations 2000. In some examples, these operations are performed after the craft 100 has ceased operating in the heading adjustment mode and location adjustment mode described in FIGS. 14 and 17, respectively. For example, the craft 100 may have reached the target craft location 1810 specified during the location adjustment operations 1700.

The operations at block 2005 involve the control system 500 of the craft 100 receiving an indication of a target craft location 1810, observed craft location 1805, an observed craft heading 1505, and environmental conditions 1815. In some examples, the target craft location 1810 is specified by the pilot of the craft 100, by an automated onboard system of the craft 100, and/or from a remote system. An example of the target craft location 1810 corresponds to particular spatial geographic coordinates of a known location, such as a dock, mooring location, etc. In some examples, the spatial coordinates of the location may be known ahead of time. In this regard, the control system 500 may search a database for the spatial coordinates (e.g., GNSS location) of a particular location associated with a particular landing area (e.g., the location of a dock that is near the target landing area). The database may be onboard (e.g., stored in the memory of the control system 500) or hosted by a remote computer in wireless communication with the control system 500.

Some examples of the craft 100 comprise one or more systems that facilitate determining the observed craft location 1805, such as a GNSS system. In some examples, the observed craft location 1805 corresponds to the spatial coordinates of the craft 100 as determined via the GNNS system. In some examples, the observed craft location 1805 is determined via trilateration (e.g., by measuring the distance of the craft 100 to several (e.g., three) known reference points). In this regard, some examples of the target area in which the craft 100 lands include a group of signal transmitting beacons (e.g., proximate a docking location) and some examples of the craft 100 measure the time it takes for the respective signals to reach the craft 100 to determine the distance between the craft 100 and each beacon and, therefore, the location of the craft 100 relative to the location of the beacons. Some examples of the craft 100 comprise one or more sensors that facilitate determining the environmental conditions 1515 associated with the craft 100, such as the wind velocity and direction, the water current velocity and direction, wave height, swell direction and period, etc.

The operations at block 2010 involve the control system 500 determining a target point 2105 on the craft longitudinal axis 2110 that is closest to the target craft location 1810. In some examples, this involves the control system 100 determining the craft longitudinal axis 2110 to correspond to the observed craft heading 1505, determining a normal axis that is normal to the craft longitudinal axis 2110 and that passes through the target craft location 1810, and determining the target point 2105 as the intersection of the normal axis and the craft longitudinal axis 2110.

The operations at block 2010 involve the control system 500 determining whether the distance between the craft 100 and the target point 2105 is above a threshold difference. When the location difference is determined to be above the predetermined threshold location difference, the operations at block 2015 are performed.

The operations at block 2015 involve the control system 500 determining adjusted control settings to move the craft 100 along the craft longitudinal axis 2110. The operations at block 2020 involve operating the control elements according to the determined/adjusted settings.

Some examples of the control elements that can be adjusted to alter the position of the craft 100 along the craft longitudinal axis 2110 correspond to propulsion systems that can generate thrust in the forward and reverse directions, such as the outrigger propulsion systems 900 and the propeller assemblies 116. In some examples, the propulsion pods 1200 and bow thrusters may be configured to generate forward and reverse thrust along the craft longitudinal axis 2110 and, therefore, may also be used to adjust the position of the craft 100 along the craft longitudinal axis 2110.

After the operations at block 2020 for adjusting the control settings are performed, the operations at block 2010 for determining whether the distance between the craft 100 and the target point 2105 is above a threshold difference are performed. As such, in some examples, the settings are continually adjusted or refined as the craft 100 moves along the craft longitudinal axis 2110 towards the target point 2105.

Returning to block 2010, when the craft 100 is at or within a threshold distance of the target point 2105, the operations at block 2025 are performed. For instance, in some examples, the control system 500 forgoes making any further adjustments to the control elements settings associated with the control elements to forgo affecting a change in the observed craft 1810 (i.e., to maintain the location). In some examples, this involves returning the settings of the control elements to the state they were in prior to performing the location adjustment operations 2000. After the operations at block 2025 are performed, the operations may repeat from block 2010. For example, if the distance between the craft 100 and the target point 2105 were to exceed the threshold difference, the control elements may be adjusted again to bring the craft 100 to or within a threshold distance of the target point 2105.

In some examples, the location control logic 1900 described in FIG. 19 is used to perform location adjustment operations 2000 of FIG. 20 to minimize the distance between the craft 100 and a particular/target craft location 1810 using hull-aligned movements. For instance, in some examples, the target location at which the craft 100 should be maintained is input to the location control logic 1900, and the input to the yaw determination logic 1905 is set to zero to forgo making any adjustments that may change the heading of the craft 100. This causes the control element configuration logic 1900 to adjust the settings of the control elements, such as those propulsion systems that can generate thrust in the forward and reverse directions, such as the outrigger propulsion systems 900 and the propeller assemblies 116 to minimize the distance between the craft 100 and a particular/target craft location 1810 using hull-aligned movements.

The operations described in regard to FIGS. 14, 17, and 20 can be used in various combinations to allow the craft 100 to perform advanced maneuvering operations. Some examples of these maneuvering operations include anchoring operations 2200, station-keeping operations 2300, and docking operations 2600.

### E. Anchoring Operations

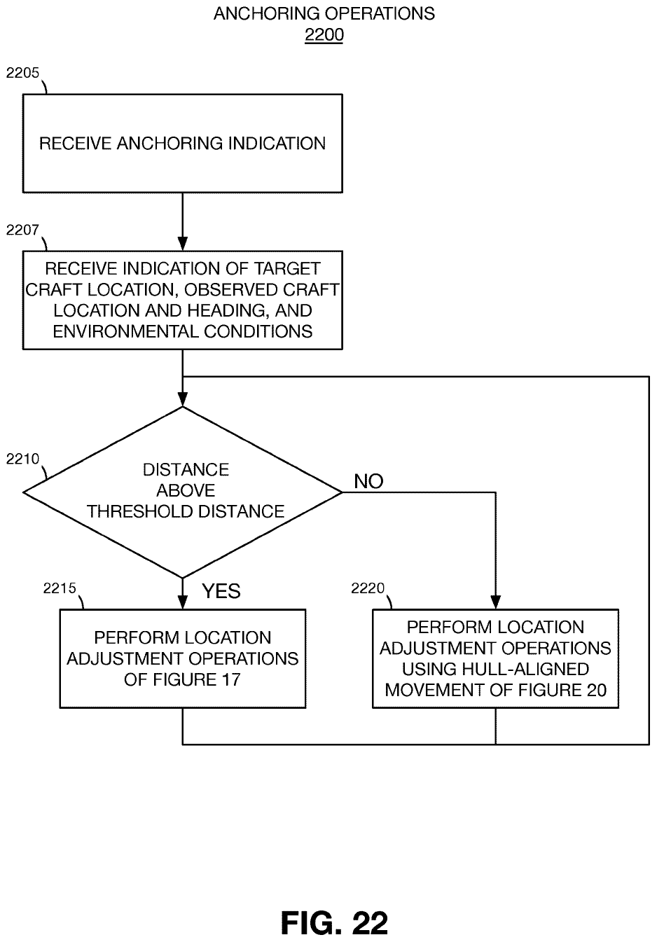

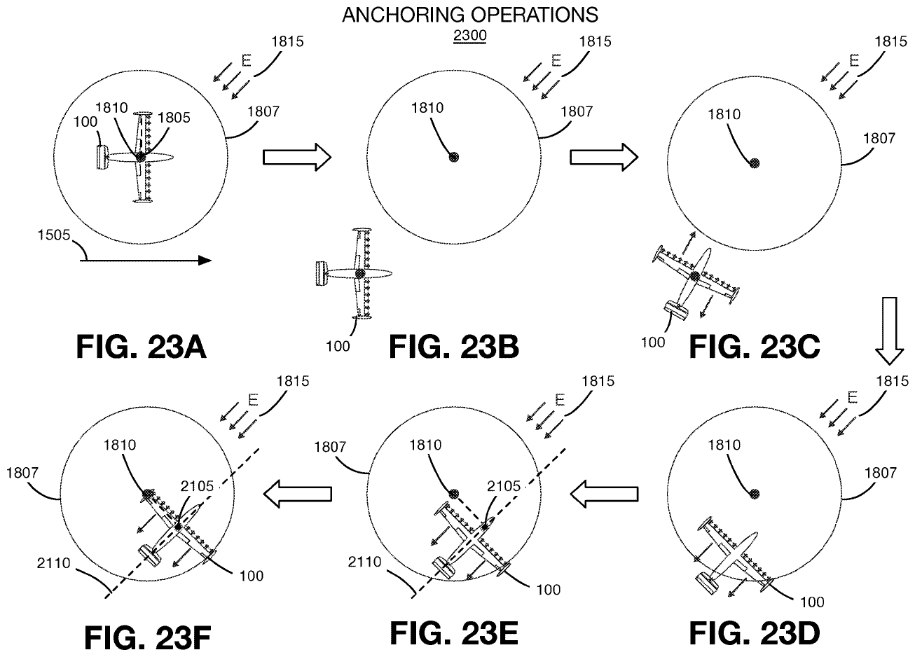

FIG. 22 illustrates example anchoring operations 2200 performed by some examples of the craft 100. The anchoring operations 2200 in FIG. 22 differ from the anchoring operations facilitated by the performance of the location adjustment operations 1700 described in regard to FIG. 17 in that aspects of both of the location adjustment operations 1700 and 2000 described in regards to FIGS. 17 and 20 are used to anchor (or virtually anchor) the craft 100. The anchoring operations 2200 of FIG. 22 may be further described with reference to FIGS. 23A-23F, which illustrate six example maneuvering stages through which the craft 100 may transition while anchoring. It should be understood that the anchoring operations described herein do not necessarily involve a physical anchor tied to the craft 100 and placed into the water. Rather the craft 100 is virtually anchored to a target craft location 1810 within a threshold location difference 1807 as shown as a circle perimeter around the target craft location 1810. It is contemplated, however, that the control system 500 could be configured to additionally cause a physical anchor that is tied to the craft to be placed into the water after the craft 100 is brought to an anchoring location.

The operations at block 2205 involve the control system 500 of the craft 100 receiving an anchoring indication. For instance, the control system 500 may receive an indication from the pilot to anchor the craft 100 at its current location.

The operations at block 2207 involve the control system 500 of the craft 100 receiving an indication of a target location 1810, observed craft location 1805, observed craft heading 1505, and environmental conditions 1815. For instance, the craft 100 may perform operations similar to those described in regard to block 1705 of FIG. 17 and block 2005 of FIG. 20. In some examples, after receiving the indication, the control system 500 sets the currently observed craft location 1805 as a target craft location 1810, as shown in FIG. 23A. Note: In some examples, the anchoring location may be different from the current location. For example, the pilot may indicate that the craft 100 should be virtually anchored at a different location or that the craft 100 should anchor itself once it stops moving or after its speed falls below a threshold anchoring speed (e.g., 2 knots). In such cases, the control system 500 may set the target craft location 1810 to be the desired anchoring location, the location at which the craft 100 comes to a stop, and/or the location at which the speed of the craft 100 falls below the threshold anchoring speed.

The operations at block 2210 involve the control system 500 determining whether the difference between the target craft location 1810 and the observed craft location 1805 is above a predetermined threshold location difference 1807.

When the location difference is determined to be above the predetermined threshold location difference 1807, the operations at block 2215 are performed. The operations at block 2215 involve performing some of the location adjustment operations 1700 of FIG. 17 for adjusting/moving the craft 100 to or towards the target craft location 1810. For example, the craft 100 may continuously perform the operations of blocks 1715 and 1720 to maneuver the craft 100 until the location of the craft 100 is within the predetermined threshold location difference 1807. Afterward, the operations of block 2210 are performed. For example, as shown in FIG. 23B, the environmental conditions 1815 (e.g., wind, water current, waves, etc.) have moved the craft 100 from the position shown in FIG. 23A to a position beyond the threshold location difference 1807. As shown in FIG. 23C, the craft 100 performs the operations of blocks 1715 and 1720 of FIG. 17, such as using one or more propulsion systems to cause the craft 100 to rotate towards the target craft location 1810 and move within the predetermined threshold location difference 1807 as shown in FIG. 23D.

When at block 2210 the location difference is determined to be within the predetermined threshold location difference 1807 (e.g., as shown in FIG. 23D), the operations at block 2220 are performed. The operations at block 2220 involve performing operations similar to those performed at blocks 2010 through 2025 of FIG. 20 for minimizing the distance between the craft 100 and a particular/target craft location 1810 using hull-aligned movements. For example, as shown in FIG. 23D-23F, after the craft 100 is within the threshold location difference 1807 of the target craft location 1810, the craft 100 moves along the craft longitudinal axis 2110 to minimize the distance between the craft 100 and target craft location 1810 using hull-aligned movements.

### F. Station-Keeping Operations

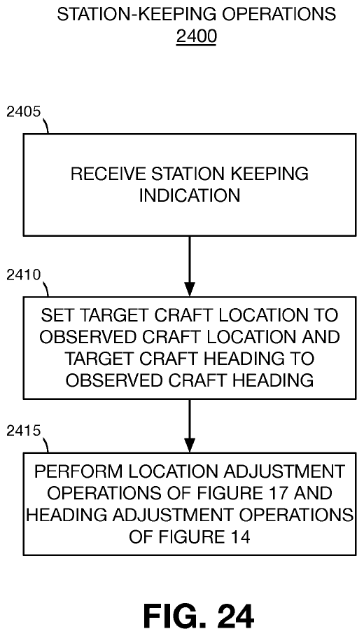

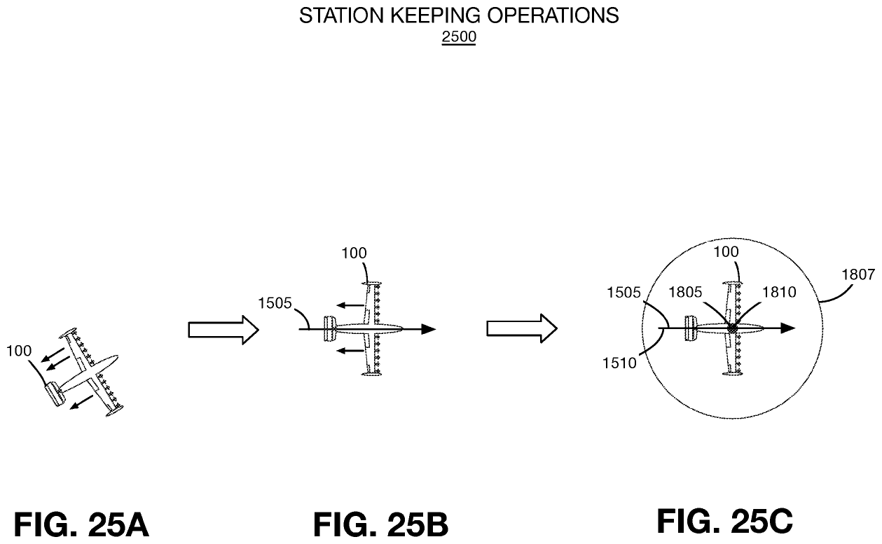

FIG. 24 illustrates example station-keeping operations 2400 performed by some examples of the craft 100. The station-keeping operations 2400 may be further described with reference to FIGS. 25A-25C.

The operations at block 2405 involve the control system 500 of the craft 100 receiving an indication to perform a station-keeping operation. For instance, the craft 100 may be maneuvering from the state shown in FIG. 25A to the state shown in FIG. 25B. When the craft 100 is in the state shown in FIG. 25B, the control system 500 may receive the station-keeping indication from the pilot to perform station-keeping of the craft 100 at its current location.

The operations at block 2410 involve the control system 500 setting the target craft location 1810 to observed craft location 1805 and target craft heading 1510 to observed craft heading 1505 as indicated in FIG. 25C.

The operations at block 2415 involve the control system 500 performing the location adjustment operations 1700 of FIG. 17 and the heading adjustment operations 1400 of FIG. 14 to maintain the craft location and the craft heading.

### G. Docking Operations

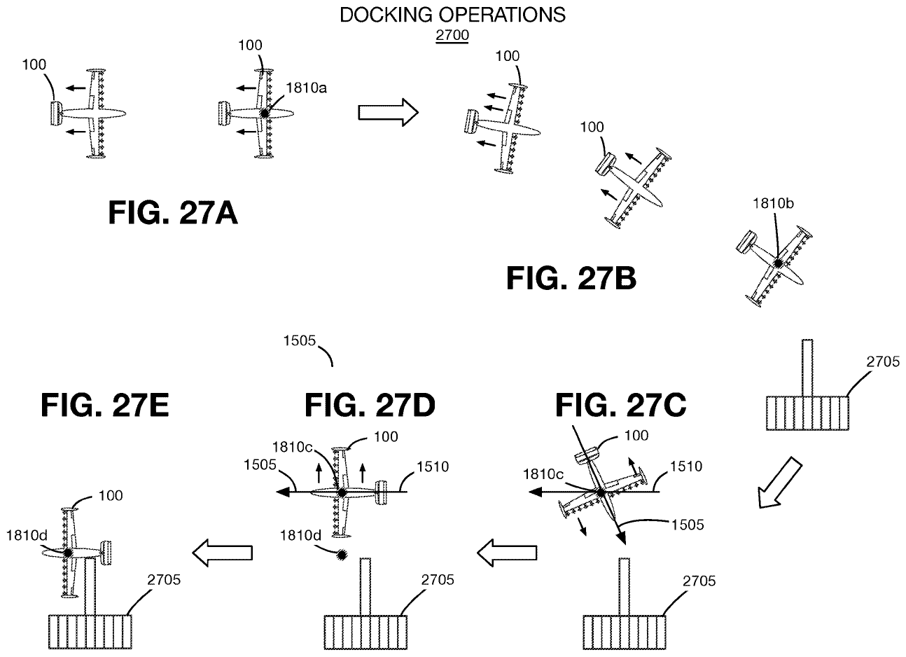

FIG. 26 illustrates example docking operations 2600 performed by some examples of the craft 100. The docking operations 2600 may be further described with reference to FIGS. 27A-27E.

The operations at block 2605 involve the control system 500 of the craft 100 receiving an indication to perform a docking operation. For instance, the indication may be received from the pilot of the craft 100. The indication may be received from an automated onboard system of the craft 100 and/or from a remote system in response, for example, to the craft 100 landing on the water near a dock 2705.

The operations at block 2610 involve the control system 500 of the craft 100 receiving one or more target locations 1810a-1810d and in some examples one or more target headings that collectively define a path the craft 100 should take to reach the dock 2705. In some examples, the control system 500 may receive a control element usage map that specifies the control elements that can be used in different regions near the dock 2705.

The operations at block 2615 involve the control system 500 causing the craft 100 to maneuver to follow the path specified by target locations 1810a-1810d and/or target headings. Some examples of the operations at block 2615 involve performing some of the location adjustment operations 1700 of FIG. 17 for adjusting/moving the craft 100 to or towards a target craft location 1810. For example, the craft 100 may continuously perform the operations of blocks 1715 and 1720 to maneuver the craft 100 until the craft 100 is within a predetermined threshold location difference 1807 of a first target location 1810a before maneuvering the craft 100 to within a predetermined threshold location difference 1807 of a second target location 1810b.

For example, as shown in FIG. 27A, the craft 100 may maneuver along a first path segment to a first target craft location 1810a and then along a second path segment to a second target craft location 1810b, as shown in FIG. 27B. By way of example, the control element usage map may indicate that the propeller assemblies 116 should be used to maneuver the craft 100 in the region associated with the first path segment because that region may be relatively far from obstacles. Similarly, the control element usage map may indicate that the outrigger propulsion systems 900 should be used to maneuver the craft 100 in the region associated with the second path segment because that region may be closer to obstacles.

As shown in FIG. 27C, the control system 500 may then control the craft 100 to rotate at the third target craft location 1810c and to a target craft heading 1510 associated with the third target craft location 1810c. In this regard, some examples of the operations at block 2615 may further involve performing some of the heading adjustment operations 1400 of FIG. 14 for adjusting the heading the craft 100 to or towards a target craft heading 1510. For example, the craft 100 may continuously perform the operations of blocks 1415 and 1420 to maneuver the craft 100 until the difference between the target craft heading 1510 and the observed craft heading 1505 is within a predetermined threshold heading difference (e.g., within a 0° difference, 5° difference, etc.). In some examples, the control element map may indicate to the control system 500 that one or more of the outrigger propulsion systems 900, propulsion pods 1200, bow thrusters, and hydrofoils 130, 136 can be used to maneuver that craft 100 to the target craft heading 1510 at the third target craft location 1810c.

As shown in FIG. 27D, after the observed craft heading 1505 reaches the target craft heading 1510, the control system 500 may cause the craft 100 to move laterally towards a fourth target craft location 1810d that places the craft 100 adjacent to the dock 2705. The control element map may indicate to the control system 500 that the propulsion pods 1200 and/or bow thruster may be used to perform this maneuver.

As shown in FIG. 27E, after the craft 100 reaches the fourth target craft location 1810d, the propulsion systems of the craft 100 may be disengaged.

### VI. OTHER EXAMPLES

The following section describes several examples. The examples (and features thereof) summarized in this section are for illustration purposes. The invention(s) disclosed and described herein are not limited to the examples summarized in this section or to any other example disclosed elsewhere herein. Any of the examples disclosed in this section, and any features of any of the examples, may be used together with each other in any combination, so long as the example (or feature(s) thereof) are not mutually exclusive. Further, any example (or feature(s) thereof) disclosed in any other section of this disclosure may be combined with any other example (or feature(s) thereof) disclosed in this section and/or any other section, in any combination, so long as the example (or feature(s) thereof) are not mutually exclusive.

Example 1: A craft comprising: (i) at least one hull; (ii) a pair of wings coupled to the at least one hull and configured to facilitate airborne operations of the craft; and (iii) a pair of outriggers, each outrigger positioned at a respective end of a corresponding wing of the pair of wings and configured to at least partially support the craft when the craft is hull-borne, wherein each outrigger comprises a pump configured to cause water to be ejected from at least one opening of the outrigger to generate thrust from the outrigger that facilitates moving the craft while the craft is hull-borne.

Example 2: The craft of Example 1, where each outrigger comprises: (i) an outrigger body; and (ii) a first opening and a second opening arranged on a bottom surface section of the outrigger body, wherein the pump is configured to cause water to be pulled into the first opening and ejected from the second opening.

Example 3: The craft according to Examples 1 or 2, where the outrigger body comprises: (i) a longitudinal axis that extends from a front end of the outrigger to a rear end of the outrigger and that is substantially parallel to a longitudinal axis of the craft, wherein the first opening is proximate to the front end of the outrigger and the second opening is proximate to the rear end of the outrigger; and (ii) an inner channel that extends between the first opening and the second opening, wherein the pump is configured to cause water to be pulled into the first opening, moved through the inner channel, and ejected from the second opening.

Example 4: The craft according to Example 3, where the inner channel is positioned so that when the craft is hull-borne, the inner channel is below the surface of the water.

Example 5: The craft according to Example 3, where the inner channel comprises a first section proximate the first opening and a second section proximate the second opening, wherein the second section extends towards the second opening such that a direction at which water is ejected from the second opening has a horizontal component.

Example 6: The craft according to Example 5, where the first section extends towards the first opening such that a magnitude of a horizontal component of water pulled into the first opening is less than a magnitude of the horizontal component of water ejected from the second opening.

Example 7: The craft according to Example 3, where the pump is a reversible pump that can be reversed to cause water to be pulled into the second opening, moved through the inner channel, and ejected from the first opening.

Example 8: The craft according to Example 1, where the pump is a propeller pump.

Example 9: The craft according to Example 3, where the bottom surface section of each outrigger comprises a third opening between the first opening and the second opening, wherein the pump is configured to cause water to be pulled into the third opening, moved through the inner channel, and ejected from either the first opening to cause thrust to be generated in a first direction or from the second opening to cause thrust to be generated in a second direction that is opposite the first direction.

Example 10: The craft according to Example 9, where the pump is a centrifugal pump.

Example 11: The craft according to Example 3, further comprising a first actuatable cover and a second actuatable cover configured to selectively cover the first opening and the second opening, respectively, wherein the first actuatable cover and the second actuatable cover are controlled to cover the first opening and the second opening, respectively, to facilitate airborne operations of the craft, and are controlled to uncover the first opening and the second opening, respectively, to facilitate hull-borne maneuvering operations of the craft.

Example 12: A craft comprising: (i) at least one hull; (ii) a pair of wings coupled to the at least one hull and configured to facilitate airborne operations of the craft; (iii) a plurality of propellers distributed across the pair of wings; (iv) a pair of outriggers, each outrigger positioned at a respective end of a corresponding wing of the pair of wings and configured to at least partially support the craft when the craft is hull-borne, wherein each outrigger comprises a pump configured to cause water to be ejected from an opening of the outrigger, wherein ejection of the water from the outrigger facilitates moving the craft while the craft is hull-borne; and (v) a control system that comprises data storage having instruction code stored thereon that, when executed by one or more processors of the control system, causes the control system to: (a) determine whether the at least one hull is on water; (b) after determining that the at least one hull is on the water, move the craft using the plurality of propellers to a target area; and (c) after determining that the craft has reached the target area, disengage the plurality of propellers and engage the pump of each of the pair of outriggers to maneuver the craft to a target destination.

Example 13: The craft according to Example 12, where the instruction code that causes the craft to maneuver to the target destination comprises instruction code that causes the control system to: (i) receive the target destination and information indicative of environmental forces acting on the craft; and (ii) control a relative power to the pump of each of the pair of outriggers to maneuver the craft to the target destination in a manner that compensates for the environmental forces acting on the craft.

Example 14: The craft according to Example 12, where the instruction code causes the control system to, after the craft has reached the target destination, continuously control a relative power to the pump of each of the pair of outriggers to maintain the craft at the target destination.

Example 15: The craft according to Example 12, where the instruction code causes the control system to, before engaging the pump of each of the pair of outriggers to maneuver the craft to the target destination, determine whether the pump of each of the pair of outriggers is submerged in water, wherein the instruction code causes the control system to engage the pump of each of the pair of outriggers to maneuver the craft to the target destination after the pump of each of the pair of outriggers is determined to be submerged in the water.

Example 16: The craft according to Example 12, where the instruction code causes the control system to, before engaging the pump of each of the pair of outriggers to maneuver the craft to the target destination, determine whether a water speed of the craft is below a target threshold, wherein the instruction code causes the control system to engage the pump of each of the pair of outriggers to maneuver the craft to the target destination after the water speed of the craft is determined to be below the target threshold.

Example 17: The craft according to Example 12, further comprising a plurality of propellers along the at least one wing, wherein the instruction code causes the control system to, before the propellers are engaged, disengage the pump of each of the pair of outriggers.

Example 18: The craft according to Example 12, further comprising an actuatable cover configured to selectively cover the opening, wherein the instruction code causes the control system to control the actuatable cover to cover the opening to facilitate airborne operations of the craft, and to uncover the opening to facilitate hull-borne maneuvering operations of the craft.

Example 19: A craft comprising: (i) at least one hull; (ii) at least one wing coupled to the at least one hull and configured to facilitate airborne operations of the craft; (iii) at least one propulsion pod positioned on an underside of the at least one hull, wherein the at least one propulsion pod comprises a pump configured to cause water to be ejected from an opening of the at least one propulsion pod to generate thrust from the at least one propulsion pod that facilitates moving the craft while the craft is hull-borne.

Example 20: The craft according to Example 19, where the at least one of propulsion pod is a first propulsion pod and the craft comprises a second propulsion pod, wherein the first propulsion pod is positioned proximate a forward end of the craft and the second propulsion pod is positioned proximate a tail end of the craft.

Example 21: The craft according to Example 19, where the at least one propulsion pod comprises a rotatable nozzle configured to direct water ejected from the at least one propulsion pod in a plurality of different directions to facilitate moving the craft laterally in a plurality of different directions.

Example 22: The craft according to Example 19, where the at least one propulsion pod is configured to be retracted into the hull of the craft.

Example 23: A craft comprising: (i) at least one hull; (ii) at least one sensor configured to sense one or more environmental conditions associated with the craft; (iii) a main wing coupled to the at least one hull and configured to facilitate airborne operations of the craft; (iv) at least one wing-affixed control element; and (v) a control system that comprises data storage having instruction code stored thereon that, when executed by one or more processors of the control system, causes the control system to operate in a heading adjustment mode. In some embodiments, the heading adjustment mode includes one or more (or all) of: (i) receiving, while hull-borne and the at least one wing-affixed control element is operating according to an initial wing-affixed control setting, an indication of (a) a target craft heading and (b) an indication of an observed craft heading; (ii) determining whether a heading difference between the target craft heading and the observed craft heading is above a threshold heading difference; (iii) when it is determined that the heading difference is above the threshold heading difference, determining an adjusted wing-affixed control setting for affecting a change in the observed heading of the craft based at least in part on at least (a) sensed environmental conditions, (b) the initial wing-affixed control setting, (c) the target craft heading, and (d) the observed craft heading; (iv) causing the at least one wing-affixed control element to operate according to the adjusted wing-affixed control setting to change the observed heading of the craft to the target craft heading; and (v) when it is determined that the heading difference is not above the threshold heading difference, adjusting the wing-affixed control setting to forgo affecting further change in the observed heading of the craft.

Example 24: The craft according to Example 23, where the at least one wing-affixed control element comprises one or more of: one or more propeller assemblies distributed along the main wing, one or more outrigger propulsion systems comprised within opposite ends of the main wing, and a rudder positioned on a tail wing of the craft.

Example 25: The craft according to Example 23, where adjusting the wing-affixed control setting to forgo affecting further change in the observed heading of the craft comprises adjusting the at least one wing-affixed control element to operate according to the initial wing-affixed control setting.

Example 26: The craft according to Example 23, where receiving the indication of the target craft heading and comprises, after receiving an indication to perform a station-keeping operation of the craft, determining a target heading of the craft to be a current observed craft heading.

Example 27: The craft according to Example 23, where the instruction code further causes the control system to operate in a location adjustment mode that comprises: (i) receiving an indication of a first target craft location and an observed craft location; (ii) determining whether a first distance between the first target craft location and the observed craft location is above a first threshold distance; and (iii) when it is determined that the first distance is above the first threshold distance, determining the adjusted wing-affixed control setting based additionally on (a) the first target craft location and (b) the observed craft location to move the craft to the target craft location; and (iv) when it is determined that the first distance is not above the first threshold distance, foregoing further adjustment based on (a) the first target craft location and (b) the observed craft location to forgo affecting further change to the observed craft location.

Example 28: The craft according to Example 27, where receiving the indication of the target craft heading and the indication of the target craft location comprises one or more (or all) of: (i) receiving an indication to dock the craft at a particular docking location; (ii) determining the particular docking location as the first target craft location; and (iii) determining a direction in which the craft should move to allow the craft to reach the particular docking location as the target craft heading.

Example 29: The craft according to Example 27, the craft further comprising at least one hull affixed control element, where the instruction code further causes the control system to: (i) cease operating in one or both of the heading adjustment mode and the location adjustment mode; (ii) after ceasing operating in the one or both of the heading adjustment mode and the location adjustment mode, begin to operate in a location maintenance mode. In some embodiments, operating in the location maintenance mode comprises: (i) receiving an indication of a second target craft location; (ii) determining whether a second distance between the second target craft location and the observed craft location is above a second threshold distance. When it is determined that the second distance is below the second threshold distance, some embodiments include (i) determining a hull affixed control setting for the hull affixed control element to maintain the second distance below the second threshold distance, based on at least (a) the determined second craft location and (b) the observed craft location; and (ii) causing the hull affixed control element to operate according to the determined hull affixed control setting to maintain the second distance below the second threshold distance. When it is determined that the second distance is above the second threshold distance, some embodiments include (i) setting the first target craft location to the second target craft location; and (ii) causing the craft to operate in the location adjustment mode.

Example 30: The craft according to Example 29, where the at least one hull-affixed control element comprises one or more of: (i) one or more propulsion pods coupled to the at least one hull and (ii) one or more extendible hydrofoils coupled to at least one hull.

Example 31: The craft according to Example 29, where receiving the indication of the second target craft location heading comprises: (i) receiving an indication to anchor or maintain a location of the craft; and (ii) determining the second target location to be a current observed location of the craft.

Example 32: The craft according to Example 23, further comprising a plurality of propeller assemblies distributed along each of a port side and a starboard side of the main wing and configured to generate lift on the craft by blowing air over the main wing, wherein causing the at least one wing-affixed control element to operate according to the adjusted wing-affixed control setting comprises adjusting an amount of thrust generated by one or more of the plurality of propeller assemblies.

Example 33: The craft according to Example 32, where adjusting the amount of thrust generated by one or more of the plurality of propeller assemblies comprises simultaneously causing one or more first propeller assemblies to generate thrust in a forward direction and one or more second propeller assemblies to generate thrust in a reverse direction.

Example 34: The craft according to Example 32, where adjusting the amount of thrust generated by one or more of the plurality of propeller assemblies comprises simultaneously causing at least one propeller on the port side of the main wing to generate thrust in a forward direction and cause at least one propeller on the starboard side of the main wing to generate thrust in a reverse direction.

Example 35: The craft according to Example 32, where adjusting the amount of thrust generated by one or more of the plurality of propeller assemblies comprises simultaneously cause at least one propeller on each of the port side and the starboard side of the main wing to generate thrust in a forward direction and at least one different propeller on each of the port side and the starboard side of the main wing to generate thrust in a reverse direction.

Example 36: The craft according to Example 32, where adjusting the amount of thrust generated by one or more of the plurality of propeller assemblies comprises: (i) while one or more propeller assemblies is generating thrust that imparts a force on the craft that affects maneuvering of the craft, and after determining that the one or more propeller assemblies should cease generating thrust, cause the one or more propeller assemblies to transition to a non-zero idle rotation rate at which thrust generated by the one or more propeller assemblies is insufficient to affect maneuvering of the craft; and (ii) maintain the one or more propeller assemblies at the non-zero idle rotation rate until thrust sufficient to affect maneuvering of the craft is required.

Example 37: A craft comprising a control system, where the control system comprises data storage having instruction code stored thereon that, when executed by one or more processors of the control system, causes the craft to perform functions comprising: (i) receiving, while operating according to an initial control setting, an indication of (a) a target craft heading and (b) an indication of an observed craft heading; (ii) determining whether a heading difference between the target craft heading and the observed craft heading is above a threshold heading difference. When it is determined that the heading difference is above the threshold heading difference, some embodiments include: (i) determining an adjusted control setting for affecting a change in the observed heading of the craft based on at least an initial control setting, the target craft heading, and the observed craft heading; and (ii) causing the craft to operate according to the adjusted control setting to change the observed heading of the craft to the target craft heading. When it is determined that the heading difference is not above the threshold heading difference, some embodiments include forgoing affecting a change in the observed heading of the craft.

Example 38: The craft of Example 37, where causing the craft to operate according to the adjusted control setting to change the observed heading of the craft to the target craft heading comprises, causing a wing-affixed control element of the craft to operate according to the adjusted control setting to change the observed heading of the craft to the target craft while hull-borne.

Example 39: The craft of Example 37, where the threshold heading difference is a 0 degrees difference.

Example 40: The craft of Example 37, where the control setting corresponds to at least one control element, and wherein the at least one control element comprises at least one of an outrigger propulsion system, a propulsion pod, a bow thruster, a propeller assembly, a rudder control surface, a height of a main hydrofoil assembly, a height of a rear hydrofoil assembly, a control surface on a tail of the craft.

Example 41: The craft of Example 37, where the control setting corresponds to at least one control element, the functions further comprising determining the at least one control element based on at least one observed environmental condition.

Example 42: The craft of Example 37, where the control setting corresponds to a pump, the craft further comprising: (i) at least one hull; (ii) a pair of wings coupled to the at least one hull and configured to facilitate airborne operations of the craft; and (iii) a pair of outriggers, each outrigger positioned at a respective end of a corresponding wing of the pair of wings and configured to at least partially support the craft when the craft is hull-borne. In some embodiments, each outrigger comprises the pump, wherein the pump is configured to cause water to be ejected from at least one opening of the outrigger to generate thrust from the outrigger that facilitates moving the craft while the craft is hull-borne.

Example 43: A craft comprising a control system, where the control system comprises data storage having instruction code stored thereon that, when executed by one or more processors of the control system, causes the craft to perform functions comprising: (i) while the craft is hull-borne on water, determining a difference between a target heading and an observed heading of the craft; (ii) determining desired yaw adjustment based on at least the determined difference between the target headings and the observed heading; (iii) generating a control signal based on at least the determined desired yaw adjustment; and (iv) causing, using the generated control signal, a control setting of at least one wing-affixed control element of the craft to be adjusted.

Example 44: The craft of Example 43, the functions further comprising, before determining the difference between the target heading and the observed heading, receiving a signal that represents the difference between the target heading and the observed heading.

Example 45: The craft of Example 43, where generating the control signal based on at least the determined desired yaw adjustment comprises generating the control signal based on (a) at least the determined desired yaw adjustment and (b) an indication of a target speed.

Example 46: The craft of Example 43, where the at least one wing-affixed control element comprises a wing-affixed propeller.

Example 47: The craft of Example 43, where the at least one wing-affixed control element comprises at least two wing-affixed propellers.

Example 48: The craft of Example 43, where the at least one wing-affixed control element comprises at least a first wing-affixed propeller and a second wing-affixed propeller, and wherein the control setting of the at least one wing-affixed control element comprises a first control setting for the first wing-affixed propeller and a second control setting for the second wing-affixed propeller, wherein the first control setting is different from the second control setting.

Example 49: A craft comprising a control system, where the control system comprises data storage having instruction code stored thereon that, when executed by one or more processors of the control system, causes the craft to perform functions comprising: (i) receiving an indication of a target craft location and an observed craft location; and (ii) determining whether a distance between the target craft location and the observed craft location is above a threshold distance. When it is determined that the distance is above the threshold distance, some embodiments include: (i) determining a control setting based on (a) the target craft location and (b) the observed craft location to move the craft to the target craft location; and (ii) adjusting, based on the determined control setting, a setting of a control element of the craft. When it is determined that the first distance is not above the first threshold distance, some embodiments include foregoing adjustment of the control element.

Example 50: The craft of Example 49, wherein the target craft location comprises a first target craft location, the functions further comprising: (i) after adjusting the setting of the control element of the craft, determining, based on a final target location, a second target craft location; and (ii) determining another control setting based on (a) the second target craft location and (b) another observed craft location to move the craft to the second target craft location.

Example 51: The craft of Example 49, where determining the control setting further comprises determining the control setting based on (a) the target craft location, (b) the observed craft location, and (c) an observed environmental condition.

Example 52: The craft of Example 49, where the at least one control element comprises at least one of an outrigger propulsion system, a propulsion pod, a bow thruster, a propeller assembly, a rudder control surface, a height of a main hydrofoil assembly, a height of a rear hydrofoil assembly, a control surface on a tail of the craft.

Example 53: A craft comprising a control system, where the control system comprises data storage having instruction code stored thereon that, when executed by one or more processors of the control system, causes the craft to perform functions comprising: (1) while the craft is hull-borne on water, determining a difference between a target location and an observed location of the craft; (2) determining, based on at least the determined difference between the target location and the observed location of the craft, (a) one of (i) a desired forward thrust or (ii) a desired reverse thrust, and (b) a desired yaw adjustment; (3) generating a control signal based on at least (a) the determined one of (i) the desired forward thrust or (ii) the desire reverse thrust and (b) the desired yaw adjustment; and (4) causing, using the generated control signal, a control setting of at least one wing-affixed control element of the craft to be adjusted.

Example 54: The craft of Example 53, the functions further comprising, before determining the difference between the target location and the observed location, receiving a signal that represents the difference between the target location and the observed location.

Example 55: The craft of Example 53, where the at least one wing-affixed control element comprises a wing-affixed propeller.

Example 56: The craft of Example 53, where the at least one wing-affixed control element comprises at least two wing-affixed propellers.

Example 57: The craft of Example 53, where the at least one wing-affixed control element comprises at least a first wing-affixed propeller and a second wing-affixed propeller, and wherein the control setting of the at least one wing-affixed control element comprises a first control setting for the first wing-affixed propeller and a second control setting for the second wing-affixed propeller, wherein the first control setting is different from the second control setting.

Example 58. A craft comprising a control system, where the control system comprises data storage having instruction code stored thereon that, when executed by one or more processors of the control system, causes the craft to perform functions comprising: (i) receiving an indication of a target craft location and an observed craft location; and (ii) determining whether a distance between the target craft location and the observed craft location is above a threshold distance. When it is determined that the distance is above the threshold distance, come embodiments include (a) determining a target point on a longitudinal axis of the craft that is closest to the target craft location, (b) determining a control setting based on at least the determined target point, wherein the control setting corresponds to a desired movement of the craft along the longitudinal axis, and (c) adjusting, based on the determined control setting, a setting of a control element of the craft. When it is determined that the first distance is not above the first threshold distance, some embodiments include foregoing adjustment of the control element.

Example 59: The craft of Example 58, where determining the control setting further comprises determining the control setting based on (a) the target craft location, (b) the observed craft location, and (c) an observed environmental condition.

Example 60: The craft of Example 58, where the at least one control element comprises at least one of an outrigger propulsion system, a propulsion pod, a bow thruster, a propeller assembly, a rudder control surface, a height of a main hydrofoil assembly, a height of a rear hydrofoil assembly, a control surface on a tail of the craft.

Example 61: The craft of Example 58, where the determined control setting comprises a yaw-control setting of zero.

Example 62. A craft comprising a control system, where the control system comprises data storage having instruction code stored thereon that, when executed by one or more processors of the control system, causes the craft to perform functions comprising: (i) receiving an indication of a target craft location and an observed craft location; and (ii) determining whether a distance between the target craft location and the observed craft location is above a threshold distance. When it is determined that the distance is above the threshold distance, some embodiments include: (i) determining a first control setting based on (a) the target craft location and (b) the observed craft location to move the craft to the target craft location; and (ii) adjusting, based on the determined first control setting, a first setting of a control element of the craft. When it is determined that the distance is not above the threshold distance, some embodiments include (a) determining a target point on a longitudinal axis of the craft that is closest to the target craft location, (b) determining a second control setting based on at least the determined target point on the longitudinal axis of the craft, wherein the second control setting corresponds to a desired movement of the craft along the longitudinal axis of the craft, and (c) adjusting, based on the determined second control setting, a second setting of the control element of the craft.

Example 63: The craft of Example 62, the functions further comprising receiving an indication to anchor the craft at a current location, wherein the indication of the target craft location indicates the current location.

Example 64: The craft of claim 62, the functions further comprising: (i) receiving an indication to anchor the craft; and (ii) in response to receiving the indication to anchor the craft, receiving the indication of the observed craft location, wherein the target craft location is different from the observed craft location.

Example 65: The craft of Example 62, the functions further comprising causing a physical anchor that is tied to the craft to be placed.

Example 66: The craft of Example 62, wherein determining the first control setting further comprises determining the first control setting based on (a) the target craft location, (b) the observed craft location, and (c) an observed environmental condition.

Example 67: A craft comprising a control system, where the control system comprises data storage having instruction code stored thereon that, when executed by one or more processors of the control system, causes the craft to perform functions comprising: (i) receiving an indication of a first observed craft heading; (ii) receiving an indication to perform a station-keeping operation; (iii) after receiving the indication to perform a station keeping operation, (a) receiving an indication of a second observed craft heading, and (b) determining whether a heading difference between the first observed craft heading and the second observed craft heading is above a threshold heading difference. When it is determined that the heading difference is above the threshold heading difference, some embodiments include: (i) determining, based on at least the first observed craft heading and the second observed craft heading, an adjusted control setting for affecting a change in the second observed craft heading; and (ii) causing the craft to operate according to the determined adjusted control setting to change the second observed craft heading. And When it is determined that the heading difference is not above the threshold heading difference, some embodiments include forgoing affecting change in the second observed heading of the craft.

Example 68: A craft comprising a control system, where the control system comprises data storage having instruction code stored thereon that, when executed by one or more processors of the control system, causes the craft to perform functions comprising: (1) receiving an indication of a first observed craft heading and a first observed location craft location; (2) receiving an indication to perform a station-keeping operation; (3) after receiving the indication to perform the station keeping operation, (i) receiving an indication of a second observed craft heading and a second observed craft location, and (ii) determining whether (a) a heading difference between the first observed craft heading and the second observed craft heading is above a threshold heading difference or (b) that a location difference between the first observed craft location and the second observed craft location is above a threshold location difference. When it is determined that (a) the heading difference is above the threshold heading difference or (b) the location difference is above the threshold location difference, some embodiments include: (i) determining, based on at least one of (a) the first observed craft heading and the second observed craft heading and (b) the first observed craft location and the second observed craft location, an adjusted control setting for affecting a change in at least one of the second observed craft heading and the second observed craft location; and (ii) causing the craft to operate according to the determined adjusted control setting. And when it is determined that (a) the heading difference is not above the threshold heading difference and (b) the location difference is not above the threshold location difference, some embodiments include forgoing causing the craft to operate according to any adjusted control setting.

Example 69. A craft comprising a control system, where the control system comprises data storage having instruction code stored thereon that, when executed by one or more processors of the control system, causes the craft to perform functions comprising: (i) receiving an indication to perform a docking operation; (ii) after receiving the indication to perform the docking operation, receiving an indication of at least a first target craft location and a second target craft location; (iii) receiving an indication of a first observed craft location; and (iv) determining whether a first distance between the first target craft location and the first observed craft location is above a first threshold distance. When it is determined that the first distance is above the first threshold distance, some embodiments include: (i) determining a first control setting based on (a) the first target craft location and (b) the first observed craft location to move the craft to the first target craft location; and (ii) adjusting, based on the determined first control setting, a first setting of a control element of the craft. And when it is determined that the first distance is not above the first threshold distance, some embodiments include: (i) receiving an indication of a second observed craft location; and (ii) determining whether a second distance between the second target craft location and the second observed craft location is above a second threshold distance. When it is determined that the second distance is above the second threshold distance, some embodiments include (i) determining a second control setting based on (a) second target craft location and (b) the second observed craft location to move the craft to the second target craft location, and (ii) adjusting, based on the determined second control setting, a setting of the control element of the craft. And when it is determined that the second distance is not above the second threshold distance, some embodiments include causing the craft to maintain the second observed craft location.

### VII. CONCLUSION

While the systems and methods of operation have been described with reference to certain examples, it will be understood by those skilled in the art that various changes can be made, and equivalents can be substituted without departing from the scope of the claims. Therefore, it is intended that the present methods and systems not be limited to the particular examples disclosed, but that the disclosed methods and systems include all embodiments falling within the scope of the appended claims.

1. A craft comprising:
at least one hull;
at least one sensor configured to sense one or more environmental conditions associated with the craft;
a main wing coupled to the at least one hull and configured to facilitate airborne operations of the craft;
at least one wing-affixed control element; and
a control system that comprises data storage having instruction code stored thereon that, when executed by one or more processors of the control system, causes the control system to operate in a heading adjustment mode that comprises:
receiving, while hull-borne and the at least one wing-affixed control element is operating according to an initial wing-affixed control setting, an indication of (a) a target craft heading and (b) an indication of an observed craft heading;
determining whether a heading difference between the target craft heading and the observed craft heading is above a threshold heading difference; and
when it is determined that the heading difference is above the threshold heading difference,
determining, based on at least (a) sensed environmental conditions, (b) the initial wing-affixed control setting, (c) the target craft heading, and (d) the observed craft heading, an adjusted wing-affixed control setting for affecting a change in the observed heading of the craft; and
causing the at least one wing-affixed control element to operate according to the adjusted wing-affixed control setting to change the observed heading of the craft to the target craft heading; and
when it is determined that the heading difference is not above the threshold heading difference, adjusting the wing-affixed control setting to forgo affecting further change in the observed heading of the craft.

2. The craft according to claim 1, wherein the at least one wing-affixed control element comprises one or more of: one or more propeller assemblies distributed along the main wing, one or more outrigger propulsion systems comprised within opposite ends of the main wing, and a rudder positioned on a tail wing of the craft.

3. The craft according to claim 1, wherein adjusting the wing-affixed control setting to forgo affecting further change in the observed heading of the craft comprises adjusting the at least one wing-affixed control element to operate according to the initial wing-affixed control setting.

4. The craft according to claim 1, wherein receiving the indication of the target craft heading and comprises:
after receiving an indication to perform a station-keeping operation of the craft, determining a target heading of the craft to be a current observed craft heading.

5. The craft according to claim 1, wherein the instruction code further causes the control system to operate in a location adjustment mode that comprises:
receiving an indication of a first target craft location and an observed craft location;
determining whether a first distance between the first target craft location and the observed craft location is above a first threshold distance; and
when it is determined that the first distance is above the first threshold distance, determining the adjusted wing-affixed control setting based additionally on (a) the first target craft location and (b) the observed craft location to move the craft to the target craft location; and
when it is determined that the first distance is not above the first threshold distance, foregoing further adjustment based on (a) the first target craft location and (b) the observed craft location to forgo affecting further change to the observed craft location.

6. The craft according to claim 5, wherein receiving the indication of the target craft heading and the indication of the target craft location comprises:
receiving an indication to dock the craft at a particular docking location;
determining the particular docking location as the first target craft location; and
determining a direction in which the craft should move to allow the craft to reach the particular docking location as the target craft heading.

7. The craft according to claim 5, the craft further comprising:
at least one hull-affixed control element, wherein the instruction code further causes the control system to:
cease operating in one or both of the heading adjustment mode and the location adjustment mode;
after ceasing operating in the one or both of the heading adjustment mode and the location adjustment mode, begin to operate in a location maintenance mode, wherein operating in the location maintenance mode comprises:
receiving an indication of a second target craft location;
determining whether a second distance between the second target craft location and the observed craft location is above a second threshold distance; and
when it is determined that the second distance is below the second threshold distance,
determining, based on at least (a) the determined second craft location and (b) the observed craft location, a hull affixed control setting for the hull affixed control element to maintain the second distance below the second threshold distance; and
causing the hull affixed control element to operate according to the determined hull affixed control setting to maintain the second distance below the second threshold distance; and
when it is determined that the second distance is above the second threshold distance,
setting the first target craft location to the second target craft location; and
causing the craft to operate in the location adjustment mode.

8. The craft according to claim 7, wherein the at least one hull-affixed control element comprises one or more of: one or more propulsion pods coupled to the at least one hull and one or more extendible hydrofoils coupled to at least one hull.

9. The craft according to claim 7, wherein receiving the indication of the second target craft location heading comprises:
receiving an indication to anchor or maintain a location of the craft; and
determining the second target location to be a current observed location of the craft.

10. The craft according to claim 1, further comprising a plurality of propeller assemblies distributed along each of a port side and a starboard side of the main wing and configured to generate lift on the craft by blowing air over the main wing, wherein causing the at least one wing-affixed control element to operate according to the adjusted wing-affixed control setting comprises:
adjusting an amount of thrust generated by one or more of the plurality of propeller assemblies.

11. The craft according to claim 10, wherein adjusting the amount of thrust generated by one or more of the plurality of propeller assemblies comprises:
simultaneously causing one or more first propeller assemblies to generate thrust in a forward direction and one or more second propeller assemblies to generate thrust in a reverse direction.

12. The craft according to claim 10, wherein adjusting the amount of thrust generated by one or more of the plurality of propeller assemblies comprises:
simultaneously causing at least one propeller on the port side of the main wing to generate thrust in a forward direction and causing at least one propeller on the starboard side of the main wing to generate thrust in a reverse direction.

13. The craft according to claim 10, wherein adjusting the amount of thrust generated by one or more of the plurality of propeller assemblies comprises:
simultaneously cause at least one propeller on each of the port side and the starboard side of the main wing to generate thrust in a forward direction and at least one different propeller on each of the port side and the starboard side of the main wing to generate thrust in a reverse direction.

14. The craft according to claim 10, wherein adjusting the amount of thrust generated by one or more of the plurality of propeller assemblies comprises:
while one or more propeller assemblies is generating thrust that imparts a force on the craft that affects maneuvering of the craft, and after determining that the one or more propeller assemblies should cease generating thrust, cause the one or more propeller assemblies to transition to a non-zero idle rotation rate at which thrust generated by the one or more propeller assemblies is insufficient to affect maneuvering of the craft; and
maintain the one or more propeller assemblies at the non-zero idle rotation rate until thrust sufficient to affect maneuvering of the craft is required.

15-20. (canceled)
